(19) United States
(12) Patent Application Publication
(10) Pub. No.: US 2026/0024142 A1
(43) Pub. Date: Jan. 22, 2026

(54) REAL-TIME EXPENSE TRACKER

(71) Applicant: QUIDRICS, LLC, Westminster, CO (US)

(72) Inventor: Brent ROGNLIE, Westminster, CO (US)

(21) Appl. No.: 19/272,358

(22) Filed: Jul. 17, 2025

Related U.S. Application Data
(60) Provisional application No. 63/672,625, filed on Jul. 17, 2024.

(51) Int. Cl. G06Q 40/06

(52) U.S. Cl. CPC G06Q 40/064

(57) ABSTRACT

Systems and methods for real-time tracking of expenses and savings of users. Various user interfaces are configured to provide a variety of interactive functions and display different types of data associated with a user's financial state. Snapshots of a user's spending and/or savings state is provided in real time considering the timing of expenditures (or lack of expenditures) or the timing of savings (or lack of savings). Various graphs may be displayed that depict data such as budgets, spending, amounts of budgets remaining, actual amount remaining, savings, end of year projections, and/or projections to budget surplus states.

### CROSS-REFERENCE TO RELATED APPLICATION(S)

This application claims the filing benefit of U.S. Provisional Application No. 63/672,625, filed Jul. 17, 2024. This application is incorporated by reference herein in its entirety and for all purposes.

### TECHNICAL FIELD

This disclosure relates generally to the field of finance, and more specifically to finance management software applications and systems and devices that execute finance management software applications.

### BACKGROUND

A finance management software application allows a user to track financial information, such as spending and savings. However, in some instances, the application is complicated to use and can consume too much of a user's time. As such, the ease of use of the application and the adoption of the application by users are decreased.

### SUMMARY

Systems and methods are disclosed for real-time tracking of expenses and savings. Embodiments disclosed herein describe various user interfaces (“screen or “screens”) that are configured to provide a variety of interactive functions and display different types of data associated with a user's financial state. Snapshots of a user's spending and/or savings state is provided in real time considering the timing of expenditures (or lack of expenditures) or the timing of savings (or lack of savings). Various graphs may be displayed that depict data such as budgets, spending, amounts of budgets remaining, actual amount remaining, savings, end of year projections, and/or projections to budget surplus states. The information displayed in the user interfaces are nearly instantaneously updated based on newly incurred or entered expenditures.

One example screen is a home or introductory screen. An introductory may be a home screen of a software application or a home page of a web-based application. The introductory screen may be a spending introductory screen that provides information on the user's spending, or the introductory screen may be a savings introductory screen that provides information on the user's savings. An introductory screen may present a summary section of a summary of spending or savings and one or more metrics associated with the spending or savings, an annual performance section and one or more metrics associated with the annual performance, an adaptable icon that may function as a visual aid regarding the user's current spending state or current savings state at the time the introductory screen is opened or updated, and/or a graph section that is configured to display one or more graphs associated with the user's spending or savings. Additionally or alternatively, the introductory screen may present a real time year-to-date of planned and actual spending or savings in the summary section, a countdown timer, a calendar countdown icon that, when selected, presents the shortest time to a budget surplus or a status level, and/or a “Now” column and an end-of-day (e.g., Midnight) column in the annual performance section. Some or all of the information in the introductory screen can change in real time throughout the day based on the user's expenditures (or lack of expenditures) or the user's savings (or lack of savings). For example, in one embodiment, the adaptable icon, the summary section and associated metric(s), a year-to-date total, the annual performance section and associated metric(s), and the graph section may change in real time throughout the day.

Other example screens may be new category screens and/or new sub-category screens. A new category screen may include an input element (e.g., a text box) for receiving a name of the new category or the new sub-category and an input element (e.g., a text box) for receiving a description of the new category or the new sub-category. Additionally or alternatively, the new sub-category screen may include additional selectable input elements (e.g., radio buttons) for indicating the sub-category is a variable expense, a scheduled periodic expense, or a scheduled custom expense.

Another example screen may be a category overview screen. A category overview screen may present an overview of the categories associated with a budget. The category overview screen may display a list of the categories with planned and surplus columns. A graph section may be presented in the category overview screen.

A sub-category overview screen may be another example screen. A sub-category overview screen may present an overview of the sub-categories associated with a particular category of the budget. The sub-category overview screen may display a list of the sub-categories with planned and surplus columns. A graph section may be presented in the sub-category overview screen.

In some embodiments, a category details screen may be included in the various screens. A category details screen may present information on the spending state of a particular category in a budget. The category details section may include a category overview section of a summary of spending and one or more metrics associated with the spending, an annual performance section and one or more metrics associated with the annual performance, an adaptable icon that may function as a visual aid regarding the user's current spending state at the time the category details screen is opened or updated, and/or a graph section that is configured to display one or more graphs associated with the user's spending. Additionally or alternatively, the category details screen may present a real time year-to-date of planned and actual spending in the summary section, a countdown timer, a calendar countdown icon that, when selected, presents the shortest time to a budget surplus or a status level, and/or a “Now” column and an end-of-day (e.g., Midnight) column in the annual performance section. Some or all of the information in the category details screen can change in real time throughout the day based on the user's expenditures (or lack of expenditures). For example, in one embodiment, the adaptable icon, the summary section and associated metric(s), a year-to-date total, the annual performance section and associated metric(s), and the graph section may change in real time throughout the day.

Other example screens may be an edit category screen and/or an edit sub-category screen. The edit category screen and/or the edit sub-category screen may be configured for expenses or savings. An edit category screen may include an input element (e.g., a text box) for receiving an edited name of the category, an input element (e.g., a text box) for receiving a description of the category, and/or a sub-category section that includes a list of the sub-categories for the named category. Sub-categories may be added, deleted or edited in the edit category screen. The category may be deleted using the edit category screen. An edit sub-category screen may include input elements for receiving a start date, an end date, an amount, and/or an input element for receiving a schedule (e.g., bi-weekly). Sub-categories may be added, deleted or edited in the edit sub-category screen. The sub-category may be deleted.

Expenses may be variable or scheduled, and other example screens include a variable expenses screen or a scheduled expenses screen. A scheduled expense screen and/or a variable expense screen may include a filter section and a listing of expenses section. The filter section can include one or more filters that are used to filter the scheduled or variable expenses to be displayed in the scheduled or variable expense screen, respectively. The listing of expenses section may list scheduled or variable expenses that were paid and/or are due within a given time period.

In some implementations, a new expense screen may be included in the various screens. A new expense screen may include input elements for a category name, a sub-category name, a date the expense is due, an amount, and a description or note of the new expense. The new expense screen may include a budget details section and/or a countdown timer. For example, the countdown timer may present a countdown to a breakeven time and/or day for the budget.

Another example screen may be an edit expenses screen. The expense may be a scheduled expense or a variable expense. An edit expenses screen may include input elements for a category name, a sub-category name, a date, an amount and a description or note of the expense. Additionally or alternatively, the edit expense screen may present a date expected for payment of the expense, an expected amount for the expense, an input element for receiving a date paid and an input element for receiving an actual amount. In some instances, an edit expenses screen may include an input element for receiving an item that may be used to represent different aspects of an expense (e.g., a category or a sub-category). For example, a category or sub-category may be “vacation”, and an item may be associated with each month in which a vacation is planned. An expense may be deleted using the edit expenses screen.

Yet another example screen may be a savings screen. The savings screen may include a variable savings screen or a scheduled savings screen. The variable savings screen and/or the scheduled savings screen may include a filter section and a variable or scheduled savings section that present a list of variable or scheduled savings within a given time period.

An edit savings screen may be included in the various screens. An edit savings screen may display an expected date for the savings, an expected amount for the savings, and a description or note of the savings. The edit savings screen may include input elements for an actual date of the savings and an actual amount of the savings.

Another example screen may be a new savings entry screen. A new savings entry screen may include input elements for a date the savings are to be received, an amount of the savings, and a description for the new savings.

One or more graphs may be displayed in some or all of the various screens. The graphs may present information associated with spending or with savings. Example graphs include, but are not limited to, a burndown graph, a budget graph, a spending graph, a savings graph, a surplus or a deficit graph, and a total budget graph.

In some embodiments, some or all of the various screens may include the adaptable icon. The adaptable icon may function as a visual aid regarding the user's current spending state or current savings state at the time a respective screen is opened or updated. An adaptable icon may be color coded to indicate a status associated with the spending or savings state. An adaptable icon may use any number of colors and/or states, and/or icon shapes, and/or different pattern fills for the states, or other adaptable visual representations of the states, either by default or by user customization.

In one aspect, a system may include a processor and a memory. The memory may be configured to store processor-executable instructions, that when executed by the processor, cause operations to be performed. The operations may include receiving financial information, where the financial information includes a plurality of expenses that are associated with a budget. The expenses may include variable expenses and scheduled expenses. Information regarding a payment of an expense in the plurality of expenses is received. A spending state may be updated in real time based on the received information. A screen associated with the spending state may be displayed. The screen may include an adaptable icon configured to visually represent the spending state; a summary section providing a summary of spending; and/or a graph including at least one plot associated with spending over the time period. The summary section may include spending over a day and spending over a time period that is greater than a day.

In another aspect, a method may include receiving financial information, where the financial information includes a plurality of expenses that are associated with a budget. The expenses may include variable expenses and scheduled expenses. Information regarding a payment of an expense in the plurality of expenses is received, and a spending state is updated in real time based on the received information. A screen associated with the spending state may be displayed. The screen may include an adaptable icon configured to visually represent the spending state; a summary of spending that includes spending over a day and spending over a time period that is greater than a day; and/or a graph including at least one plot associated with spending over the time period. The adaptable icon may be one of a plurality of adaptable icons.

In yet another aspect, a system may include a processor and a memory. The memory may be configured to store processor-executable instructions, that when executed by the processor, cause operations to be performed. The operations may include receiving financial information, where the financial information includes savings that are associated with a budget. The savings may include variable savings and scheduled savings. Information regarding payment of a saving is received. A savings state may be updated in real time based on the received information. A screen associated with the savings state may be displayed. The screen may include an adaptable icon configured to visually represent the savings state; a summary section providing a summary of savings over a time period; and/or a graph including at least one plot associated with the savings over the time period.

In another aspect, a method may include receiving financial information, where the financial information includes savings that are associated with a budget. The savings may include variable savings and scheduled savings. Information regarding payment of a saving, and a savings state is updated in real time based on the received information. A screen associated with the savings state may be displayed. The screen may include an adaptable icon configured to visually represent the savings state; a summary of savings, the summary including savings over a time period; and/or a graph including at least one plot associated with the savings over the time period. The adaptable icon may be one of a plurality of adaptable icons.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the Figures.

FIG. 1 illustrates a first example of an introductory screen of a finance management application displayed on a user device according to an embodiment of the disclosure;

FIG. 2 illustrates a second example of an introductory screen of a finance management application displayed on the user device according to an embodiment of the disclosure;

FIG. 3A illustrates the first example of the introductory screen shown in FIG. 1;

FIG. 3B illustrates an example action plan screen displayed on the user device according to an embodiment of the disclosure;

FIG. 4A illustrates the first example of the introductory screen shown in FIG. 1;

FIG. 4B illustrates an example category overview screen displayed on the user device according to an embodiment of the disclosure;

FIG. 5A illustrates the example category overview screen shown in FIG. 4B according to an embodiment of the disclosure;

FIG. 5B illustrates an example category details screen displayed on the user device according to an embodiment of the disclosure;

FIG. 6A illustrates the example category details screen shown in FIG. 5B according to an embodiment of the disclosure;

FIG. 6B illustrates an example sub-category overview screen displayed on the user device according to an embodiment of the disclosure;

FIG. 7A illustrates an example of a first variable expenses screen displayed on the user device according to an embodiment of the disclosure;

FIG. 7B illustrates an example of a first new expense screen displayed on the user device according to an embodiment of the disclosure;

FIG. 8A illustrates an example of a second variable expenses screen displayed on the user device according to an embodiment of the disclosure;

FIG. 8B illustrates an example of a second new expense screen displayed on the user device according to an embodiment of the disclosure;

FIG. 9A illustrates the example new expense screen shown in FIG. 8B according to an embodiment of the disclosure;

FIG. 9B illustrates an example of an updated new expense screen displaying on the user device according to an embodiment of the disclosure;

FIG. 10A illustrates the example variable expenses screen shown in FIG. 7A according to an embodiment of the disclosure;

FIG. 10B illustrates a first example of an edit expenses screen displayed on the user device according to an embodiment of the disclosure;

FIG. 11 illustrates the first example of the introductory screen shown in FIG. 1 displaying a spending indicator according to an embodiment of the disclosure;

FIG. 12A illustrates an example of a first scheduled expenses screen displayed on the user device according to an embodiment of the disclosure;

FIG. 12B illustrates a second example of an edit expenses screen displayed on the user device according to an embodiment of the disclosure;

FIG. 13A illustrates an example of an updated scheduled expenses screen displaying on the user device according to an embodiment of the disclosure;

FIG. 13B illustrates the second example of the edit expenses screen 1202 shown in FIG. 12B according to an embodiment of the disclosure;

FIG. 14A illustrates an example savings screen displaying on the user device according to an embodiment of the disclosure;

FIG. 14B illustrates an example new savings entry screen displaying on the user device according to an embodiment of the disclosure;

FIG. 15A illustrates an example savings screen for scheduled savings displaying on the user device according to an embodiment of the disclosure;

FIG. 15B illustrates an example edit savings screen for a scheduled savings displaying on the user device according to an embodiment of the disclosure;

FIG. 16 illustrates a first example of a burndown graph according to an embodiment of the disclosure;

FIG. 17 illustrates a second example of a burndown graph according to an embodiment of the disclosure;

FIG. 18 illustrates a first example of a budget surplus graph according to an embodiment of the disclosure;

FIG. 19 illustrates a second example of a budget surplus graph according to an embodiment of the disclosure;

FIG. 20 illustrates an example of a total budget graph according to an embodiment of the disclosure;

FIG. 21 illustrates an example of a total budget graph and an associated pie chart representing a distribution of the spending according to an embodiment of the disclosure;

FIG. 22 illustrates best time to surplus graph according to an embodiment of the disclosure;

FIG. 23 illustrates a budget surplus graph for a utilities sub-category according to an embodiment of the disclosure;

FIG. 24 illustrates a budget surplus graph for a maintenance sub-category according to an embodiment of the disclosure;

FIG. 25 illustrates a budget surplus graph for a water/sewer sub-category according to an embodiment of the disclosure;

FIG. 26 illustrates a budget surplus graph for a homeowner association (HOA) sub-category according to an embodiment of the disclosure;

FIG. 27A illustrates an example budget screen for expenses displayed on the user device according to an embodiment of the disclosure;

FIG. 27B illustrates an example of a new category screen displayed on the user device according to an embodiment of the disclosure;

FIG. 28A illustrates an example of an updated new category screen displaying on the user device according to an embodiment of the disclosure;

FIG. 28B illustrates an example of an edit category screen displayed on the user device according to an embodiment of the disclosure;

FIG. 29A illustrates the example edit category screen shown in FIG. 28B according to an embodiment of the disclosure;

FIG. 29B illustrates an example of a new sub-category screen displayed on the user device according to an embodiment of the disclosure;

FIG. 30A illustrates an example of a sub-category screen displayed on the user device according to an embodiment of the disclosure;

FIG. 30B illustrates an example of a first edit sub-category screen displayed on the user device according to an embodiment of the disclosure;

FIG. 31A illustrates an example budget screen for savings displayed on the user device according to an embodiment of the disclosure;

FIG. 31B illustrates an example of a second edit sub-category screen displayed on the user device according to an embodiment of the disclosure;

FIG. 32A illustrates the example budget screen shown in FIG. 31A according to an embodiment of the disclosure;

FIG. 32B illustrates an example of a third edit sub-category screen displayed on the user device according to an embodiment of the disclosure;

FIG. 33 illustrates a block diagram of an example computing system for implementing various embodiments in the examples described herein according to an embodiment of the disclosure;

FIG. 34 illustrates a flowchart of an example method of operating a finance management application disclosed in the various embodiments described herein according to an embodiment of the disclosure;

FIG. 35 illustrates an example of a splash screen displayed on the user device according to an embodiment of the disclosure;

FIG. 36 illustrates an example of a sign in screen displayed on the display screen according to an embodiment of the disclosure;

FIG. 37 illustrates the example of a sign in screen shown in FIG. 36 according to an embodiment of the disclosure;

FIG. 38 illustrates an example password reset screen displayed on the display screen according to an embodiment of the disclosure;

FIG. 39 illustrates the example password reset screen shown in FIG. 38 according to an embodiment of the disclosure;

FIG. 40 illustrates the example password reset screen shown in FIG. 38 according to an embodiment of the disclosure;

FIG. 41 illustrates an example password reset screen displayed on the display screen according to an embodiment of the disclosure;

FIG. 42 illustrates an example sign in screen displayed on the display screen according to an embodiment of the disclosure;

FIG. 43 illustrates an example create account screen displayed on the display screen according to an embodiment of the disclosure;

FIG. 44 illustrates the example sign in screen shown in FIG. 43 according to an embodiment of the disclosure;

FIG. 45 illustrates an example create account screen displayed on the display screen according to an embodiment of the disclosure;

FIG. 46 illustrates the example create account screen shown in FIG. 45 according to an embodiment of the disclosure;

FIGS. 47A-47F illustrate screens displayed on the display screen for a tutorial of the financial management application according to an embodiment of the disclosure;

FIG. 48 illustrates a ready to start screen displayed on the display screen according to an embodiment of the disclosure;

FIG. 49 illustrates an alternate ready to start screen displayed on the display screen according to an embodiment of the disclosure;

FIG. 50 illustrates a create budget screen displayed on the display screen according to an embodiment of the disclosure;

FIG. 51 illustrates a new budget screen displayed on the display screen according to an embodiment of the disclosure;

FIG. 52 illustrates a new budget screen displayed on the display screen according to an embodiment of the disclosure;

FIG. 53 illustrates a new budget screen displayed on the display screen according to an embodiment of the disclosure;

FIG. 54 illustrates an example introductory screen displayed on the display screen according to an embodiment of the disclosure;

FIG. 55 illustrates another example introductory screen displayed on the display screen according to an embodiment of the disclosure;

FIG. 56 illustrates example adaptable icons that may be displayed on an introductory screen according to an embodiment of the disclosure;

FIGS. 57A-57F illustrate example headers that may be displayed in a display screen according to embodiments of the disclosure;

FIG. 58 illustrates a table screen displayed on the display screen according to an embodiment of the disclosure;

FIG. 59 illustrates a table screen displayed on the display screen according to an embodiment of the disclosure;

FIG. 60 illustrates an example screen displayed on the display screen that displays a surplus graph according to an embodiment of the disclosure;

FIG. 61 illustrates an example screen of the surplus graph in a landscape view according to an embodiment of the disclosure;

FIG. 62 illustrates an example screen displayed on the display screen that displays a surplus graph according to an embodiment of the disclosure;

FIG. 63 illustrates an example screen displayed on the display screen that displays a burndown graph according to an embodiment of the disclosure;

FIG. 64 illustrates an example category overview screen displayed on the display screen according to an embodiment of the disclosure;

FIG. 65 illustrates an example category details screen displayed on the display screen according to an embodiment of the disclosure;

FIG. 66 illustrates an example sub-category overview screen displayed on the display screen according to an embodiment of the disclosure;

FIG. 67 illustrates an example budget screen displayed on the display screen according to an embodiment of the disclosure;

FIGS. 68A-68B illustrate example new category screens displayed on the display screen according to an embodiment of the disclosure;

FIG. 69 illustrates an example edit category screen displayed on the display screen according to an embodiment of the disclosure;

FIG. 70 illustrates an example delete category screen displayed on the display screen according to an embodiment of the disclosure;

FIG. 71 illustrates an example delete sub-category screen displayed on the display screen according to an embodiment of the disclosure;

FIG. 72 illustrates an example new sub-category screen displayed on the display screen according to an embodiment of the disclosure;

FIG. 73 illustrates an example delete screen displayed on the display screen according to an embodiment of the disclosure;

FIG. 74 illustrates a portion of an example new sub-category screen displayed on the display screen according to an embodiment of the disclosure;

FIG. 75 illustrates a portion of an example new sub-category screen displayed on the display screen according to an embodiment of the disclosure;

FIG. 76 illustrates a portion of an example new sub-category screen displayed on the display screen according to an embodiment of the disclosure;

FIG. 77 illustrates an example expense screen displayed on the display screen according to an embodiment of the disclosure;

FIG. 78 illustrates an example filter for an expense screen displayed on the display screen according to an embodiment of the disclosure;

FIG. 79 illustrates an example filter for an expense screen displayed on the display screen according to an embodiment of the disclosure;

FIG. 80 illustrates an example filter for the expense screen shown in FIG. 79 according to an embodiment of the disclosure;

FIG. 81 illustrates an example filter for an expense screen displayed on the display screen according to an embodiment of the disclosure;

FIG. 82 illustrates a new variable expense screen displayed on the display screen according to an embodiment of the disclosure;

FIG. 83 illustrates the new variable expense screen shown in FIG. 82 according to an embodiment of the disclosure;

FIG. 84 illustrates an edit variable expense screen displayed on the display screen according to an embodiment of the disclosure;

FIG. 85 illustrates the edit variable expense screen shown in FIG. 84 according to an embodiment of the disclosure;

FIG. 86 illustrates an example expense screen displayed on the display screen according to an embodiment of the disclosure;

FIG. 87 illustrates an example edit expense screen displayed on the display screen according to an embodiment of the disclosure;

FIG. 88 illustrates an example menu screen displayed on the display screen according to an embodiment of the disclosure;

FIG. 89 illustrates an example settings screen displayed on the display screen according to an embodiment of the disclosure;

FIG. 90 illustrates a portion of a screen displayed on the display screen according to an embodiment of the disclosure; and

FIG. 91 illustrates a portion of a screen displayed on the display screen according to an embodiment of the disclosure.

### DETAILED DESCRIPTION

Embodiments described herein provide systems and methods for real-time tracking of expenses and savings. An overall snapshot of a user's spending and/or savings state is provided in real time considering the timing of variable and scheduled expenses. A variable expense may be an expense where the amount to be paid changes over time. For example, expenses associated with utilities, transportation, gifts, and food typically vary over time (e.g., from month to month) and may be classified as variable expenses. Other expenses, such as housing, insurance, loan payments (e.g., car payments), and subscription services typically remain consistent over time and may be classified as scheduled expenses. Various graphs may be computed and displayed in one or more screens. The graphs may show budgets, spending, amounts of budgets remaining, actual amount remaining, savings, end of year projections, and/or projections to budget surplus states. The overall snapshot and the graphs can be provided for every day of the year and are nearly instantaneously updated based on newly incurred or entered expenses (both variable and scheduled). An overall spending state and an overall savings state may be computed in real time and available for viewing in one or more screens. Categories and sub-category spending and savings states can be computed in real time and available for viewing in one or more screens.

Embodiments of the disclosure can be fun and challenging for a user, which can result in the user interacting with the systems and methods for real-time tracking of expenses and savings every day or multiple times a day. The user can determine a planned and/or an actual amount of cash left at any moment in time to assist the user in planning expenditures and savings. The user can be shown a financial path the user is supposed to be following as well as an actual financial path the user is on to enable the user to take any corrective actions. For any point in time, the user may compare the amount of money the user expected to spend with the amount of money the user has spent. Similarly, for any point in time, the user may compare the amount of money the user expected to save with the amount of money the user has saved. The user may also view a trend of how he or she is doing over a given time period (e.g., a week, a month, a year, etc.).

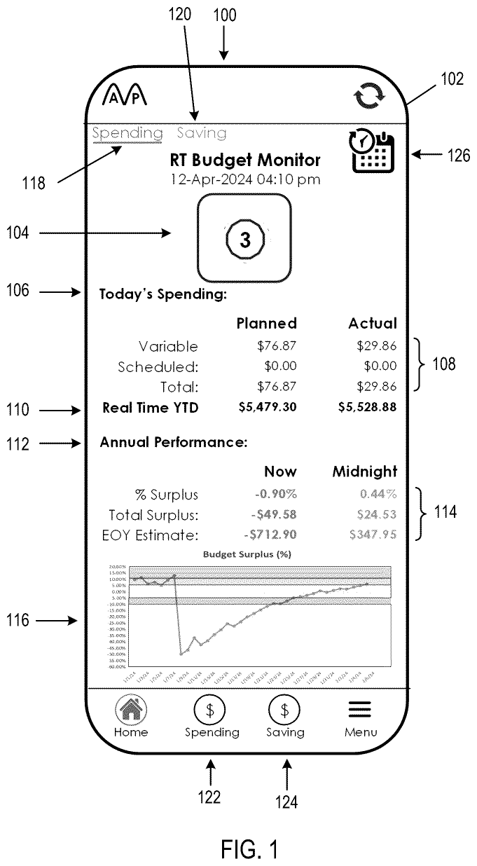

FIG. 1 illustrates a first example of an introductory screen 100 of a finance management application displayed on a user device 102 according to an embodiment of the disclosure. In one embodiment, the example introductory screen 100 may be a home screen of a software application or a home page of a web-based application. The user device 102 may be a smartphone, a desktop computer, a laptop computer, a tablet, a wearable device, a display screen connected to a computing device, a smart appliance, and the like.

The illustrated introductory screen 100 is a spending introductory screen that includes an adaptable icon 104, a summary section 106 that presents a summary of spending (e.g., a real-time summary of spending), and one or more metrics 108 associated with the summary section 106 (e.g., real-time metrics). The one or more metrics 108 include, but are not limited to, variable expenditures, scheduled expenditures, and a total amount of expenditures. The metric(s) 108 are arranged in a planned column and an actual column to enable a user to view a real-time spending state for the day when the introductory screen 100 is opened and while the introductory screen 100 is viewed. The user can compare their actual spending with their planned spending to determine whether there is a surplus or a deficit at any given point in time throughout the day.

The example introductory screen 100 further includes a real-time year-to-date total 110 for the planned and actual spending columns. This enables a user to determine how their actual spending compares to the planned spending when the introductory screen 100 is opened and while the introductory screen 100 is viewed.

The example introductory screen 100 also includes an annual performance section 112 and one or more metrics 114 associated with the annual performance section 112. The one or more metrics 114 include, but are not limited to, a surplus percentage listing, a total surplus listing, and an end-of-year estimate listing. The one or more metrics 114 are arranged in a “Now” column and an end-of-day (e.g., Midnight) column to enable a user to view the current listing amounts and the listing amounts at the end of the day.

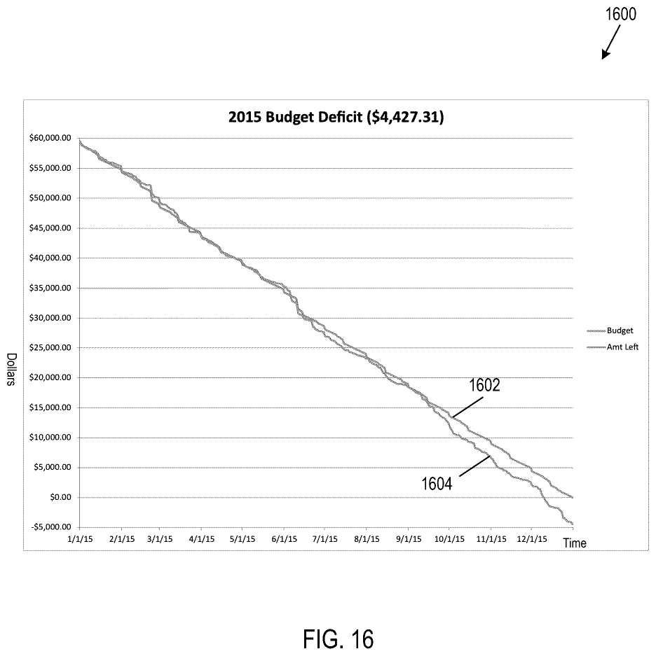

In the illustrated embodiment, the example introductory screen 100 includes a graph section 116 that can display one or more graphs for the user. In FIG. 1, the graph section 116 presents a budget surplus (%) chart. Some or all of the area in a graph may be color-coded to represent the different states of spending during a given time period (e.g., a day, a month, a quarter, etc.). The user can select (e.g., tap or swipe) the currently displayed graph to view additional graphs. The additional graphs can be viewed individually or in a stacked format that presents some or all of the available graphs. When viewed in the stacked format, the user can select a single graph to view in the graph section 116 (or in a separate screen). A graph may be presented as any type of a graph, including, but not limited to, a bar chart, a graph with plots (shown), a pie chart, and the like. Non-limiting nonexclusive examples of graphs that can be presented are shown and described in more detail in conjunction with FIGS. 16-26.

The adaptable icon 104, the summary section 106, the metric(s) 108, the year-to-date total 110, the annual performance section 112, the metric(s) 114, and the graph section 116 can change in real time throughout the day based on the user's expenditures (either variable or scheduled) or lack of expenditures. The adaptable icon 104, the summary section 106, the metric(s) 108, the year-to-date total 110, the annual performance section 112, the metric(s) 114, and the graph section 116 are provided in real-time and are nearly instantaneously updated as new planned and actual spending (both variable and scheduled) are input or received by the finance management application.

The adaptable icon 104 may function as a visual aid regarding the user's current spending state at the time the introductory screen is opened or updated. The adaptable icon 104 can change in real-time as the actual expenditures and expected variable expense amounts change throughout the day. In some embodiments, the adaptable icon 104 can change between a blue color that represents excellent spending state (e.g., a significantly lower than budgeted spending level), a green color that represents a good spending state (e.g., a lower than budgeted spending level), a yellow color that represents a caution spending state (e.g., an even or slightly higher or lower than budgeted spending level), a red color representing a poor spending state (e.g., a higher than budgeted spending level), and a white color representing a worst spending state (e.g., significantly higher than budgeted spending level). The user's spending state is highlighted by the adaptable icon 104, enabling the user to adjust their spending during the day to change (e.g., improve) the spending state. Other embodiments can use a different number of colors and/or spending states, and/or icon shapes, and/or different pattern fills for the spending states, or other adaptable visual representations of the spending states, cither by default or by user customization.

The adaptable icon 104 may change in real-time positively (less than budgeted spending) or negatively (greater than budgeted spending) throughout the day. For example, if the actual variable expenditures incurred are less than the expected variable expenditures, the budget surplus or deficit continuously improves and may place the current spending state at a higher spending state (and vice versa). With respect to scheduled expenditures, spending less than expected can improve the spending state as well. In some embodiments, the scheduled expenditures become “expected” at a particular time of day (e.g., Midnight), and at that particular time of day the adaptable icon 104 may change.

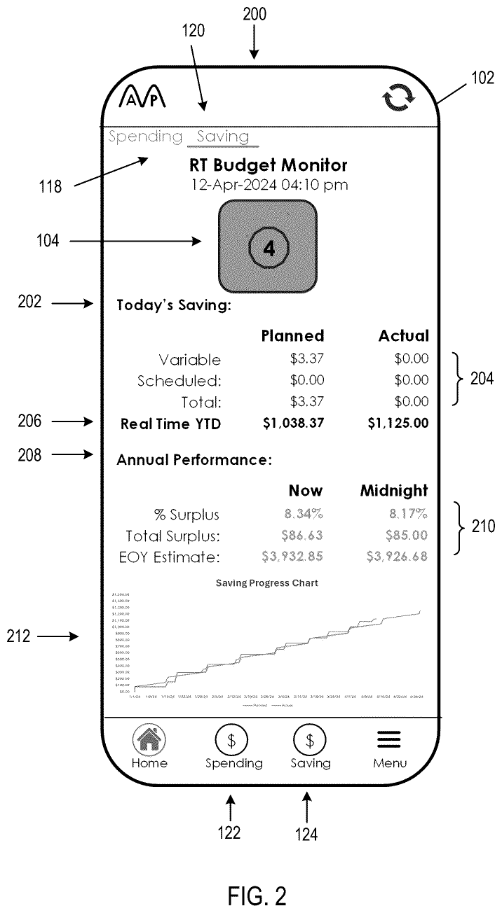

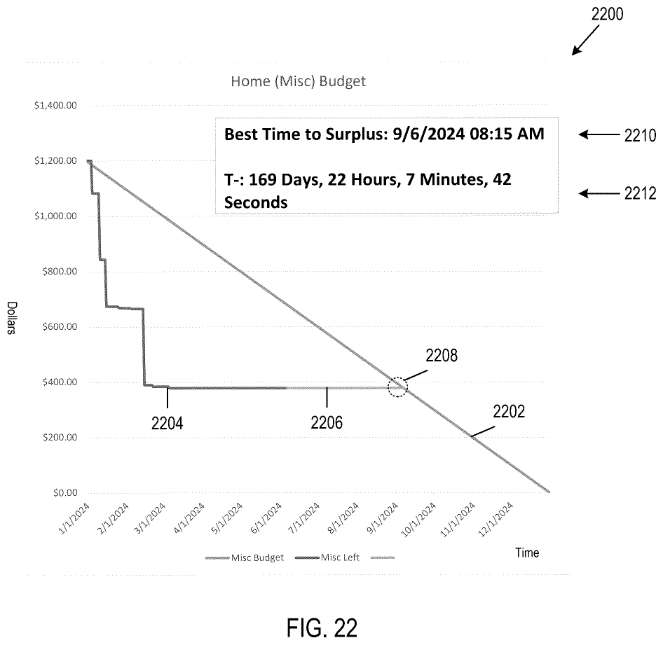

The example introductory screen 100 is identified by a tab or screen label 118 (“Spending” is the subject of the example introductory screen 100 in FIG. 1). Although not shown in FIG. 1, another introductory screen can be included for savings (screen label 120; See FIG. 2). A user can select a spending icon 122 or a savings icon 124 to switch between or view the first example introductory screen 100 and another example introductory screen (e.g., the savings introductory screen 200 of FIG. 2). In some embodiments, a user can swipe the first introductory screen 100 (e.g., swipe left) to view another screen (e.g., the savings introductory screen). Additionally, the user can select (e.g., tap) the calendar countdown icon 126 to view the shortest time to a budget surplus, where the time calculation may be based on the variable expenses only. In one embodiment, the shortest time to a budget surplus may be presented as a date and/or a graph (e.g., see FIG. 22).

FIG. 2 illustrates a second example of an introductory screen 200 of a finance management application displayed on the user device 102 according to an embodiment of the disclosure. The illustrated example introductory screen 200 is a savings introductory screen that presents the adaptable icon 104, a summary section 202 that presents a summary of savings (e.g., a real-time summary of savings), and one or more metrics 204 associated with the summary section 202 (e.g., real-time metrics). The one or more metrics 204 include, but are not limited to, variable savings, scheduled savings, and a total amount of savings. The metric(s) 204 are arranged in a planned column and an actual column to enable a user to view a real-time savings state for the day when the introductory screen 200 is opened and while the introductory screen 200 is viewed. The user can compare their actual savings with their planned savings to determine whether there is a surplus or a deficit at any given point in time throughout the day.

The example introductory screen 200 further includes a real-time year-to-date total 206 for the planned and actual savings columns. This enables a user to determine how their actual savings compare to the planned savings when the introductory screen 200 is opened and while the introductory screen 200 is viewed.

The introductory screen 200 also includes an annual performance section 208 (e.g., a real-time annual performance) and one or more metrics 210 (e.g., real-time metrics) associated with the annual performance section 208. The one or more metrics 210 include, but are not limited to, a surplus percentage listing, a total surplus listing, and an end-of-year estimate listing. The metric(s) 210 are arranged in a now column and an end-of-day (e.g., Midnight) column to enable a user to view the current listing amounts and the listing amounts at the end of the day.

In the illustrated embodiment, the introductory screen 200 includes a graph section 212 that can display one or more graphs for the user. In FIG. 2, the graph section 212 presents a savings progress chart over a period of time (e.g., a day, a week, a month, a quarter, etc.). Some or all of the area in the graph may be color-coded (not shown) to represent the different states of savings. The user can select (e.g., tap or swipe) the currently displayed graph to view additional graphs. The additional graphs can be viewed individually or in a stacked format that presents some or all of the available graphs. When viewed in the stacked format, the user can select (e.g., tap or swipe) a single graph to view in the graph section 212 (or in a separate screen). A graph may be presented as any type of a graph, including, but not limited to, a bar chart, a graph with plots (shown), a pic chart, and the like. Non-limiting nonexclusive examples of graphs that can be presented are shown and described in more detail in conjunction with FIGS. 16-26.

As described earlier, the adaptable icon 104, the summary section 202, the metric(s) 204, the year-to-date total 206, the annual performance section 208, the metric(s) 210, and the graph section 212 can change in real time throughout the day based on the user's savings (either variable or scheduled) or lack of savings. The adaptable icon 104 may function as a visual aid regarding the user's current state of savings. The adaptable icon 104, the summary section 202, the metric(s) 204, the year-to-date total 206, the annual performance section 208, the metric(s) 210, and the graph section 212 are provided in real-time and are nearly instantaneously updated as new planned and actual spending (both variable and scheduled) are input or received by the finance management application. For example, the adaptable icon 104 can change between a blue color that represents excellent savings state (e.g., a significantly higher than budgeted savings level), a green color that represents a good savings state (e.g., a higher than budgeted savings level), a yellow color that represents a caution savings state (e.g., an even or slightly higher or lower than budgeted savings level), a red color representing a poor savings state (e.g., a lower than budgeted savings level), and a white color representing a worst savings state (e.g., significantly lower than budgeted savings level). The user's savings state is highlighted by the adaptable icon 104, enabling the user to adjust their savings during the day to change (e.g., improve) the savings state. Other embodiments can use a different number of colors or savings states, and/or icon shapes, and/or different pattern fills for the spending states, or other adaptable visual representations of the spending states, either by default or by user customization.

A user can select the spending icon 122 or the savings icon 124 to switch between the first example introductory screen 100 and the second example introductory screen 200. In some embodiments, a user can swipe the second introductory screen 200 (e.g., swipe left) to view the first introductory screen 100.

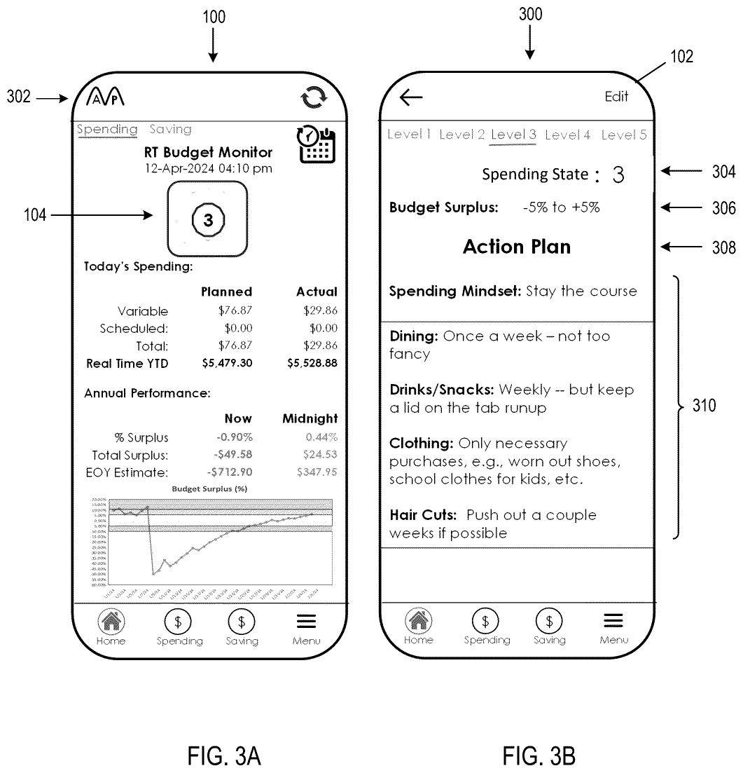

FIG. 3A illustrates the first example of the introductory screen 100 shown in FIG. 1, and FIG. 3B illustrates an example action plan screen 300 displayed on the user device 102 according to an embodiment of the disclosure. A user may select (e.g., tap) the action plan (AP) icon 302 on the introductory screen 100 to open the action plan screen 300. The action plan screen 300 includes a real-time spending level notification 304, a real-time budget surplus level 306 (e.g., shown as a range), and an example action plan 308 in an action plan section 310. The spending level notification 304 corresponds to the spending state represented by the adaptable icon 104. The budget surplus 306 is shown as falling within a range, although other embodiments are not limited to this implementation. A single percentage, a word or phrase (e.g., excellent, good, etc.) and/or a color can be used in other embodiments.

The action plan 308 may include a one or more recommendations to assist the user in maintaining and/or improving their spending state. In the illustrated embodiment, the recommendations include suggestions regarding dining out, drinks or snacks, clothing purchases, and haircuts. The recommendations may be based on the budget for that day, week, month or other time period. A user may edit or customize the contents of the action plan (e.g., the subjects and/or suggestions included in the recommendation). Additional or different subjects for the recommendations can be used in other embodiments (e.g., entertainment activities, transportation, etc.).

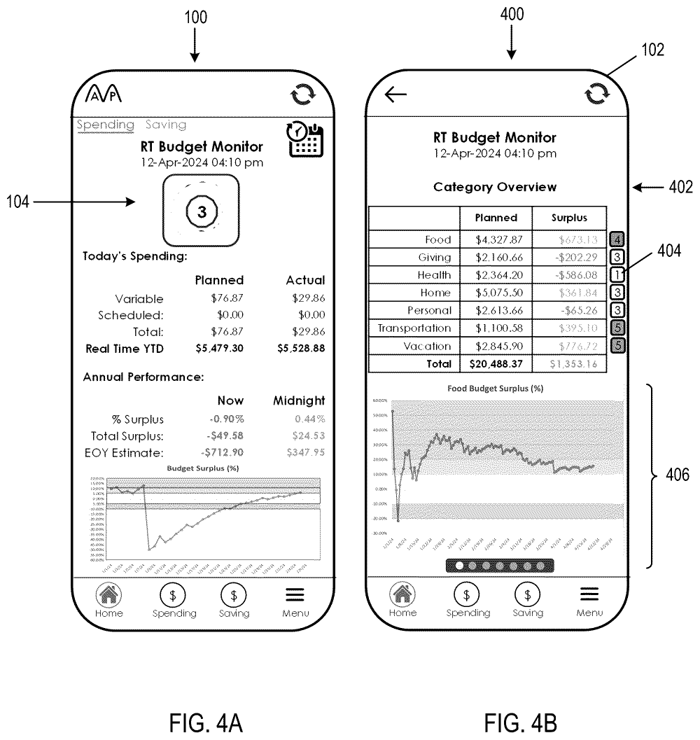

FIG. 4A illustrates the first example of the introductory screen 100 shown in FIG. 1, and FIG. 4B illustrates an example category overview screen 400 displayed on the user device 102 according to an embodiment of the disclosure. The user may select (e.g., tap or swipe) the adaptable icon 104 on the introductory screen 100 to open the category overview screen 400. The category overview screen 400 includes a category overview section 402 that shows a real-time total spending in each category of the budget along with a real-time total spending for all of the categories. In the illustrated embodiment, the categories include food, giving, health, home, personal, transportation, and vacation. The category subjects and/or the number of categories can differ in other embodiments.

The categories may be presented in a table with a planned column and a surplus column. The planned column lists planned expenditures for each category. The surplus column lists a positive surplus entry or a negative surplus entry (e.g., a deficit) for each category when the category overview screen 400 is opened and while the category overview screen 400 is viewed. The surplus entries may be color coded to indicate whether the surplus is positive or negative. One or more of the categories can further present an individual adaptable icon 404 for each category. Each individual adaptable icon 404 may be implemented similar to the adaptable icon 104.

In the illustrated embodiment, the example category overview screen 400 further includes a graph section 406 that can display one or more graphs for the user. In FIG. 4B, the graph section 406 presents a food budget surplus for the category of food. Some or all of the area in the graph may be color-coded to represent the different states of spending during a given time period (e.g., a day, a month, a quarter, etc.). The user can select (e.g., tap or swipe) the currently displayed graph to view additional graphs for the categories. The additional graphs may be viewed individually or in a stacked format that presents some or all of the available graphs. When viewed in the stacked format, the user can select (e.g., tap or swipe) a single graph to view in the graph section 406 (or in a separate screen). A graph may be presented as any type of a graph, including, but not limited to, a bar chart, a graph with a plot (shown), a pie chart, and the like.

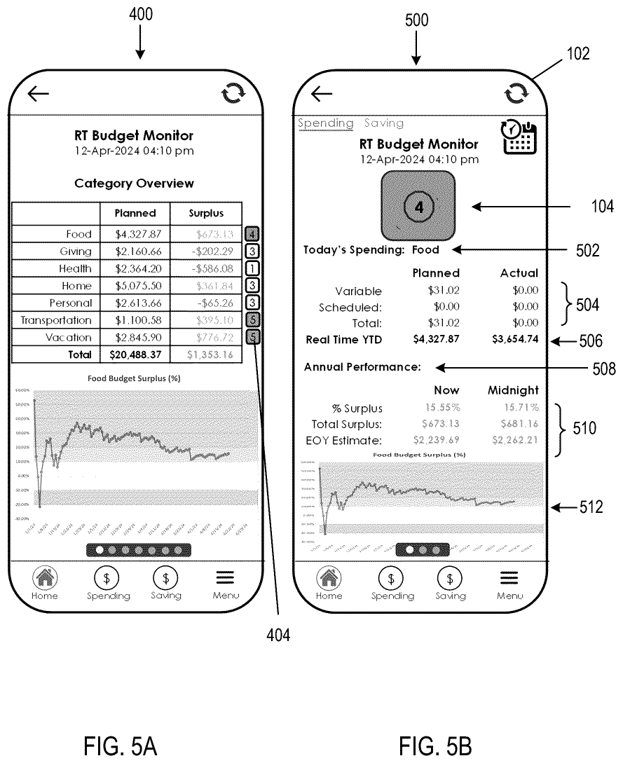

FIG. 5A illustrates the example category overview screen 400 shown in FIG. 4B, and FIG. 5B illustrates an example category details screen 500 displayed on the user device 102 according to an embodiment of the disclosure. A user may select (e.g., tap) an individual adaptable icon 404 on the category overview screen 400 to open the example category details screen 500. Additionally or alternatively, the user can select a category name and/or an entry in the category table to open the category details screen 500 in other embodiments.

The category details screen 500 includes the adaptable icon 104, a category overview section 502 of spending in the selected category along with one or more metrics 504 associated with the selected category. As shown in FIG. 5, the one or more metrics 504 include, but are not limited to, variable expenditures, scheduled expenditures, and a total amount of expenditures. The metric(s) 504 are arranged in a planned column and an actual column to enable a user to view a spending performance for the day. The user can compare their actual spending with their planned spending to determine whether there is a surplus or a deficit. The metric(s) 504 are provided in real-time and are nearly instantaneously updated as new planned and actual spending (both variable and scheduled) are input or received by the finance management application.

The category details screen 500 further includes a real-time year-to-date total 506 for the planned and actual spending columns. This enables a user to determine how their actual spending in the category compares to the planned spending in real time.

The category details screen 500 also includes an annual performance section 508 and one or more metrics 510 associated with the annual performance section 508. The one or more metrics 510 include, but are not limited to, a surplus percentage listing, a total surplus listing, and an end-of-year estimate listing. The one or more metrics 510 are arranged in a “Now” column and an end-of-day (e.g., Midnight) column to enable a user to view the current amounts and the amounts at the end of the day.

In the illustrated embodiment, the category details screen 500 includes a graph section 512 that can display one or more graphs for the user. In FIG. 5B, the graph section 512 presents a food budget surplus (%) chart. Some or all of the area in a graph may be color-coded to represent the different states of spending during a given time period (e.g., a day, a month, a quarter, etc.). The user can tap or swipe (e.g., swipe left) the currently displayed graph to view additional graphs. The additional graphs can be viewed individually or in a stacked format that presents some or all of the available graphs. When viewed in the stacked format, the user can select (e.g., tap or swipe) a single graph to view that graph in the graph section 512 (or in a separate screen). A graph may be presented as any type of a graph, including, but not limited to, a bar chart, a graph with a plot (shown), a pie chart, and the like. Non-limiting nonexclusive examples of charts that can be presented are shown and described in more detail in conjunction with FIGS. 16-26.

The adaptable icon 104, the category overview section 502, the metric(s) 504, the year-to-date total 506, the annual performance section 508, the metric(s) 510, and the graph section 512 are provided in real-time and are nearly instantaneously updated as new planned and actual spending (both variable and scheduled) are input or received by the finance management application. The adaptable icon 104, the category overview section 502, the metric(s) 504, the year-to-date total 506, the annual performance section 508, the metric(s) 510, and the graph section 512 can change in real time throughout the day based on the user's spending (either variable or scheduled) or lack of spending. As described previously, the adaptable icon 104 may function as a visual aid regarding the user's current spending state for the category shown in the category details screen 500 (e.g., food).

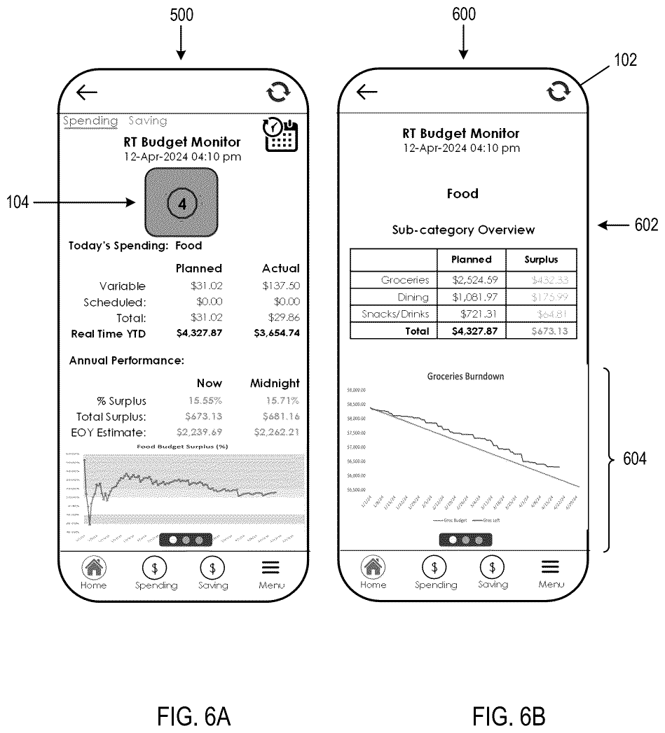

FIG. 6A illustrates the example category details screen 500 shown in FIG. 5B, and FIG. 5B illustrates an example sub-category overview screen 600 displayed on the user device 102 according to an embodiment of the disclosure. A user may select (e.g., tap) the adaptable icon 104 on the example category details screen 500 to open the sub-category overview screen 600. The sub-category overview screen 600 includes a sub-category spending overview section 602 that is associated with the category displayed in the category details screen 500. The sub-category overview section 602 shows a real-time total spending in each sub-category along with a real-time total spending for all of the sub-categories. In the illustrated embodiment, the sub-categories include groceries, dining, and snacks/drink. The sub-category subjects and/or the number of sub-categories can differ in other embodiments.

The sub-categories may be presented in a table with a planned column and a surplus column. The planned column lists planned expenditures for each sub-category. The surplus column lists a positive surplus entry or a negative surplus entry (e.g., a deficit) for each sub-category. The surplus entries may be color coded to indicate whether the surplus is positive or negative.

In the illustrated embodiment, the sub-category overview screen 600 further includes a graph section 604 that can display one or more graphs for the user. In FIG. 6B, the graph section 604 presents a burndown graph for the sub-category of groceries. Some or all of the area in a graph may be color-coded (not shown) to represent the different states of spending during a given time period (e.g., a day, a month, a quarter, etc.). The user can select (e.g., swipe) the currently displayed graph to view additional graphs. The additional graphs can be viewed individually or in a stacked format that presents some or all of the available graphs. When viewed in the stacked format, the user can select (e.g., tap or swipe) a single graph to view that graph in the graph section 604 (or in a separate screen). A graph may be presented as any type of a chart, including, but not limited to, a bar chart, a graph with plots (shown), a pie chart, and the like.

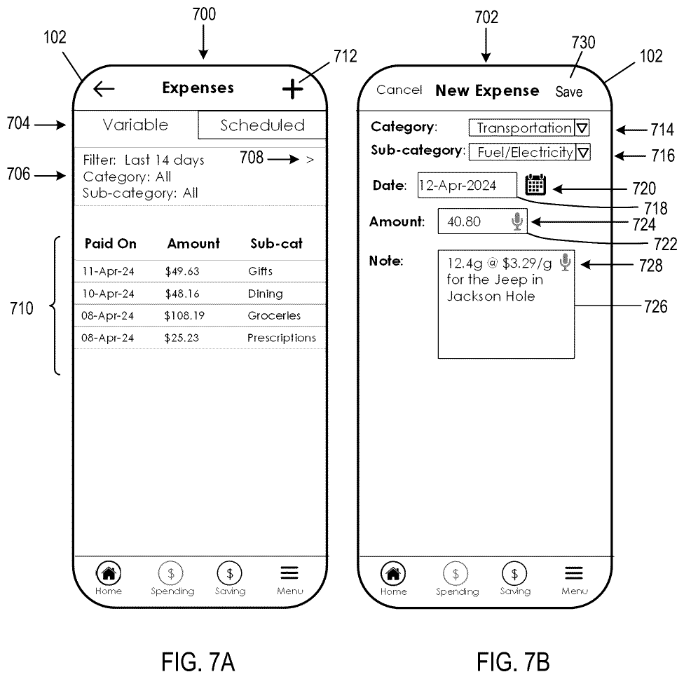

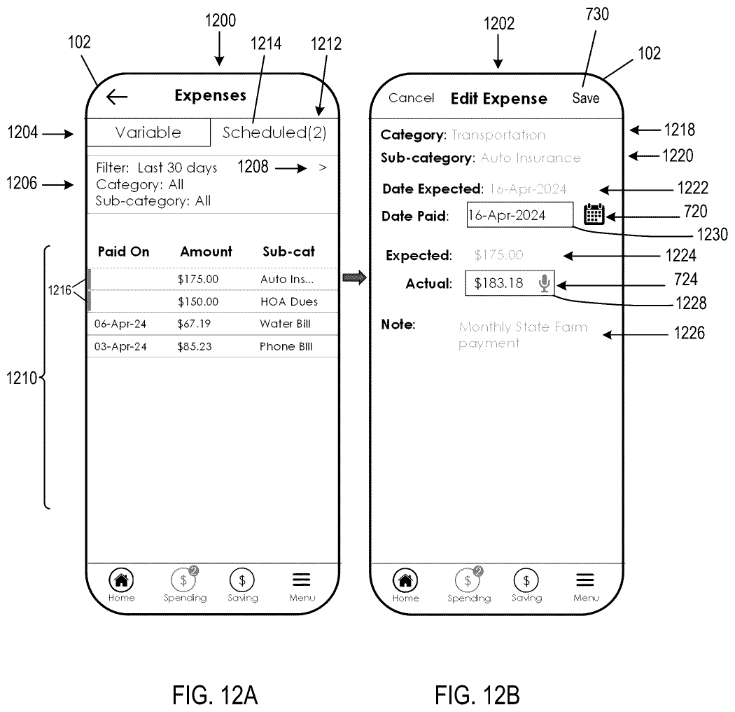

FIG. 7A illustrates an example expenses screen 700 for variable expenses displayed on the user device 102 according to an embodiment of the disclosure. FIG. 7B illustrates an example new expense screen 702 displayed on the user device 102 according to an embodiment of the disclosure. The user may select (e.g., tap) the “spending” icon on any screen (e.g., the spending icon 122 on the introductory screen 100 of FIG. 1) to open the expenses screen 700. The expenses screen 700 includes a variable expenses screen (shown in FIG. 7A) and a scheduled expenses screen (shown in FIG. 12A). The user may select which of the variable expenses screen or the scheduled expenses screen to display using the selectable controls 704.

A filter section 706 can include one or more filters that are used to filter the expenses to be displayed in the expenses screen 700. For example, in FIG. 7A, the filters are a time period (e.g., fourteen days), a category (e.g., all), and a sub-category (e.g., all). Additional or different filters may be used and/or the user can customize the filters in other embodiments. For example, the user can select (e.g., tap) the control element 708 to apply an additional or a different filter or filters. Additionally or alternatively, in some embodiments the filter(s) that are displayed in the filter section 706 may initially be set to default filter(s) and default setting(s) that the user can modify via the control element 708.

The expenses screen 700 includes a listing of expenses section 710, where the variable expenses that correspond to the selected filter(s) 706 are presented. In the illustrated embodiment, the listing of expenses section 710 displays a date the expense is paid, an amount of the expense, and a sub-category associated with the expense. The variable expenses listed in the listing of expenses section 710 may be listed in any order. For example, the expenses can be presented in descending date order or ascending amount order. In one embodiment, the listing of expenses section 710 may be collapsed and only the category expenses or the sub-category expenses are shown when a category or a sub-category, respectively, is selected as a filter.

The user can select (e.g., tap) the control element 712 to open the new expense screen 702 shown in FIG. 7B. In one embodiment, the new expense will be categorized as a variable expense or as a schedule expense depending on which of the variable expense screen or the schedule expense screen is displayed in the expenses screen 700 when the control element 712 is selected. The user selects the category for the new expense via the drop-down menu 714 and the sub-category for the new expense (if there is a sub-category) using the drop-down menu 716. Input elements other than drop-down menus may be used in other embodiments. For example, links or text boxes can be used to input a category and a sub-category.

A date the expense is to be paid (for a scheduled expense) or is paid (for a variable expense) is entered into the textbox 718 or using the calendar object 720. An amount of the new expense is entered into the text box 722. In some embodiments, the amount may be input via an audio input (e.g., speech) by selecting the audio input icon 724. When the audio input icon 724 is selected, an audio input device (e.g., a microphone) receives the date as an audio input. The user may input a note in the notes text box 726. In some embodiments, the note(s) may be input via an audio input by selecting the audio input icon 728.

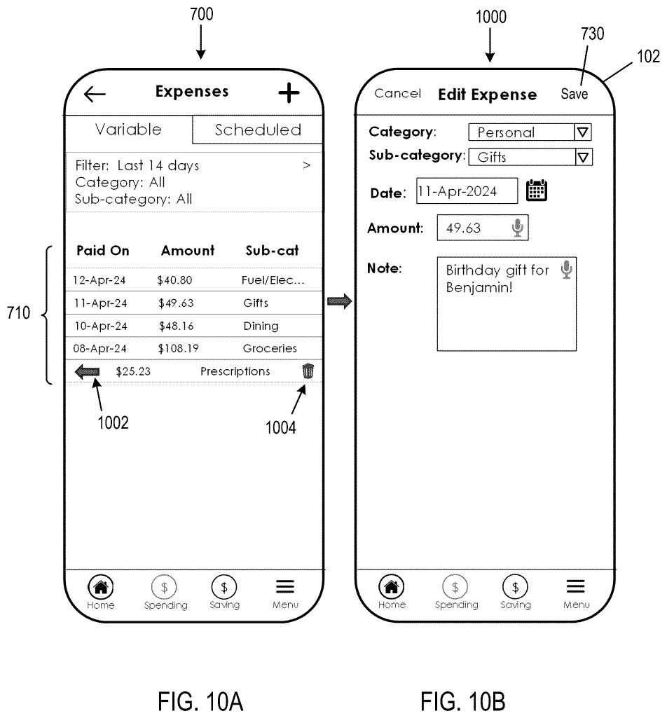

The user can select the “Save” command 730 when the entries to the new expense screen 702 are completed. In one embodiment, the finance management application returns to the expenses screen 700 in response to the selection of the “Save” command 730, enabling the user to add another new expense or to edit a previously entered expense. For example, a user can edit an existing expense by selecting (e.g., taping or swiping) the expense listing when the expense is displayed in the listing of expenses section 710. An example edit expense screen is shown and described in more detail in conjunction with FIG. 10B.

In some embodiments, visual feedback, audio feedback and/or tactile feedback may be provided in response to the selection of the “Save” command 730. For example, a sound effect may be played or visual feedback presented upon clicking the “Save” command 730 if the expense negatively impacts (e.g., lowers) the spending state for the category associated with the expense and/or negatively impacts the user's overall spending state. The type of feedback (e.g., audio or tactile), the intensity of the feedback, and/or the execution of the feedback (e.g., play a particular song or output a particular haptic pattern) can be chosen by the user (e.g., via a user profile) or may be set as a default that the user can customize.

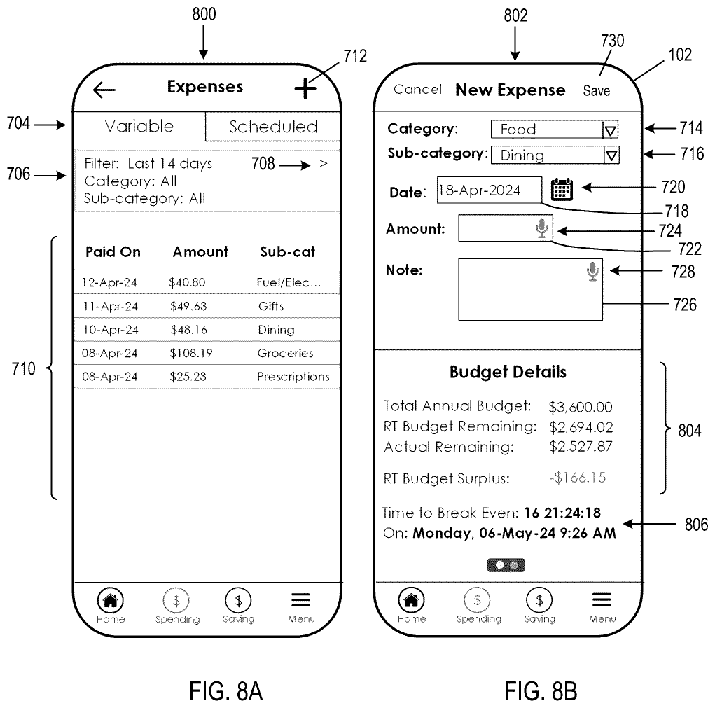

FIG. 8A illustrates another example expenses screen 800 for variable expenses displayed on the user device 102 according to an embodiment of the disclosure and FIG. 8B illustrates another example new expense screen 802 displayed on the user device 102 according to an embodiment of the disclosure. The example expenses screen 800 is similar to the example expenses screen shown in FIG. 7A. The expenses screen 800 includes the selectable controls 704 (for the variable expenses screen (shown in FIG. 8A) and the scheduled expenses screen (not shown)), the filter section 706, the control element 708, and the listing of expenses section 710. The user may select which of the variable expenses screen or the scheduled expenses screen to display using the selectable controls 704.

The user can select (e.g., tap) the control element 712 to open the new expense screen 802 shown in FIG. 8B. The new expense screen 802 is similar to the new expense screen 702 shown in FIG. 7B and includes the category drop-down menu 714, the sub-category drop-down menu 716, the date textbox 718, the calendar object 720, the amount text box 722, the audio input icon 724, the notes text box 726, and the audio input icon 728.

The new expense screen 802 further includes a budget details section 804. In the illustrated embodiment, the budget details section 804 lists a total annual budget amount, a real-time budget remaining amount, an actual budget remaining amount, and a real-time budget surplus amount (positive or negative (deficit)). The total annual budget amount, the real-time budget remaining amount, the actual budget remaining amount are based on a particular time period (e.g., a day, a week, two weeks, a month, etc.) for the category or the sub-category (when there is a sub-category). When the budget surplus amount is negative indicating a deficit, a countdown timer 806 can be shown that presents the amount of time to reach a breakeven point with respect to the budget surplus (e.g., the budget deficit and the budget surplus equal zero). The countdown timer 806 may present an amount of time and/or a date (and time) to reach the breakeven point. The countdown timer 806 can assist the user in determining whether or not to incur the expense (or a new expense) in the category or sub-category (if there is a sub-category). For example, in FIG. 8B the category is “food”, and the sub-category is “dining.” The countdown timer 806 can assist the user in determining whether or not to eat at a restaurant, and if cating at a restaurant, how much money to spend at the restaurant.

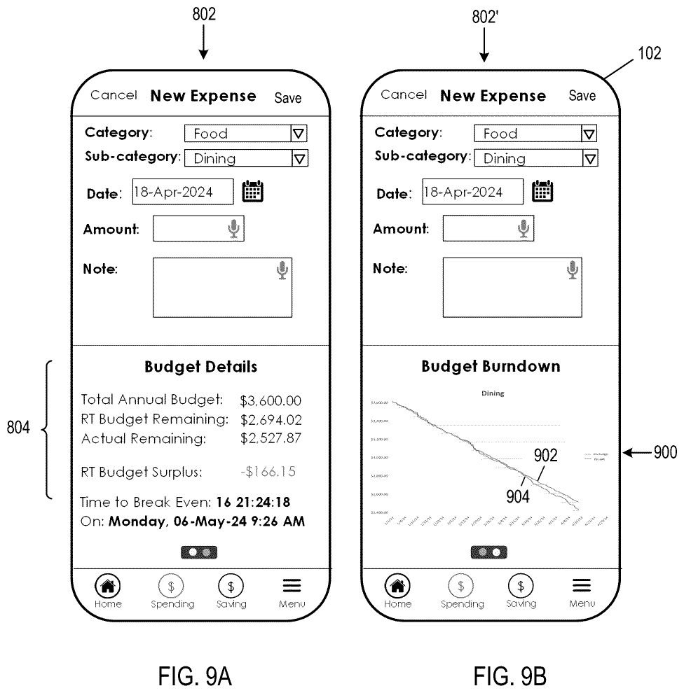

FIG. 9A illustrates the example new expense screen 802 shown in FIG. 8B, and FIG. 9B illustrates an example of an updated new expense screen 802′ displaying on the user device 102 according to an embodiment of the disclosure. The user may select (e.g., tap or swipe) the budget details section 804 to cause one or more graphs to be displayed in a graph section 900 of the new expense screen 802′. In the illustrated embodiment, the graph presented in the graph section 900 is a budget burndown graph. A user can select (e.g., tap or swipe) the graph to enter an interactive mode that enables the user to interact with the graph. For example, the user may zoom in or out and/or select a point or an area along one or both plots 902, 904 to view more budget details associated with the point or area. The plot 902 represents the budget for dining and the plot 904 represents the remaining dining budget. In FIG. 9B, the graph shows a budget surplus.

Some or all of the area in a graph may be color-coded (not shown) to represent the different states of spending during a given time period (e.g., a day, a month, a quarter, etc.). The user can select the currently displayed graph to view additional graphs. The additional graphs can be viewed individually or in a stacked format that presents some or all of the available graphs. When viewed in the stacked format, the user can select (e.g., tap or swipe) a single graph to view that graph in the graph section (or in a separate screen). A graph may be presented as any type of a graph, including, but not limited to, a bar chart, a graph with plots (shown), a pie chart, and the like. Non-limiting nonexclusive examples of graphs that can be presented are shown and described in more detail in conjunction with FIGS. 16-26.

FIG. 10A illustrates the example variable expenses screen 700 shown in FIG. 7A and FIG. 10B illustrates an edit expenses screen 1000 displayed on the user device 102 according to an embodiment of the disclosure. The user may swipe (e.g., swipe left 1002) on a particular expense listing in the listing of expenses section 710 to delete the listing. Alternatively, the user can swipe on the expense listing to cause a delete icon 1004 to be displayed, and the user may then select the delete icon 1004 to delete the listing.

The user may select (e.g., tap or swipe) a particular expense listing in the listing of expenses section 710 to open the edit expense screen 1000 of FIG. 10B. The user may view and/or edit the details associated with the expense. Once the edits are complete, the user can select the “Save” command 730 to save the edits and close the edit expense screen 1000 and to return to the expenses screen 700. Again, visual feedback, audio feedback and/or tactile feedback may be provided in response to the selection of the “Save” command 730 in some embodiments.

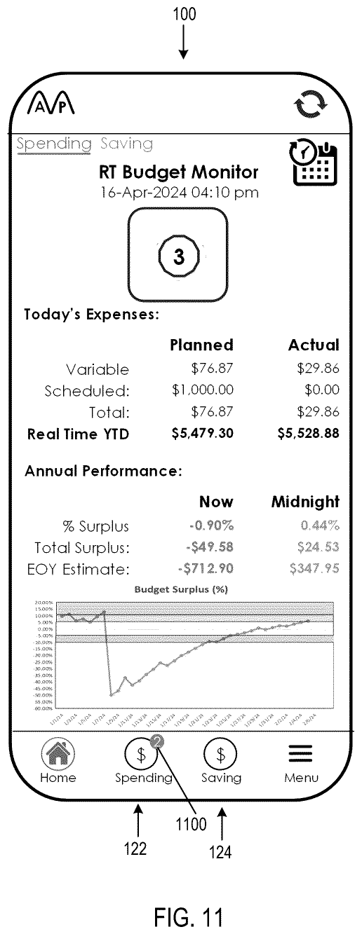

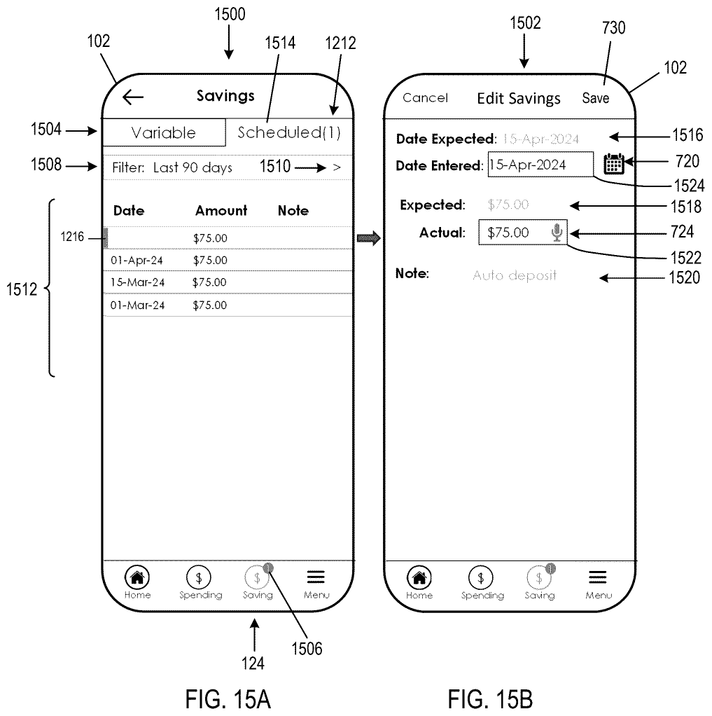

FIG. 11 illustrates a modified first example of the introductory screen 100 shown in FIG. 1 displaying a spending indicator 1100 according to an embodiment of the disclosure. In some embodiments, the amount of scheduled expenses shown in the introductory screen 100 represents the total amount of scheduled expenses that are due or overdue that day. When one or more scheduled expenses are outstanding and have not been entered or paid, the spending indicator 1100 may be presented at the spending icon 122. Similarly, when one or more scheduled savings have not occurred, a savings indicator (not shown) can be presented at the savings icon (e.g., see FIG. 15A). In the illustrated embodiment, the spending indicator 1100 is implemented as a number (e.g., “2”) that indicates the number of scheduled expenses (e.g., two) that have not been paid. The user can select the spending icon 122 to open a scheduled expenses screen (e.g., the scheduled expenses screen 1200 shown in FIG. 12A). In one embodiment, the total number of scheduled expenses that have not been entered or paid may appear on the software application icon or logo that is used to launch the software application. In another embodiment, a total number of scheduled expenses and scheduled savings that have not been entered or paid can appear on the software application icon or logo that is used to launch the software application.

FIG. 12A illustrates an example of a first scheduled expenses screen 1200 displayed on the user device 102 according to an embodiment of the disclosure. FIG. 12B illustrates a second example of an edit expenses screen 1202 displayed on the user device 102 according to an embodiment of the disclosure. The user may select which of the variable expenses screen or the scheduled expenses screen to display using the selectable controls 1204.

A filter section 1206 can include one or more filters that are used to filter the scheduled expenses to be displayed in the scheduled expenses screen 1200. For example, in FIG. 12A, the filters are a time period (e.g., thirty days), a category (e.g., all), and a sub-category (e.g., all). Additional or different filters may be used and/or the user can customize the filters in other embodiments. For example, the user can select (e.g., tap) the control element 1208 to apply an additional or a different filter or filters. Additionally or alternatively, in some embodiments the filter(s) that are displayed in the filter section 1206 may initially be set to default filter(s) and default setting(s) that the user can modify via the control element 1208.

The scheduled expenses screen 1200 includes a listing of expenses section 1210, where the scheduled expenses that correspond to the selected filter(s) 1206 are presented. In the illustrated embodiment, the listing of expenses section 1210 displays a date the scheduled expense is paid, an amount of the scheduled expense, and a sub-category associated with the scheduled expense (a category can be displayed if there is no sub-category). The listing of expenses section 1210 may be collapsed and only the category expenses or the sub-category expenses are shown when a category or a sub-category, respectively, is selected as a filter.

In some embodiments, the scheduled expenses in the listing of expenses section 1210 are presented in descending date order and the expected unpaid or non-entered scheduled expenses are at the top of the list. An indicator 1212 can be displayed next to the scheduled screen label 1214 when one or more scheduled expenses have not been entered or paid. Additionally or alternatively, an indicator 1216 may be presented in a listing when the scheduled expense has not been entered or paid. In the illustrated embodiment, two scheduled expenses have not been paid or entered (auto insurance and HOA dues) and an indictor 1216 appears in both listings. Other embodiments can present the scheduled expenses in the listing in a different order. For example, the scheduled expenses may be presented in ascending date order or by descending or ascending amounts paid.

The user may select (e.g., tap or swipe) a particular scheduled expense listing in the listing of expenses section 1210 to open the edit expense screen 1202 of FIG. 12B. The edit expense screen 1202 presents the category 1218 and sub-category 1220 (when there is a sub-category), the expected date 1222 for payment of the scheduled expense, the expected amount to be paid 1224 for the scheduled expense, and a notes entry 1226 (when there is a note entry). When an unpaid or unentered scheduled expense is paid or entered, the user can enter the actual amount paid in the text box 1228 (or use the audio input icon 724) and enter the date paid in the text box 1230 (or use the calendar object 720). Once the edits are completed, the user can select the “Save” command 730 to save the edits and close the edit expense screen 1202 and to return to the expenses screen 1200. Again, visual feedback, audio feedback and/or tactile feedback may be provided in response to the selection of the “Save” command 730 in some embodiments.

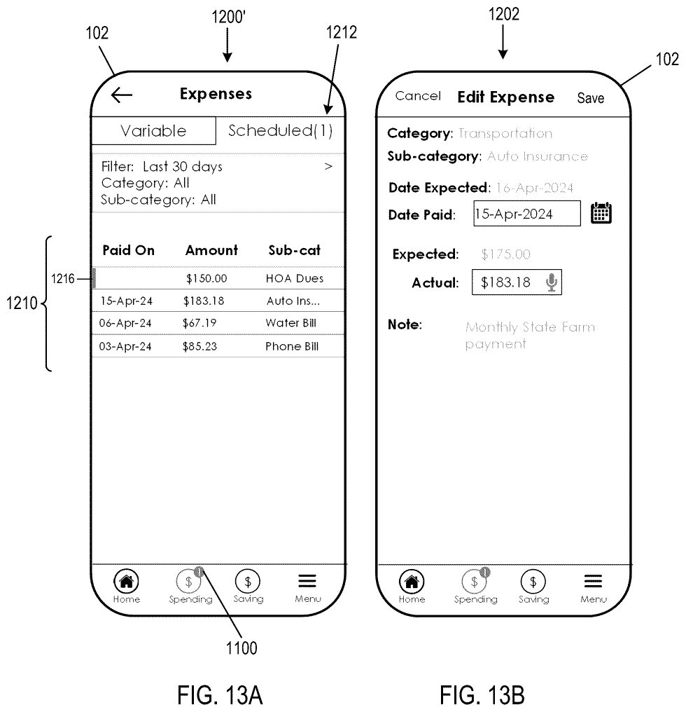

FIG. 13A illustrates an example of an updated scheduled expenses screen 1200′ displaying on the user device 102 according to an embodiment of the disclosure. FIG. 13B illustrates the second example of the edit expenses screen 1202 shown in FIG. 12B. When the user updates an unpaid or unentered scheduled expense with the payment and the date, the scheduled expenses screen 1202 updates to show the amount paid and the date of the payment. For example, in FIG. 13A, the date and the amount for the auto insurance listing are now listed (compare to FIG. 12A). The indicator 1216 in the auto insurance listing is removed and the indicators 1100, 1212 are updated to reflect the currently unpaid or unentered scheduled expenses. In the illustrated embodiment, the indicators 1100, 1212 now show “1” to reflect the unpaid or unentered scheduled expense for the HOA dues and the indicator 1216 is included in that listing. Any existing paid scheduled expense may be selected (e.g., tap or swipe) to edit that listing. The edit expenses screen 1202 is opened when the user selects an existing paid scheduled expense in the listing of scheduled expenses 1210.

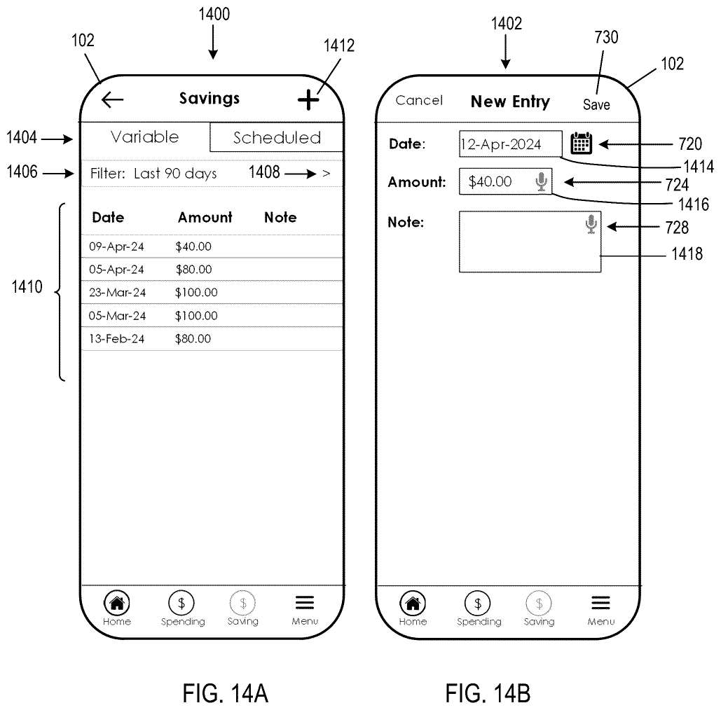

FIG. 14A illustrates an example savings screen 1400 for variable savings displaying on the user device 102 according to an embodiment of the disclosure. FIG. 14B illustrates an example new savings entry screen 1402 for a variable saving displaying on the user device 102 according to an embodiment of the disclosure. The user may select which of the variable savings screen or the scheduled savings screen to display using the selectable controls 1404. In FIG. 14A, the savings screen for variable savings is shown.

A filter section 1406 can include one or more filters that are used to filter the variable savings to be displayed in the savings screen 1400. For example, in FIG. 14A, the filter is a time period (e.g., ninety days). Additional or different filters may be used and/or the user can customize the filters in other embodiments. For example, the user can select the control element 1408 to apply an additional or a different filter or filters. Additionally or alternatively, in some embodiments the filter(s) that are displayed in the filter section 1406 may initially be set to default filter(s) and default setting(s) that the user can modify via the control element 1408.

The savings screen 1400 includes a listing of variable savings section 1410, where the variable savings that correspond to the selected filter(s) 1406 are presented. In the illustrated embodiment, the listing of variable expenses section 1410 displays a date of the variable savings, an amount of the variable savings, and a note section.

The user can select the new entry control element 1412 to open the new savings entry screen 1402 shown in FIG. 14B. In one embodiment, the new entry will be categorized as a variable savings or as a schedule savings depending on which of the variable saving screen or the schedule saving screen is displayed in the savings screen 1400 when the new entry control element 1412 is selected. A date of the savings is entered into the textbox 1414 (or using the calendar object 720). In some embodiments, the date entry defaults to the current date. The user can edit the current date if needed.

An amount of the savings is entered into the text box 1416. In some embodiments, the amount may be input via an audio input by selecting the audio input icon 724. The amount may be a positive amount or a negative amount. For example, the amount is negative when the user withdraws money from a savings account. The user may input a note in the notes text box 1418. In some embodiments, the note(s) may be input via an audio input by selecting the audio input icon 728.

Once the inputs to the new entry are completed, the user can select the “Save” command 730 to save the new entry and close the new savings entry screen 1402 and to return to the savings screen 1400. Again, visual feedback, audio feedback and/or tactile feedback may be provided in response to the selection of the “Save” command 730 in some embodiments.

FIG. 15A illustrates an example savings screen 1500 for scheduled savings displaying on the user device 102 according to an embodiment of the disclosure. FIG. 15B illustrates an example edit savings screen 1502 for a scheduled savings displaying on the user device 102 according to an embodiment of the disclosure. The user may select which of the variable savings screen or the scheduled savings screen to display using the selectable controls 1504. In FIG. 15A, the scheduled savings screen is shown.

In some embodiments, the amount of scheduled savings shown in the introductory screen 200 (FIG. 2) represents the total amount of scheduled savings for that day. When one or more scheduled savings are outstanding and have not been entered or paid, a savings indicator 1506 may be presented at the savings icon 124. In the illustrated embodiment, the savings indicator 1506 is implemented as a number (e.g., “1”) that indicates the number of scheduled savings (e.g., one) that have not been paid or entered. The user can select the savings icon 124 to open the savings screen 1500. In one embodiment, the total number of scheduled savings that have not been entered or paid may appear on the software application icon or logo that is used to launch the software application. In another embodiment, a total number of scheduled expenses and scheduled savings that have not been entered or paid can appear on the software application icon or logo that is used to launch the software application.

A filter section 1508 can include one or more filters that are used to filter the scheduled savings to be displayed in the savings screen 1500. For example, in FIG. 15A, the filter is a time period (e.g., ninety days). Additional or different filters may be used and/or the user can customize the filters in other embodiments. For example, the user can select the control element 1510 to apply an additional or a different filter or filters. Additionally or alternatively, in some embodiments the filter(s) that are displayed in the filter section 1508 may initially be set to default filter(s) and default setting(s) that the user can modify via the control element 1510.

The savings screen 1500 includes a listing of scheduled savings section 1512, where the scheduled savings that correspond to the selected filter(s) 1508 are presented. In the illustrated embodiment, the listing of scheduled savings section 1512 displays a date of the scheduled savings, an amount of the scheduled savings, and a note section. In some embodiments, the scheduled savings in the listing of scheduled savings section 1512 are presented in descending date order and the expected unpaid or non-entered scheduled savings are at the top of the list. The indicator 1212 can be displayed next to the scheduled screen label 1514 when one or more scheduled savings have not been entered or paid. Additionally or alternatively, an indicator 1216 may be presented in a listing when the scheduled savings has not been entered or paid. In the illustrated embodiment, one scheduled savings has not been paid or entered and the indictor 1216 appears in the listing for that scheduled savings. Other embodiments can present the scheduled savings in the listing in a different order. For example, the scheduled savings may be presented in ascending date order or by descending or ascending amounts paid.

The user may select (e.g., tap or swipe) a particular scheduled savings listing in the listing of scheduled savings section 1512 to open the savings edit screen 1502 shown in FIG. 15B. The savings edit screen 1502 presents the expected date 1516 for payment of the scheduled savings, the expected amount to be paid 1518 for the scheduled savings, and a notes entry 1520 (when there is a note entry). When an unpaid or unentered scheduled savings is paid or entered, the user can enter the actual amount paid in the text box 1522 (or use the audio input icon 724) and enter the date in the text box 1524 (or use the calendar object 720). Once the edits are completed, the user can select the “Save” command 730 to save the edits and close the savings edit screen 1502 and to return to the savings screen 1500. Again, visual feedback, audio feedback and/or tactile feedback may be provided in response to the selection of the “Save” command 730 in some embodiments.

As discussed previously, one or more graphs may be displayed in a section of a screen. For example, graphs have been presented in the screens shown in FIGS. 1-6B, 9B, and 11, although graphs may be presented in all of the screens disclosed herein. In some embodiments, the user can interact with the graphs. For example, the user can select a point on a plot or an area around a plot or plots in a graph to view details of the budget, the actual spending, the budget surplus, the budget deficit and/or other features of a graph. Additionally or alternatively, a user can zoom in or out of a graph, rotate a graph, pan a graph, and/or perform other actions on a graph.

FIG. 16 illustrates a first example of a burndown graph 1600 according to an embodiment of the disclosure. The x-axis represents time and the y-axis represents dollars. In the illustrated embodiment, the x-axis represents a year (e.g., the year 2015). The burndown graph 1600 includes a first plot 1602 that represents a budget and a second plot 1604 that represents actual spending. The differences between the first plot 1602 and the second plot 1604 over time indicate budget surpluses or budget deficits. As shown in FIG. 16, at the end of the year (e.g., Dec. 31, 2015) there is a budget deficit of $4,427.31.

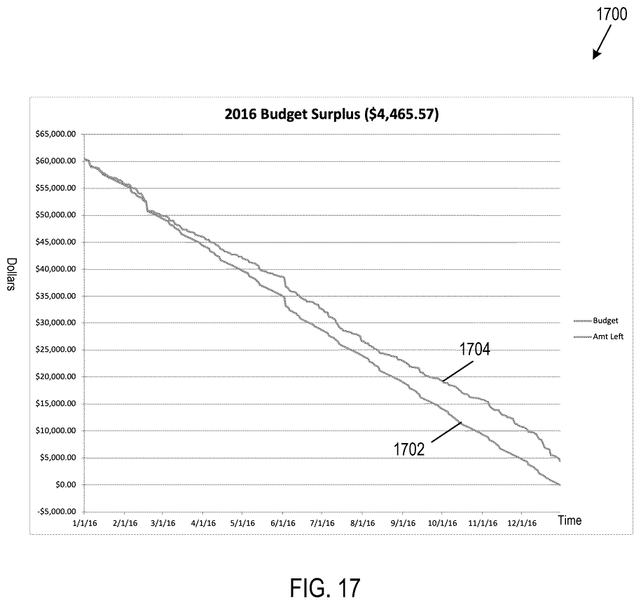

FIG. 17 illustrates a second example of a burndown graph 1700 according to an embodiment of the disclosure. The x-axis represents time and the y-axis represents dollars. In the illustrated embodiment, the x-axis represents a year (e.g., the year 2016). The burndown graph 1700 includes a first plot 1702 that represents a budget and a second plot 1704 that represents actual spending. The differences between the first plot 1702 and the second plot 1704 over time indicate budget surpluses or budget deficits. As shown in FIG. 17, at the end of the year (e.g., Dec. 31, 2016) there is a budget surplus of $4,465.57.

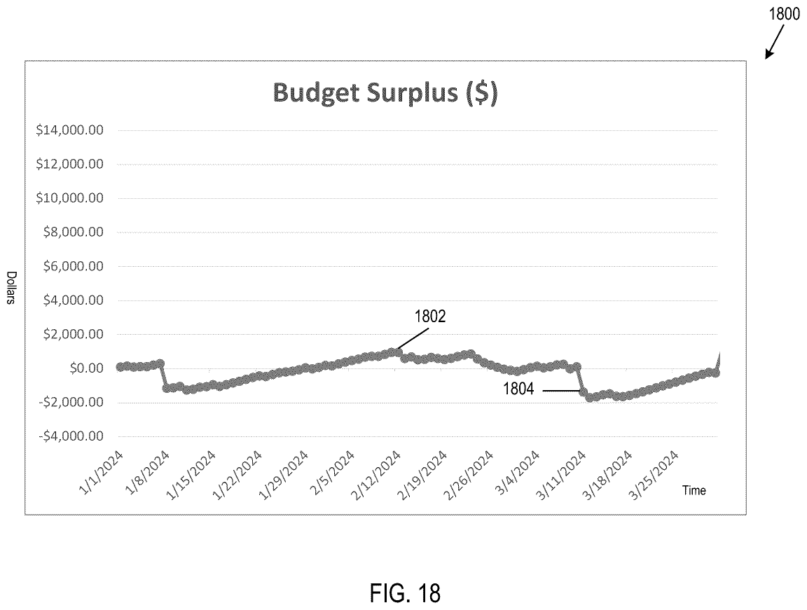

FIG. 18 illustrates a first example of a budget surplus graph 1800 according to an embodiment of the disclosure. The x-axis represents time and the y-axis represents dollars. In the illustrated embodiment, the x-axis represents a quarter of a year (e.g., January to March of 2024). The budget surplus graph 1800 includes a plot 1802 that represents a budget surplus over the time period represented on the x-axis. In the example embodiment, a series of data points 1804 form the plot 1802. The user may select a data point or a group of data points to view details of the budget surplus at that point or period in time. Additionally or alternatively, a user can zoom in or out of the budget surplus graph 1800, rotate the budget surplus graph 1800, pan the budget surplus graph 1800, and/or perform other actions on the budget surplus graph 1800.

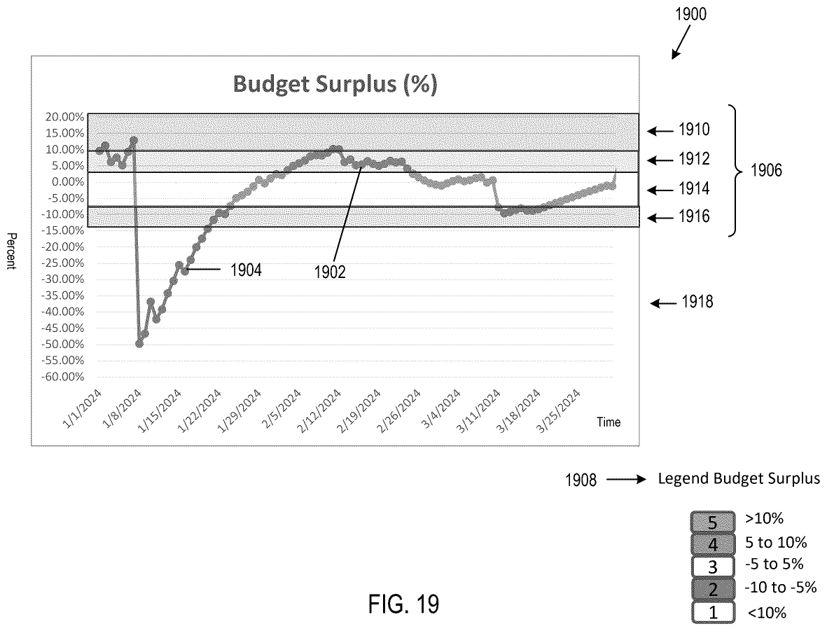

FIG. 19 illustrates a second example of a budget surplus graph 1900 according to an embodiment of the disclosure. The x-axis represents time and the y-axis represents percentages. In the illustrated embodiment, the x-axis represents a quarter of a year (e.g., January to March of 2024). The budget surplus graph 1900 includes a plot 1902 that represents a budget surplus over the time period represented on the x-axis. In the example embodiment, a series of data points 1904 form the plot 1902. The user may select a data point or a group of data points to view details of the budget surplus at that point or period in time. Additionally or alternatively, a user can zoom in or out of the budget surplus graph 1900, rotate the budget surplus graph 1900, pan the budget surplus graph 1900, and/or perform other actions on budget surplus graph 1900.

In some embodiments, some or all of the area around the plot 1902 may include color coded sections 1906 to indicate one or more spending states (e.g., budget surplus states) over the period of time. The one or more color coded sections 1906 can represent different levels of budget surplus states. For example, in the illustrated embodiment, a legend 1908 for the budget surplus graph 1900 shows five budget surplus states. A first budget surplus state 1910 represents a budget surplus of greater than a positive ten percent (e.g., spending is below the budget by more than ten percent). A second budget surplus state 1912 represents a budget surplus between a positive five percent and a positive ten percent (e.g., spending is below the budget between five and ten percent). A third budget surplus state 1914 represents a budget surplus between a negative five percent and a positive five percent (e.g., spending is below or above the budget between minus five and five percent). A fourth budget surplus state 1916 represents a budget surplus between a negative ten percent and a negative five percent (e.g., spending is above the budget between five and ten percent). A fifth budget surplus state 1918 represents a budget surplus less than negative ten percent (e.g., spending is above the budget by more than ten percent). Other embodiments can use a fewer or a greater number of budget spending states, different color coding, and/or the budget spending states may represent different levels of surpluses or deficits.

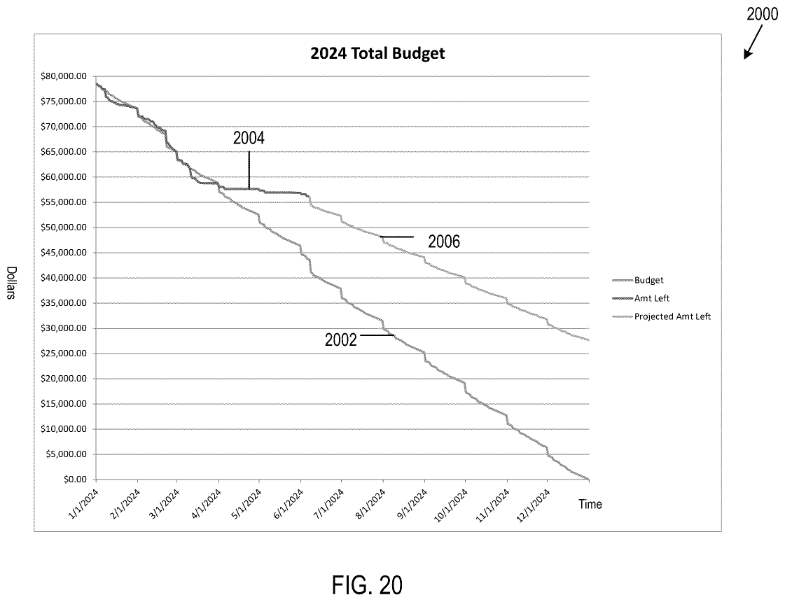

FIG. 20 illustrates an example of a total budget graph 2000 according to an embodiment of the disclosure. The x-axis represents time and the y-axis represents dollars. In the illustrated embodiment, the x-axis represents a year (e.g., 2024). The total budget graph 2000 includes a first plot 2002 that represents a budget and a second plot 2004 that represents actual spending. The differences between the first plot 2002 and the second plot 2004 over time indicate budget surpluses or budget deficits.

In the illustrated embodiment, the total budget graph 2000 is created in mid-June, so the second plot 2004 ends at that date. The total budget graph 2000 can stop there and only display the first plot 2002 and the second plot 2004. In another embodiment, a third plot 2006 may begin at the end of the second plot 2004 and represents a projection of spending to the end of the year. In one embodiment, the projection of the spending is based on an assumption that the user's current level of spending continues to the end of the time period represented on the x-axis (e.g., end of the year). In another embodiment, the user can modify the assumption for the computation of the projection. In this manner, the user can view how different spending levels for the rest of the time period (e.g., the year) may impact the amount of the projected budget surplus or deficit. In yet another embodiment, the system can recommend one or more spending levels to reach a particular budget surplus or deficit goal of the user. The one or more recommendations may be a single spending level for the rest of the time period (e.g., year) or spending levels that change over the time period (e.g., a different spending level for each month).

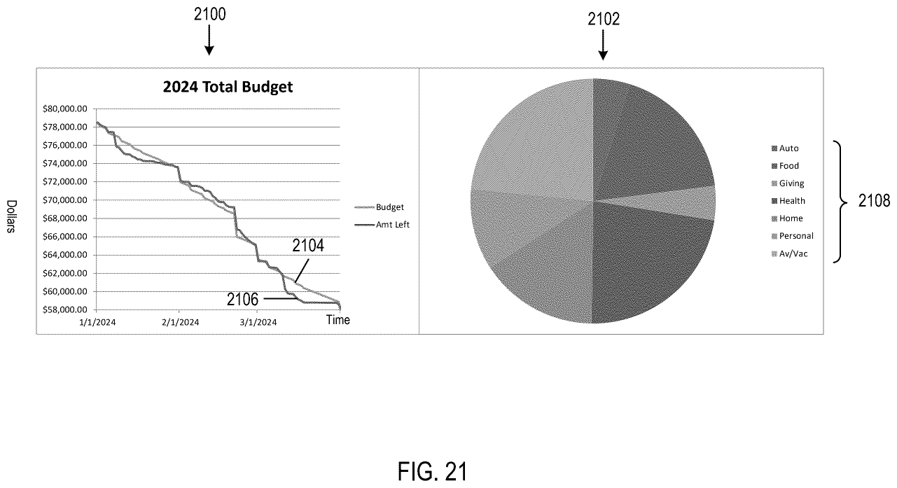

FIG. 21 illustrates an example of a total budget graph 2100 and an associated pie chart 2102 representing a distribution of the spending according to an embodiment of the disclosure. With respect to the total budget graph 2100, the x-axis represents time and the y-axis represents dollars. In the illustrated embodiment, the x-axis represents a quarter of a year (e.g., January to March of 2024). The total budget graph 2100 includes a first plot 2104 that represents a budget and a second plot 2106 that represents actual spending. The differences between the first plot 2104 and the second plot 2106 over time indicate budget surpluses or budget deficits.

The pie chart 2102 shows a distribution of the spending in the categories 2108 of the budget for the time period covered in the total budget graph 2100. In the illustrated embodiment, the categories are auto, food, giving, health, home, personal, and vacation. Although not shown in FIG. 21, the pie chart can include the percentage of the spending for each category, or another label for each category. For example, the pie chart 2102 may include indicators representing whether the category is under or over the budget for the category (e.g., a “+” for over budget or “−” for under budget). Alternatively, the indicators can be associated with a percentage range, such as the percentage ranges shown in the legend 1908 shown in FIG. 19. In some embodiments, the pie chart 2102 can include textual descriptors of the spending state of the categories (e.g., great, good, bad, worse), the individual adaptable icons 404 shown in FIG. 4B, or the total spending amounts (e.g., in dollars) for the categories. In some embodiments, the user can interact with the pie chart 2102. For example, the user can select “slice” of the pie chart to view details of the spending for that category. Additionally or alternatively, a user can zoom in or out, rotate, pan, and/or perform other actions on the pie chart 2102.

FIG. 22 illustrates a best time to surplus graph 2200 according to an embodiment of the disclosure. The x-axis represents time and the y-axis represents dollars. In the example embodiment, the x-axis represents a year (e.g., 2024). The best time to surplus graph 2200 includes a plot 2202 that represents the budget over the time period and the plot 2204 represents the actual spending at the time the best time to surplus graph 2200 is created or viewed. The differences between the first plot 2202 and the second plot 2204 over time indicate budget surpluses or budget deficits.

In the illustrated embodiment, the best time to surplus graph 2200 is created in mid-June, so the second plot 2204 ends at that date. A third plot 2206 begins at the end of the second plot 2204 and represents a projection as to when the budget deficit will intersect the first plot 2202 at the current level of spending (a crossover point). The crossover point in FIG. 22 is the point 2208. A notification 2210 can provide a date (and in some instances, a time) as when the budget deficit will reach the crossover point. Additionally or alternatively, a countdown 2212 may be presented.

In some embodiments, the user can modify the spending (e.g., the monthly spending) for the computation of the third plot 2206 to a crossover point. In this manner, the user can view how different spending levels may impact the best time to reach a budget surplus. In another embodiment, the system can recommend one or more spending levels to reach the best time to a budget surplus. The one or more recommendations may be a single spending level until the third plot 2206 reaches a crossover point, or spending levels that change until the third plot 2206 reaches a crossover point (e.g., a different spending level for each month).

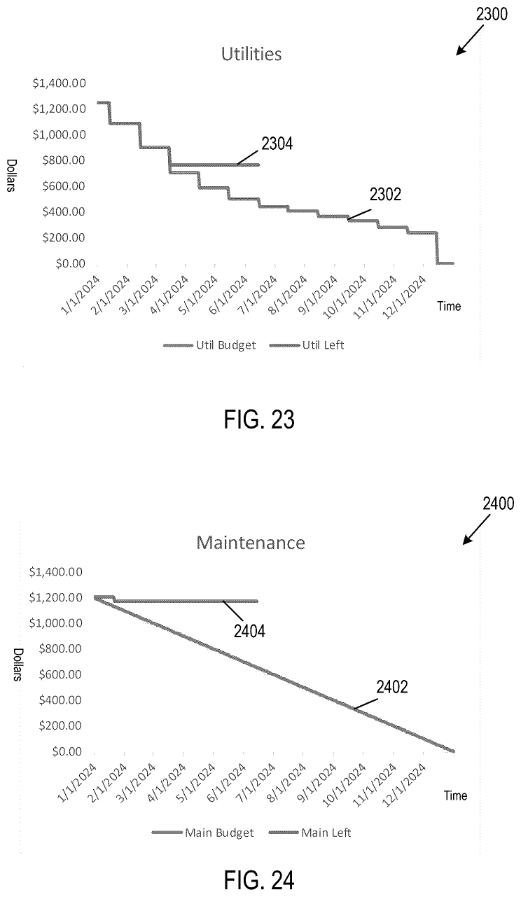

Graphs may be generated for categories and/or sub-categories in some embodiments. For example, the user may request a graph be created for a particular category or sub-category. The categories or sub-categories may be variable expenses or scheduled expenses. FIGS. 23-26 illustrate budget surplus graphs for the sub-categories of utilities, maintenance, water/sewer, and homeowner association (HOA) expenses. The category associated with the utilities sub-category may be a home category. The home category may include additional or different sub-categories, such as internet, security, property tax, and/or insurance.

FIG. 23 illustrates a budget surplus graph 2300 for a utilities sub-category according to an embodiment of the disclosure. The x-axis represents time and the y-axis represents dollars. In the illustrated embodiment, the x-axis represents a year (e.g., the year 2024). The budget surplus graph 2300 includes a first plot 2302 that represents a budget for the utilities and a second plot 2304 that represents the actual spending on the utilities. The illustrated budget surplus graph 2300 is created in mid-June, so the second plot 2304 ends at that date. The differences between the first plot 2302 and the second plot 2304 over time indicate a budget surplus or a budget deficit. As shown in FIG. 23, the budget surplus graph 2300 shows a budget surplus when the budget surplus graph 2300 is opened and while the budget surplus graph 2300 is viewed.

FIG. 24 illustrates a budget surplus graph 2400 for a maintenance sub-category according to an embodiment of the disclosure. The x-axis represents time and the y-axis represents dollars. In the illustrated embodiment, the x-axis represents a year (e.g., the year 2024). The budget surplus graph 2400 includes a first plot 2402 that represents a budget for the maintenance and a second plot 2404 that represents the actual spending on maintenance. The illustrated budget surplus graph 2400 is created in mid-June, so the second plot 2404 ends at that date. The differences between the first plot 2402 and the second plot 2404 over time indicate a budget surplus or a budget deficit. As shown in FIG. 24, the budget surplus graph 2400 shows a budget surplus at the point in time when the budget deficit graph 2400 is opened and while the budget surplus graph 2400 is viewed.

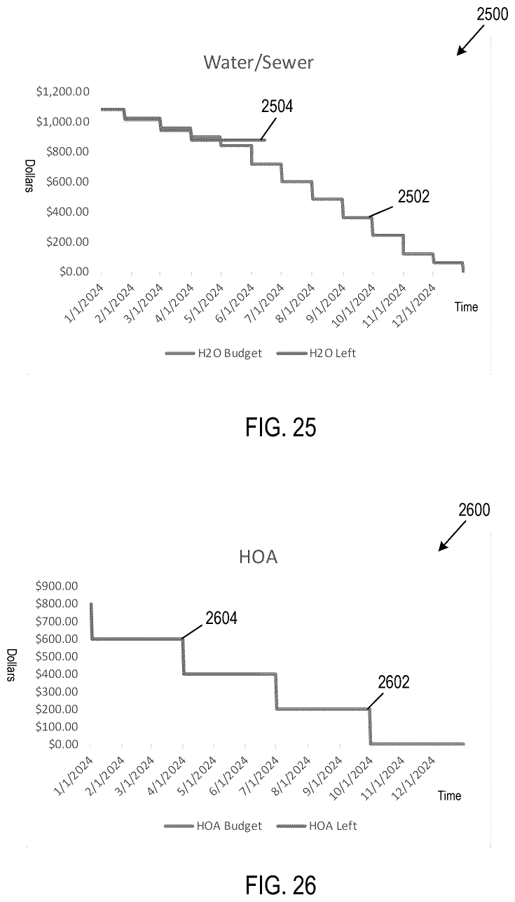

FIG. 25 illustrates a budget surplus graph 2500 for a water/sewer sub-category according to an embodiment of the disclosure. The x-axis represents time and the y-axis represents dollars. In the illustrated embodiment, the x-axis represents a year (e.g., the year 2024). The budget surplus graph 2500 includes a first plot 2502 that represents a budget for the water/sewer and a second plot 2504 that represents the actual spending on water/sewer. The illustrated budget surplus graph 2500 is created in mid-June, so the second plot 2504 ends at that date. The differences between the first plot 2502 and the second plot 2504 over time indicate a budget surplus or a budget deficit. As shown in FIG. 25, the budget surplus graph 2500 shows a budget surplus at the point in time the budget deficit graph 2500 is opened and while the budget surplus graph 2500 is viewed.

FIG. 26 illustrates a budget surplus graph 2600 for a homeowner association (HOA) sub-category according to an embodiment of the disclosure. The x-axis represents time and the y-axis represents dollars. In the illustrated embodiment, the x-axis represents a year (e.g., the year 2024). The budget surplus graph 2600 includes a first plot 2602 that represents a budget for the HOA expense and a second plot 2604 that represents the actual spending on HOA expense. The illustrated budget surplus graph 2600 is created in mid-June, so the second plot 2604 ends at that date. The differences between the first plot 2602 and the second plot 2604 over time indicate a budget surplus or a budget deficit. As shown in FIG. 26, the budget surplus graph 2600 shows the actual spending on the HOA expense correspond to or matches the budget for the HOA expenses (e.g., no budget deficit or budget surplus).

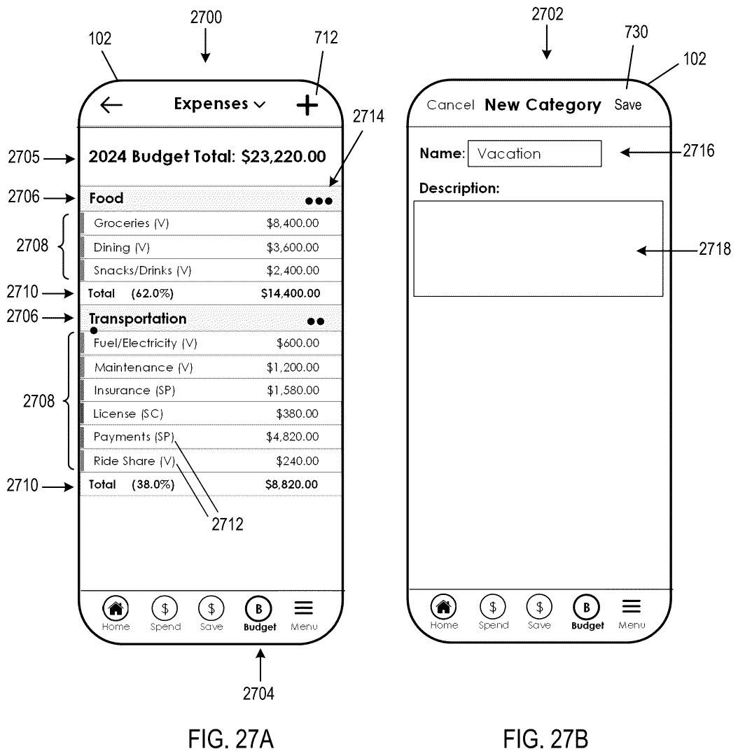

A budget may be entered into the finance management application in several ways. For example, the budget can be created in another application and the budget details imported from the other application to the finance management application. Additionally or alternatively, budget details may be entered using the example screens shown and described in conjunction with FIGS. 27A-32B.

FIG. 27A illustrates an example budget screen 2700 for expenses displayed on the user device 102 according to an embodiment of the disclosure. FIG. 27B illustrates an example of a new category screen 2702 displayed on the user device 102 according to an embodiment of the disclosure. A user can select (e.g., tap) the budget icon 2704 to open the example budget screen 2700. The example budget screen 2700 includes a budget total 2705, a category 2706, and sub-categories 2708 for each category 2706. In the illustrated embodiment, one category 2706 is food, and the sub-categories 2708 for food include groceries, dining, and snacks/drinks (along with total amounts for each sub-category). Another category 2706 is transportation, and the sub-categories 2708 for transportation include fuel/electricity, maintenance, insurance, license, payments, and ride share (along with total amounts for each sub-category).

Each category 2706 includes a total 2710 that can present the total amount for the category 2706 and a percentage of the budget total 2705 (e.g., 62% for food and 38% for transportation). Each sub-category 2708 may include an indicator 2712 that indicates whether the sub-category 2708 is a variable expense (V) or a scheduled expense (SP). In some embodiments, a selectable object 2714 (e.g., the ellipses) can be used to indicate to the user the option to edit the category, and/or to present (when selected) a menu of additional functions. For example, one additional function may be a move-up function that enables the user to control the order of the categories 2706 and/or the sub-categories 2708 in the example budget screen 2700.

The user can select (e.g., tap) the control element 712 to open the new category screen 2702 shown in FIG. 27B. The user can enter a name for the new category in the text box 2716 and a description in the text box 2718. In FIG. 27B, a category named “vacation” is added. In some embodiments, the name and/or the description may be input via an audio input by selecting an audio input icon (e.g., the audio input icon 728 of FIG. 7B). The user can select the “Save” command 730 when the entries to the new category screen 2702 are completed. In one embodiment, the finance management application returns to the example budget screen 2700 in response to the selection of the “Save” command 730, enabling the user to add another category or to edit a previously entered category.

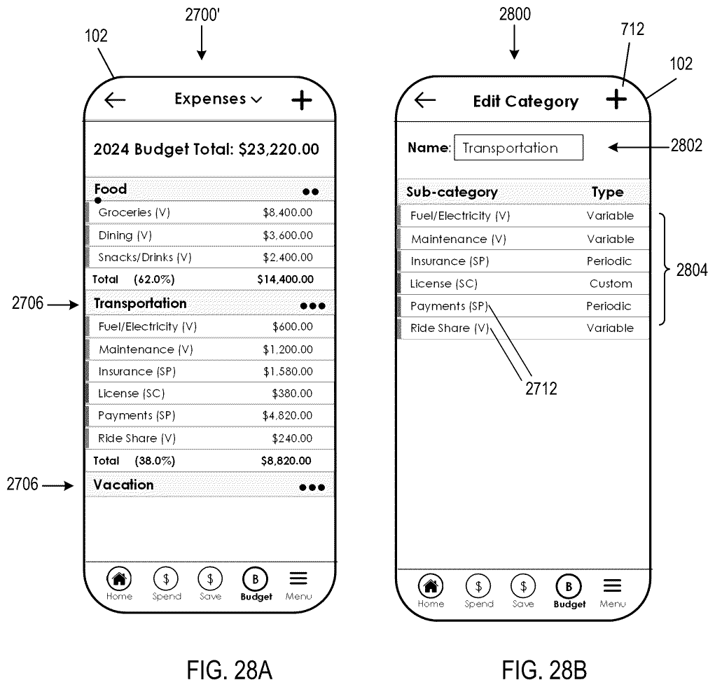

FIG. 28A illustrates an example of an updated example budget screen 2700′ displaying on the user device 102 according to an embodiment of the disclosure. FIG. 28B illustrates an example of an edit category screen displayed on the user device 102 according to an embodiment of the disclosure. The updated budget screen 2700′ includes the new category 2706 “vacation” that was added to the example budget screen (see FIG. 27B). In some embodiments, a swipe (e.g., a left swipe) may be used to delete a category. The category may be deleted immediately if there are no sub-categories for the to—be deleted category, or if the category to be deleted includes sub-categories, the user may be presented with a notification that enables the user to cancel the deletion, to add one or more sub-categories as a category, or to delete the sub-categories with the category.

The user can select (e.g., tap or swipe) a category 2706 to open the edit category screen 2800 shown in FIG. 28B. In the illustrated embodiment, the transportation category is presented in the edit category screen 2800. The edit category screen 2800 includes the name of the category in an input element (e.g., a text box) 2802 and a sub-category section 2804 that includes a list of the sub-categories for the named category. The list of sub-categories can include the name of each sub-category and the indicator 2712 in one column and the type of sub-category in another column (e.g., variable, periodic (i.e., scheduled), and custom). The user can edit the name of the category via the text box, edit the sub-category details by selecting (e.g., tapping or swiping) the sub-category, and/or adding a sub-category by selecting the control element 712. Additional and/or different information can be presented in an edit category screen in other embodiments.

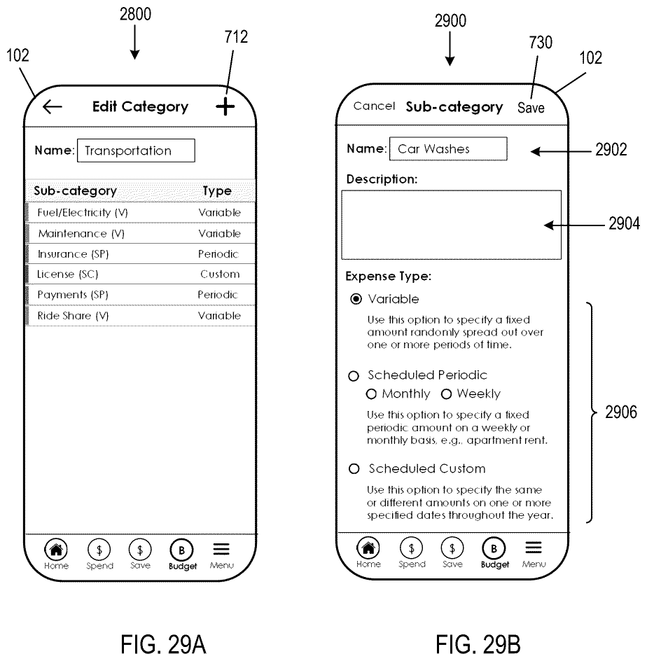

FIG. 29A illustrates the example edit category screen 2800 shown in FIG. 28B. For brevity, the example edit category screen 2800 is not described in detail again. FIG. 29B illustrates an example of a new sub-category screen 2900 displayed on the user device 102 according to an embodiment of the disclosure. The user can select the control element 712 to open the new sub-category screen 2900 shown in FIG. 29B. The user can enter a name for the new sub-category in the text box 2902 and a description in the text box 2904. In FIG. 29B, a sub-category named “car washes” is added. The user can also choose an expense type in the expense type section 2906. In the illustrated embodiment, the expense type section 2906 includes three expense types; variable, scheduled periodic (also referred to herein as a scheduled expense), and custom. In one embodiment, the custom expense type is a scheduled expense in which the expected expense amount is not recurring on a periodic basis but is entered along with respective scheduled dates. For example, one custom expense type that may be a scheduled expense property taxes that are paid in two payments, and/or an annual subscription. The expense type may be selected using a radio button or another type of graphical control element (e.g., a drop-down menu or a checkbox).

In some embodiments, the name and/or the description may be input via an audio input by selecting an audio input icon (e.g., the audio input icon 728 of FIG. 7B). The user can select the “Save” command 730 when the entries to the new sub-category screen 2900 are completed. In one embodiment, the finance management application returns to the example edit category screen 2800 in response to the selection of the “Save” command 730, enabling the user to add or edit another sub-category. In other embodiments, the finance management application may return to a different screen in response to the selection of the “Save” command 730 (e.g., the example budget screen 2700 of FIG. 27).

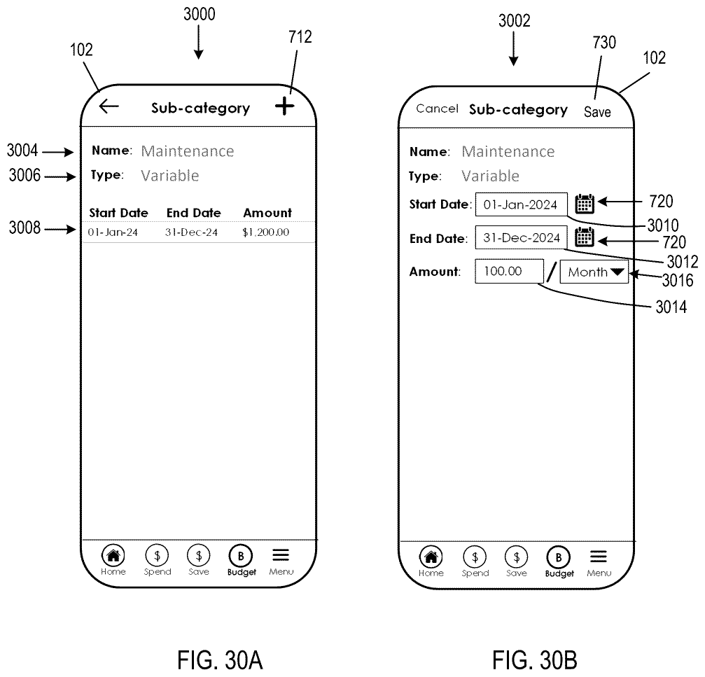

FIG. 30A illustrates an example of a sub-category screen 3000 displayed on the user device 102 according to an embodiment of the disclosure. FIG. 30B illustrates an example of a first edit sub-category screen 3002 displayed on the user device 102 according to an embodiment of the disclosure. A user can select (e.g., tap or swipe) on a sub-category in the example edit category screen 2800 shown in FIG. 29A to open the sub-category screen 3000. The sub-category screen 3000 presents information on the sub-category, such as the name 3004, the type 3006, and information 3008 regarding payments for the sub-category. In the illustrated embodiment, the information 3008 includes a start date, an end date, and an amount.

The user may select (e.g., tap or swipe) the information 3008 to open the edit sub-category screen 3002. As shown in FIG. 30B, the user can edit the start date via the text box 3010, the end date via the text box 3012, the amount via the text box 3014, and the period in which the amount is paid using the drop-down menu 3016 (e.g., monthly). The start date and/or the end date may default to the start date and the end date of the budget based on when the budget year was created. For example, the start date may default to January 1^{st} when the budget start date is January 1^{st}. Other dates may be used if the user starts the budget year during the year. The user can edit the default dates using the edit sub-category screen 3002.

In some embodiments, the start date and the end date may be entered using the calendar object 720 or an audio input icon (e.g., the audio input icon 728). Additionally or alternatively, the amount may be entered using an audio input icon. Input elements other than drop-down menus may be used in other embodiments. For example, links or text boxes can be used to input the period in which the amount is paid.

The user can select the “Save” command 730 when the entries to the edit sub-category screen 3002 are completed. In one embodiment, the finance management application returns to the example sub-category screen 3000 in response to the selection of the “Save” command 730. In other embodiments, the finance management application may return to a different screen in response to the selection of the “Save” command 730 (e.g., the example budget screen 2700 of FIG. 27).

In some embodiments, other aspects of a sub-category can be edited. For example, a note may be edited when the sub-category screen 3000 includes a note section. A payment date can be edited when the sub-category screen 3000 includes a payment date in the information 3008. Additionally or alternatively, non-overlapping start and stop intervals for the sub-category may be added using the control element 712 (FIG. 30A) for each start and stop interval.

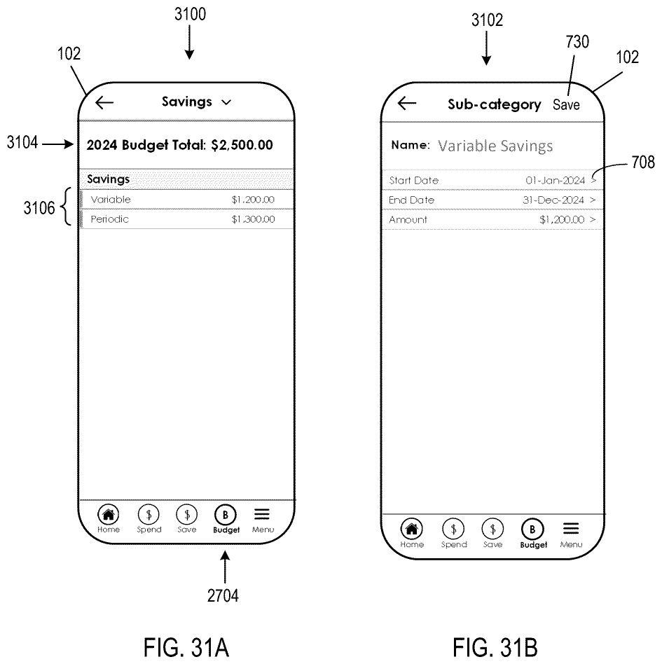

FIG. 31A illustrates an example budget screen 3100 for savings displayed on the user device 102 according to an embodiment of the disclosure. FIG. 31B illustrates an example of a second edit sub-category screen 3102 displayed on the user device 102 according to an embodiment of the disclosure. A user can select (e.g., tap) the budget icon 2704 to open the example budget screen 3100. The example budget screen 3100 includes a budget total 3104 and sub-categories 3106. In the illustrated embodiment, the sub-categories include variable savings and periodic savings (also referred to as scheduled savings).

The user can select (e.g., tap or swipe) a sub-category to open the edit sub-category screen 3102 shown in FIG. 31B. In the illustrated embodiment, the variable savings category has been selected, and the user may select (e.g., tap) the control element 708 (or swipe on the aspect to be edited) to edit the start date, the end date, and/or the amount. The user can select the “Save” command 730 when the entries to the edit sub-category screen 3102 are completed. In one embodiment, the finance management application returns to the example sub-category screen 3100 in response to the selection of the “Save” command 730. In other embodiments, the finance management application may return to a different screen in response to the selection of the “Save” command 730 (e.g., the example budget screen 2700 of FIG. 27).

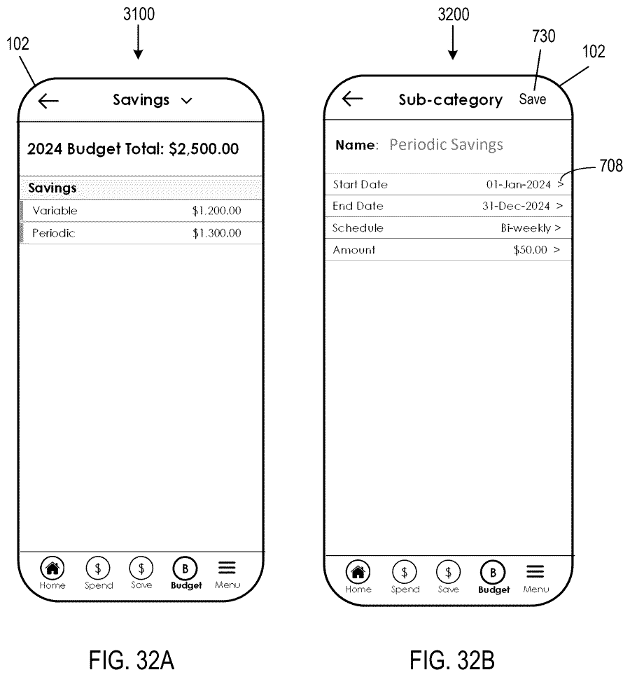

FIG. 32A illustrates the example budget screen 3100 shown in FIG. 31A. For brevity, the example budget screen 3100 is not described in detail again. FIG. 32B illustrates an example of a third edit sub-category screen 3200 displayed on the user device 102 according to an embodiment of the disclosure. The user selected (e.g., tap or swipe) the periodic savings category, and the user may select (e.g., tap) the control element 708 (or swipe on the aspect to be edited) to edit the start date, the end date, the schedule, and/or the amount. The user can select the “Save” command 730 when the entries to the edit sub-category screen 3200 are completed. In one embodiment, the finance management application returns to the example sub-category screen 3100 in response to the selection of the “Save” command 730. In other embodiments, the finance management application may return to a different screen in response to the selection of the “Save” command 730 (e.g., the example budget screen 2700 of FIG. 27).

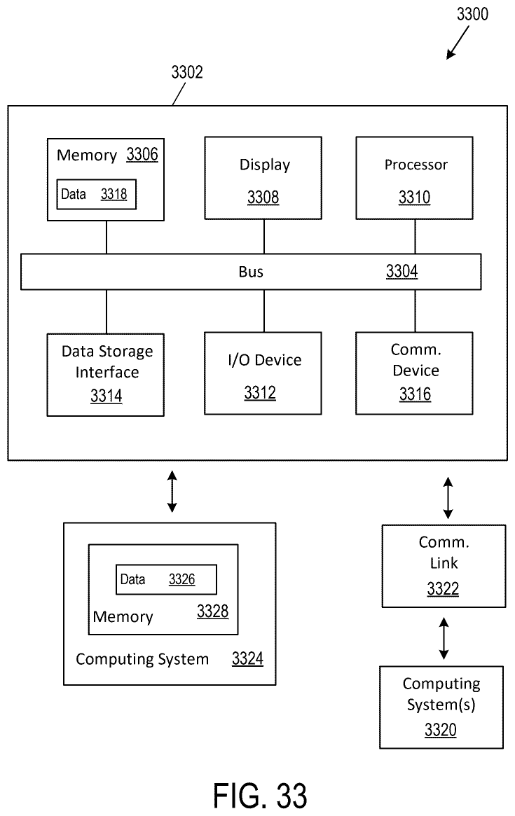

The systems, methods, and screens (e.g., user interfaces) disclosed herein may be implemented using various computing systems. FIG. 33 illustrates a block diagram of an example computing system 3300 for implementing various embodiments in the examples described herein. This disclosure contemplates any suitable number of computing systems may be used. For example, the computing system may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 3300 may include one or more computing systems; be unitary or distributed; span multiple locations; span multiple locations; span multiple machines; span multiple data centers; or reside in a cloud, which may include one or more cloud components in one or more networks.

The computing system 3300 includes a first computing device 3302 that includes one or more communication structures, such as a bus 3304 (e.g., an address bus and a data bus) or other communication mechanism for communicating information, which interconnects subsystems and devices, such as memory 3306, a display 3308, a processor 3310, an input/output (I/O) device 3312, a data storage interface 3314, and a communications device 3316. Although only one of each component is shown in FIG. 33, other embodiments can include one or more of the bus 3304, the memory 3306, the display 3308, the processor 3310, the I/O device 3312, the data storage interface 3314, and/or the communications device 3316.

The memory 3306 is configured to store information, such as data and software applications (collectively data 3318). In one embodiment, the data 3318 can include one or more user profiles and processor-executable instructions for one or more software applications, and information associated with one or more budgets and financial transactions for one or more users. The data 3318 can include different or additional data in other embodiments. The memory 3306 may be implemented as one or more types of volatile and non-volatile memory. For example, the memory 3306 can be a read only memory (ROM), dynamic and/or static random-access memory (RAM), flash memory, cache memory, erasable programmable ROM (EPROM), electrically erasable programmable ROM (EEPROM), virtual memory, optical memory, magnetic memory, and combinations thereof.

In one embodiment, the processor 3310 includes hardware for executing processor-executable instructions, such as the instructions in a software application. The processor 3310 includes circuitry for performing various processing functions, such as executing specific software for perform specific calculations or tasks. For example, the processor 3310 may be implemented as a microprocessor, a central processing unit, a graphics processing unit, a neural processing unit, a digital signal processor, or combinations thereof.

The bus 3304 can include one or more memory buses (which may each include an address bus and a data bus) that couple the processor 3310 to the memory 3306. In particular embodiments, one or more memory management units (MMUs) reside between the processor 3310 and the memory 3306 and facilitate accesses to the memory 3306 as requested by the processor 3310. In particular embodiments, the bus 3304 includes hardware, software, or both coupling components of the computing device 3302 to each other.

The display 3308 includes circuitry and a display screen and is configured to present information on the display screen. The display 3308 can be used to display the screens (e.g., the graphical user interfaces) described herein.

In one embodiment, the I/O device 3312 includes hardware, software, or both, providing one or more interfaces for communication between the I/O device 3312 and other components within the computing device 3302 and/or external to the computing device 3302. One or more of the I/O devices 3312 may enable communication between a user and the computing device 3302. The I/O device 3312 can include, but is not limited to, a keyboard, a keypad, a mouse, a microphone, speakers, input buttons, and combinations thereof. In some embodiments, the display 3308 may also function as an I/O device when the display 3308 is implemented as a touchscreen display that is configured to receive touch and/or force inputs as well as display information.

In one embodiment, the communication device 3316 includes hardware, software, or both providing one or more interfaces for communication (such as, for example, packet-based communication) between the computing device 3302 and one or more other computing devices 3320. Example communications devices 3316 include, but are not limited to, a modem, an Ethernet card, a network interface controller (NIC) or network adapter for communicating with an Ethernet or other wire-based network, a wireless NIC (WNIC) or wireless adapter for communicating with a wireless network, such as a WI-FI network, and combinations thereof.

According to particular embodiments, the computing device 3302 performs specific operations by the processor 3310 executing one or more sequences of one or more processor-executable instructions stored in the memory 3306. For example, processor-executable instructions for one or more of the graphical user interfaces and/or processor-executable instructions for one or more of the methods described herein may be stored in the memory 3306 and may be executed by the processor 3310. Such processor-executable instructions may be read into the memory 3306 from another computer readable/usable medium, such as removable computer readable/usable medium (e.g., memory sticks, external hard drives). In alternative embodiments, hard-wired circuitry may be used in place of or in combination with processor-executable instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 3310 for execution. Such a medium may take many forms, including but not limited to, nonvolatile media and volatile media.

The computing device 3302 may transmit and receive messages, data, and instructions, including software applications (or processor-executable instructions) through a communications link 3322 and the communications device 3316. Received processor-executable instructions may be executed by the processor 3310 as it is received, and/or stored in the memory 3306 for later execution. In various examples, the communications link 3322 may be configured as a network to enable the computing device 3302 to communicate with other computing devices. The network can be configured as one or more systems and protocols for communications between computing devices. Example network systems include, but are not limited to, a wide area network, a local area network, an enterprise private network, the Internet, a cloud-based network, or combinations thereof.

The computing system 3300 may further include a computing system 3324 that is configured to store data 3326 in a memory 3328. The memory 3328 can be implemented as the memory 3306, and the computing device 3324 may be implemented as the computing device 3302. As such, the memory 3328 and the computing device 3324 are not described in detail.

In one embodiment, the data 3326 can include user profiles, processor-executable instructions for one or more software applications, one or more budgets and financial transaction information. The data 3326 can include different or additional data in other embodiments.

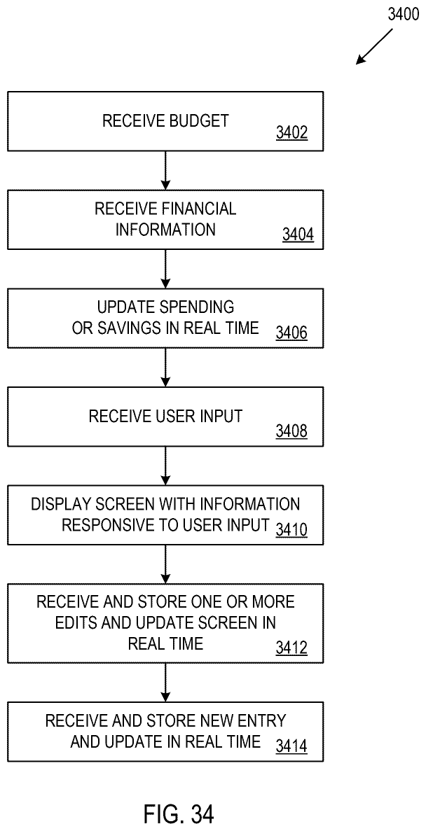

FIG. 34 illustrates a flowchart of an example method 3400 of operating a finance management application disclosed in the various embodiments described herein according to an embodiment of the disclosure. The method 3400 may be executed by the computing system 3302 shown in FIG. 33. Processor-executable instructions can be stored as data 3318 in the memory 3306 and executed by the processor 3310.

Initially, as shown in block 3402, a budget is received. The budget can cover a year or part of a year. In one embodiment, the budget may be received as a spreadsheet document, a web-based document, another type of document, and/or manual inputs.

Financial information is received at block 3404. The financial information includes, but is not limited to, expenditures and savings. The expenditures and savings may be cash, credit card, electronic fund transfers, and other transaction types. The transaction types can be received as manual inputs, as data in a document (e.g., a spreadsheet), and/or as electronic data received from banks, credit card companies, brokerage companies, and the like.

The spending state and the savings state (and associated computations, graphs, listings, etc.) are updated in real time based on the received financial information (block 3406). A user input is received at block 3408. The user input may be a selection of an icon or a logo (e.g., the adaptable icon 104 of FIG. 1 or the action plan (AP) icon 302 of FIG. 3), an object (e.g., the calendar object 720), a graph, some or all of an area in a graph, a listing (e.g., a listing in the category overview section 402 of FIG. 4), a button (e.g., the spending icon 122 of FIG. 1), and other user inputs. At block 3410, a screen (e.g., GUI) is displayed with information that is responsive to the user input. For example, an action plan screen (e.g., the action plan screen 300 of FIG. 3) may be displayed in response to receiving the selection of an adaptable icon (e.g., the adaptable icon 104 of FIG. 1). In another example, a category details screen (e.g., the category details screen 500 of FIG. 5B) can be displayed in response to receiving the selection of an individual adaptable icon (e.g., the individual adaptable icon 404 of FIG. 5B). A savings screen (e.g., the savings screen 1500 of FIG. 15A) may be displayed in response to receiving the selection of a button (e.g., the savings icon 124).

At block 3412, one or more edits to a screen may be received and stored, and the screen corresponding to the edits is updated in real time. For example, one or more edits to an expense may be received and stored (e.g., using the edit expense screen 1202 of FIG. 12B). The screen associated with the edit(s) (e.g., the expense screen 1200 of FIG. 12A) is updated in real time based on the received one or more edits.

At block 3414, a new entry can be received and stored, and the screen corresponding to the new entry is updated in real time. For example, a new entry for a scheduled savings may be received and stored (e.g., using the new entry screen 1402 of FIG. 14B). The screen associated with the new entry (e.g., the savings screen 1400 of FIG. 14A) is updated in real time based on the received new entry.

Although FIG. 34 illustrates example operations in the blocks, and depicts the blocks in a particular order, other embodiments are not limited to this implementation. Based on the embodiments disclosed herein, additional or different operations may be included in the method. In some embodiments, the order of the operations may be different. For example, some blocks can be performed in parallel and/or in a different order.

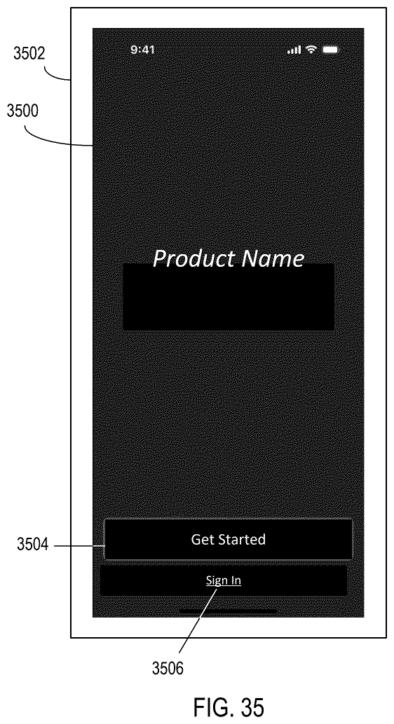

FIG. 35 illustrates an example of a splash screen 3500 displayed on a display screen 3502 according to an embodiment of the disclosure. The display screen 3502 may be a display screen on the display 3308 shown in FIG. 33. In one embodiment, the display screen 3502 may be the display screen of the user device 102. The splash screen 3500 includes two input elements 3504, 3506. A new user can select (e.g., tap) the input element 3504 to create an account. A user who has an existing account may select the input element 3506 to log into the account.

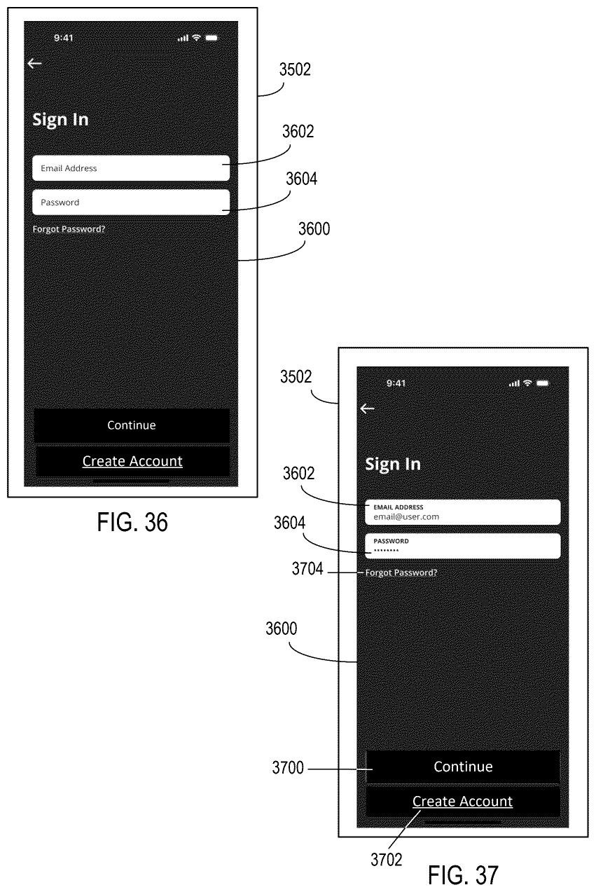

FIG. 36 illustrates an example of a sign in screen 3600 displayed on the display screen 3502 according to an embodiment of the disclosure. The sign in screen 3600 may be displayed after the user selects the input element 3506 shown in FIG. 35. The sign in screen 3600 includes two input elements 3602, 3604. The input elements 3602, 3604 are shown as text input boxes, but other embodiments are not limited to these types of input elements.

FIG. 37 illustrates the example sign in screen 3600 shown in FIG. 36 according to an embodiment of the disclosure. The sign in screen 3600 is depicted with non-limiting nonexclusive example inputs (e.g., email address and password) in the input elements 3602, 3604. A virtual keyboard may be displayed when the user selects the input elements 3602, 3604, or the user can enter the email address and the password using a physical keyboard. In some embodiments, the password is hidden as the user types the password. The input element 3700 may activate once an email address having a valid format is entered in the input element 3602 and at least one character is entered in the input element 3604. If the email address and password (the credentials) are correct and the user selects the input element 3700, an introductory or home screen may be displayed. One example of an introductory screen is shown in FIG. 1. If at least one of the credentials is not correct, an error screen is displayed on the display screen 3502. The user can select the link 3702 to create a new account. The user may select the link 3704 if the user has forgotten the password.

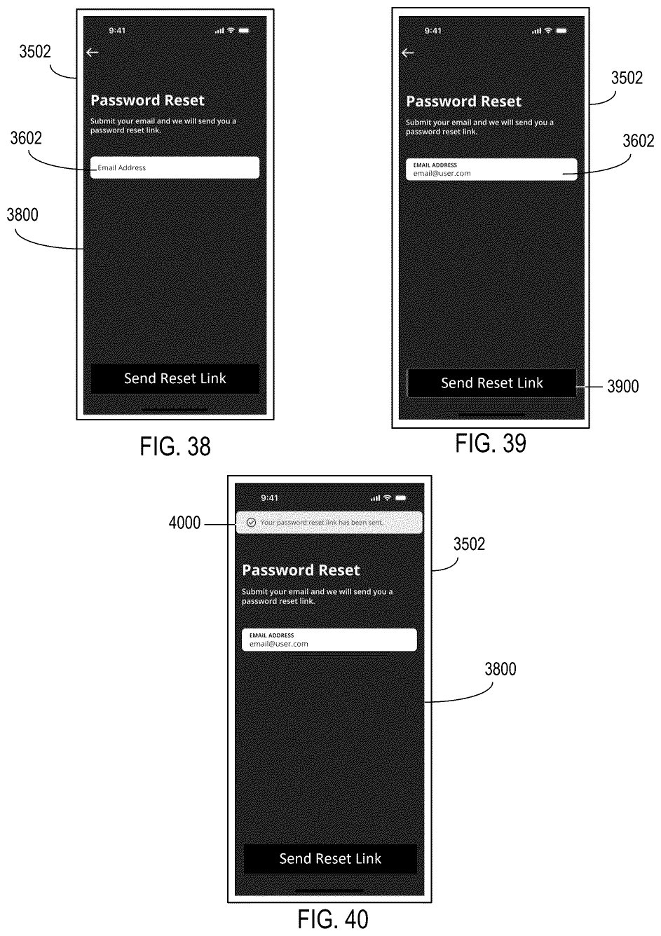

FIG. 38 illustrates an example password reset screen 3800 displayed on the display screen 3502 according to an embodiment of the disclosure. The password reset screen 3800 may be displayed after the user selects the link 3704 shown in FIG. 37. The password reset screen 3800 includes an input element 3602 (e.g., a text input box). A virtual keyboard may be displayed when the user selects the input element 3602, or the user can enter the email address into the input element 3602 using a physical keyboard.

FIG. 39 illustrates the example password reset screen 3800 shown in FIG. 38 according to an embodiment of the disclosure. An example email address is shown in the input element 3602. The user may select the input element 3900 to reset the password once the email address is input into the input element 3602. FIG. 40 illustrates the example password reset screen 3800 shown in FIG. 38 according to an embodiment of the disclosure. As shown in FIG. 40, a notification or banner 4000 is displayed after the input element 3900 is selected and a reset link is sent to the email address that is entered into the input element 3602. In some embodiments, an error message is displayed when the email address is not found.

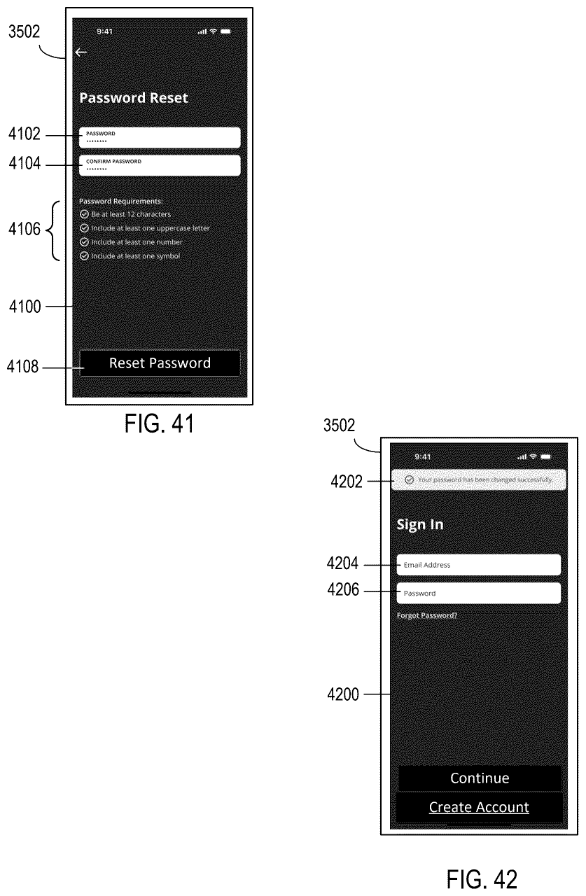

FIG. 41 illustrates an example password reset screen 4100 displayed on the display screen 3502 according to an embodiment of the disclosure. The password reset screen 4100 includes input elements 4102, 4104 and a list 4106 of requirements for a new password.

FIG. 42 illustrates an example sign in screen 4200 displayed on the display screen 3502 according to an embodiment of the disclosure. The sign in screen 4200 may be displayed after the user enters a new password in the input element 4102 and enters the new password a second time in the input element 4104 and selects the input element 4108 shown in FIG. 41. A notification or banner 4202 that indicates the reset is successful is displayed in the sign in screen 4200 along with input elements 4204, 4206. The user may enter an email address in the input element 4204 and the new password in the input element 4206 to sign into the account. The user may select the input elements 4204, 4206 to cause a virtual keyboard to be displayed, or the user can enter the email address and the password using a physical keyboard.

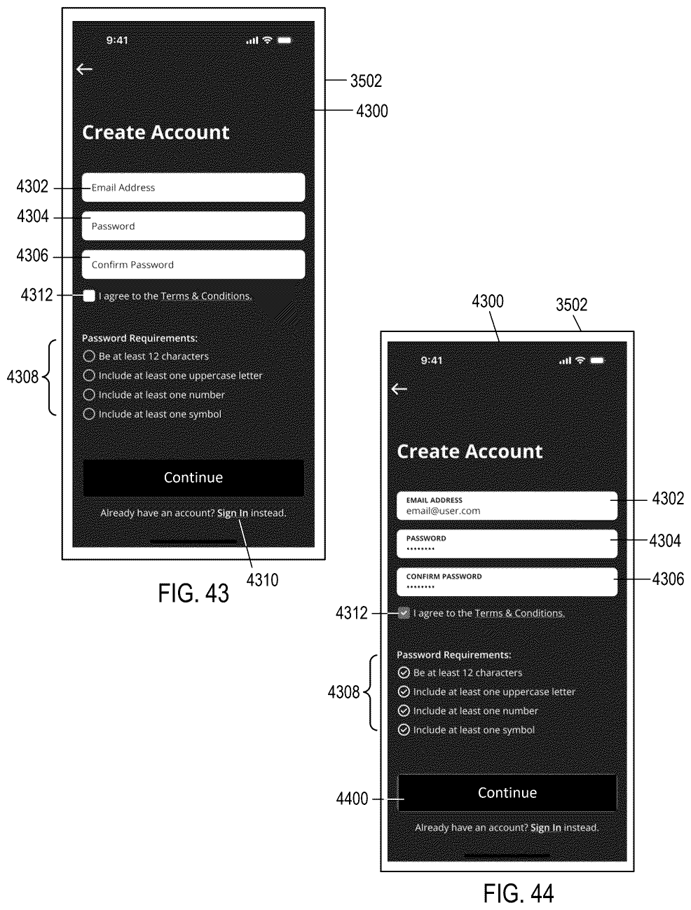

FIG. 43 illustrates an example create account screen 4300 displayed on the display screen 3502 according to an embodiment of the disclosure. The create account screen 4300 includes input elements 4302, 4304, 4306. The user may select the input elements 4302, 4304, 4306 to cause a virtual keyboard to be displayed, or the user can enter the email address and the password using a physical keyboard. An email address can be entered into the input element 4302, a password in the input element 4304, and the password in the input element 4306. A list 4308 of password requirements for the password may also be displayed in the create account screen 4300. The user can select the link 4310 to log into an existing account. The user may select the input element 4312 (e.g., checkbox) to agree to the terms and conditions of the finance management application.

FIG. 44 illustrates the example sign in screen 4300 shown in FIG. 43 according to an embodiment of the disclosure. The input element 4400 can activate once a password is entered that meets the requirements in the list 4308 of password requirements, an email address is entered in a valid format, and the input element 4312 is selected.

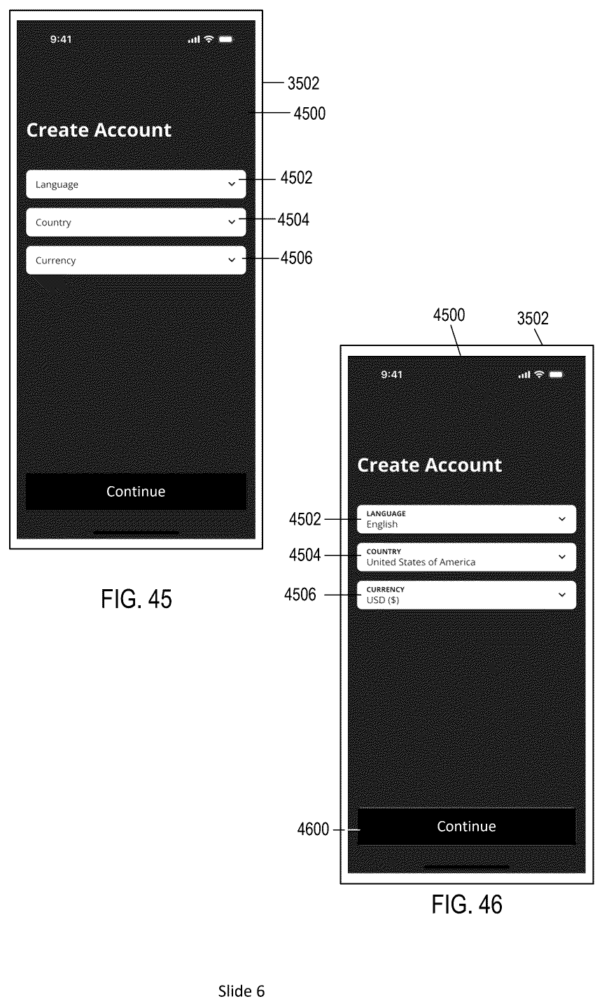

FIG. 45 illustrates an example create account screen 4500 displayed on the display screen 3502 according to an embodiment of the disclosure. The create account screen 4500 includes input elements 4502, 4504, 4506. The user can select a language using the input element 4502, a country using the input element 4504, and a currency using the input element 4506. In the illustrated embodiment, the input elements 4502, 4504, 4506 are implemented as drop-down menus, but other embodiments are not limited to this type of input element.

FIG. 46 illustrates the example create account screen 4500 shown in FIG. 45 according to an embodiment of the disclosure. A language, a country, and a currency are entered into the input elements 4502, 4504, 4506, which causes the input element 4600 to activate to enable a user to select the input element 4600.

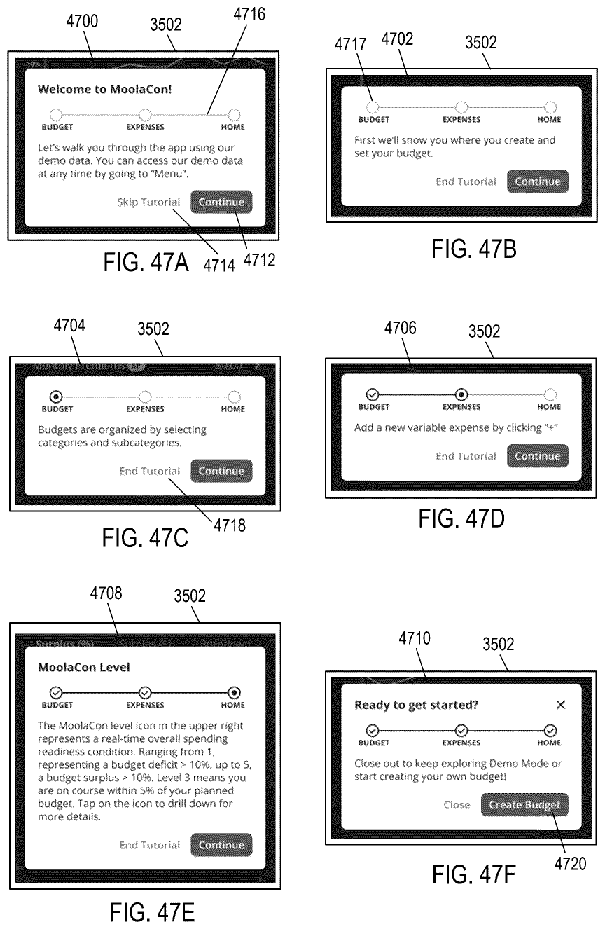

FIGS. 47A-47F illustrate screens 4700, 4702, 4704, 4706, 4708, 4710 displayed on the display screen 3502 for a tutorial of the financial management application according to an embodiment of the disclosure. In some embodiments, the user can begin a tutorial program after creating an account (e.g., using the create account screens shown in FIGS. 43-46). The screen 4700 is a welcome screen that enables the user to select an input element 4712 to continue with the tutorial or select an input element 4714 to skip the tutorial.

In the example embodiment, the tutorial is arranged in three stages; budget, expenses, and home. Each stage is tracked using a stepper element 4716. A stage is not completed when the circle graphical element 4717 in the stepper element 4716 is empty. A stage is in process when the circle graphical element 4717 in the stepper element 4716 is filled. A stage is completed when the circle graphical element 4717 in the stepper element 4716 is checked. The stepper element 4716 can be implemented differently in other embodiments. During the tutorial, the user can select the input element 4718 to end the tutorial. At the end of the tutorial, the user can select the input element 4720 to create a budget.

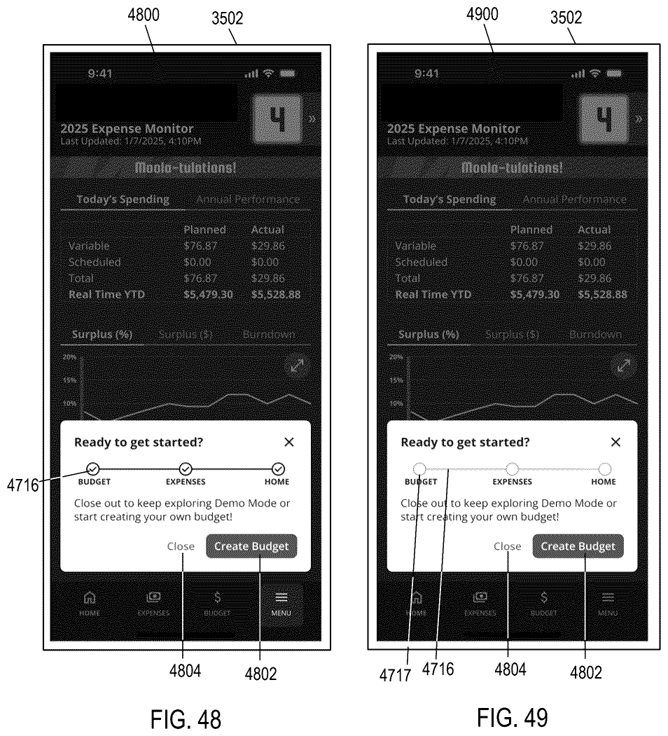

FIG. 48 illustrates a ready to start screen 4800 displayed on the display screen 3502 according to an embodiment of the disclosure. The ready to start screen 4800 may be displayed when the user ends the tutorial. The user may end the tutorial using the input element 4718 shown in FIGS. 47B-47E. The user may skip the tutorial using the input element 4714 shown in FIG. 47A. The ready to start screen 4800 displays an input element 4802 the user can select to create a budget. The ready to start screen 4800 can also display an input element 4804 the user can select to close the modal or the financial management application or to transition to a demo mode home or introductory screen. The ready to start screen 4800 can display the stepper element 4716 and indicate where the user was during the tutorial.

FIG. 49 illustrates an alternate ready to start screen 4900 displayed on the display screen 3502 according to an embodiment of the disclosure. As shown, the circle graphical elements 4717 in the stepper element 4716 are blank. As such, the ready to start screen 4900 is displayed when the user skips the tutorial. The ready to start screen 4900 displays the input elements 4802, 4804.

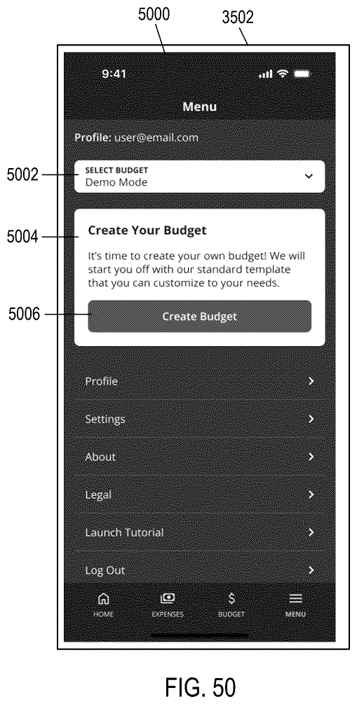

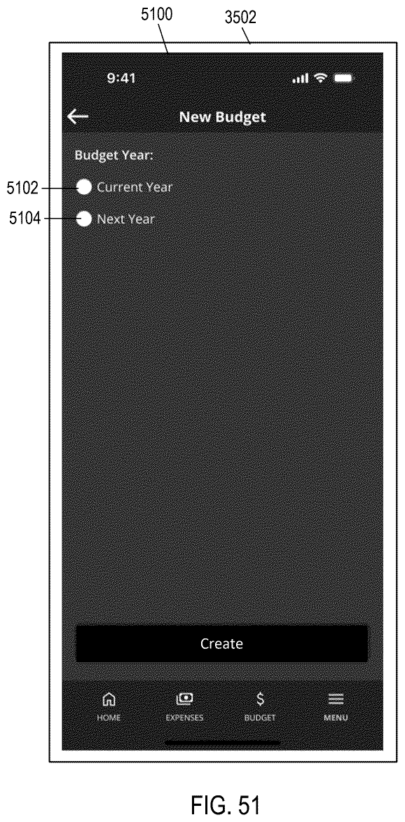

FIG. 50 illustrates a create budget screen 5000 displayed on the display screen 3502 according to an embodiment of the disclosure. In one embodiment, the create budget screen 5000 is displayed when a user ends the tutorial (e.g., using screen 47F), selects the input element 4802 shown in FIG. 49, or interacts with another input element, such as a menu. The create budget screen 5000 may display an input element 5002 that enables the user to select a budget mode. Although the input element 5002 is configured as a drop-down menu, other embodiments are not limited to this type of input element. As shown in FIG. 50, the demo mode is selected using the input element 5002. A create your budget screen 5004 may be displayed with an input element 5006. The input element 5006, when selected, allows a user to navigate to a new budget screen (e.g., shown in FIG. 51). Additionally or alternatively, a user may navigate to a new budget screen by selecting a create new budget option using the input element 5002.

FIG. 51 illustrates a new budget screen 5100 displayed on the display screen 3502 according to an embodiment of the disclosure. The new budget screen 5100 may display an input element 5102 and an input element 5104. The input elements 5102, 5104 are configured as radio buttons in the example screen 5100. The input elements 5102, 5104 may be configured as different types of input elements in other embodiments. A user can select a current year for a budget using the input element 5102 or the next year using the input element 5104.

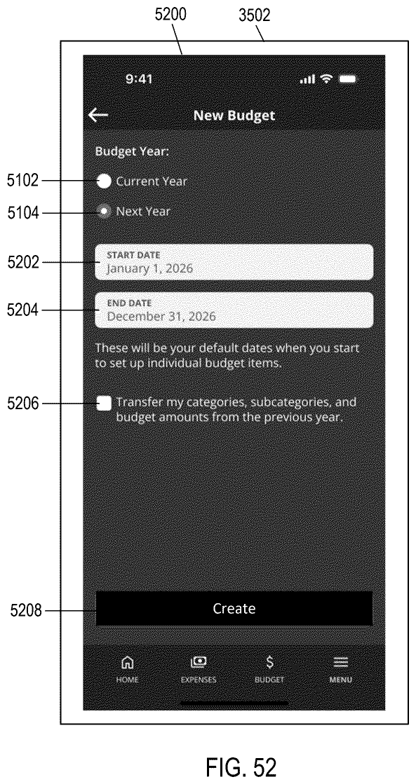

FIG. 52 illustrates a new budget screen 5200 displayed on the display screen 3502 according to an embodiment of the disclosure. When one of the input elements 5102 or 5104 are selected, the new budget screen 5200 may display an input element 5202 and an input element 5204. A user can enter a start date for the new budge using the input element 5202 and enter an end date for the new budget using the input element 5204. Although the input elements 5202, 5204 are configured as text input boxes in FIG. 52, the input elements 5202, 5204 can be implemented with different input elements in other embodiments (e.g., calendar input icons). In one embodiment, the start date defaults to the user's current date and the end date defaults to the last day of the year. When the input element 5104 is selected, a user can select an input element 5206 to transfer categories, sub-categories, and budget amounts from the previous year. When the input element 5208 is selected, the user may start with or open a budget template with all budget amounts starting at zero dollars. The user may select the input element 5208 to create the new budget.

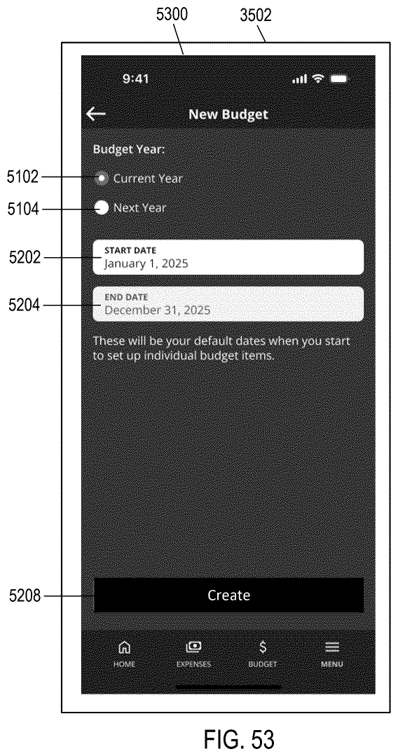

FIG. 53 illustrates a new budget screen 5300 displayed on the display screen 3502 according to an embodiment of the disclosure. In the illustrated figure, the input element 5202 is selected to select the current year for the new budget. The new budget screen 5300 may display the input element 5202 and the input element 5204. As described in conjunction with FIG. 52, the user can enter the start date for the new budge using the input element 5202 and enter the end date for the new budget using the input element 5204. In one embodiment, the start date defaults to the user's current date and the end date to the last day of the year. The user may start with or open a budget template with all budget amounts starting at zero dollars when the input element 5208 is selected.

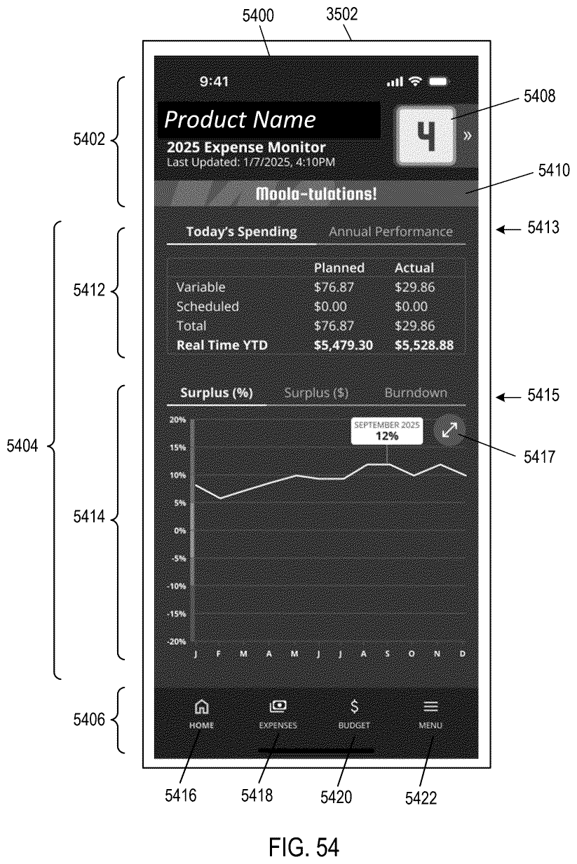

FIG. 54 illustrates an example introductory screen 5400 displayed on the display screen 3502 according to an embodiment of the disclosure. The introductory screen 5400 includes a header section 5402, a center section 5404, and a footer section 5406. The header section 5402 includes a product name or a product trademark, a title of the currently selected budget (e.g., 2025 Expense Monitor or Demo Data), the last updated data and time (e.g., Jan. 7, 2025, 4:10 PM), an adaptable icon 5408, and a banner 5410. In some embodiments, the adaptable icon 5408 includes the adaptable icon 104 shown in FIG. 1.

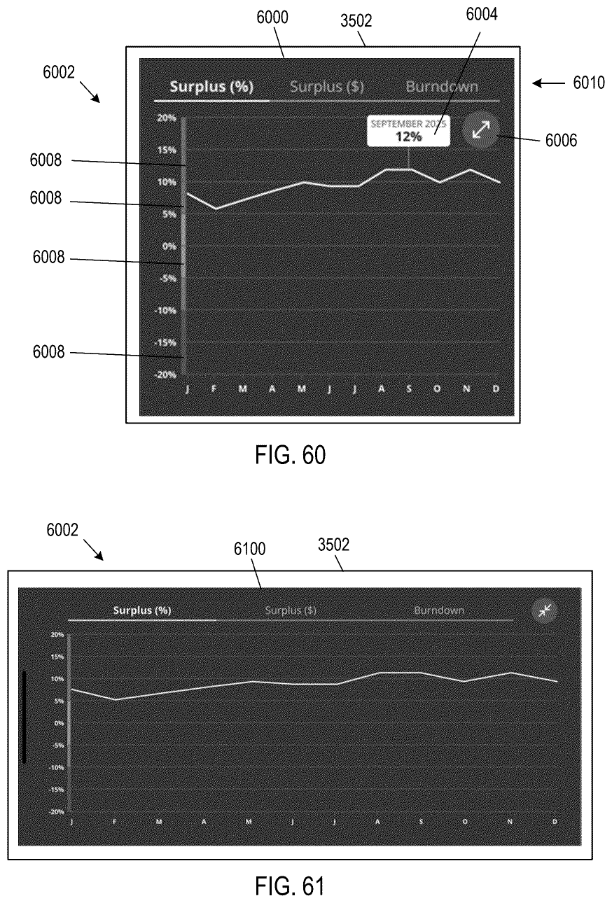

The center section 5404 may include a summary section 5412 and a graph section 5414. The summary section 5412 can include one or more metrics (e.g., the metrics 108 and/or the metrics 114 of FIG. 1). The user can toggle between “today's spending” or “annual performance” using the screen labels 5413. In some embodiments, the graph section 5414 can include the graph section 116, 212, 406, and 512 of FIGS. 1, 2, 4, and 5, respectively. The graphs may include, but are not limited to, the graphs shown in FIGS. 16-26 and/or FIGS. 60-63. The user can select the expand input element 5417 to display the graph in a landscape view (e.g., a full view landscape view). The user can toggle between different graphs using the tabs 5415.

The footer section 5406 may include one or more menu icons, such as a home icon 5416, an expenses icon 5418, a budget icon 5420, and a menu icon 5422. In some embodiments, the user can swipe up or down to refresh the introductory screen 5400 and/or to check for updates. Other embodiments may display additional or different information in a header section 5402, a center section 5404, and a footer section 5406.

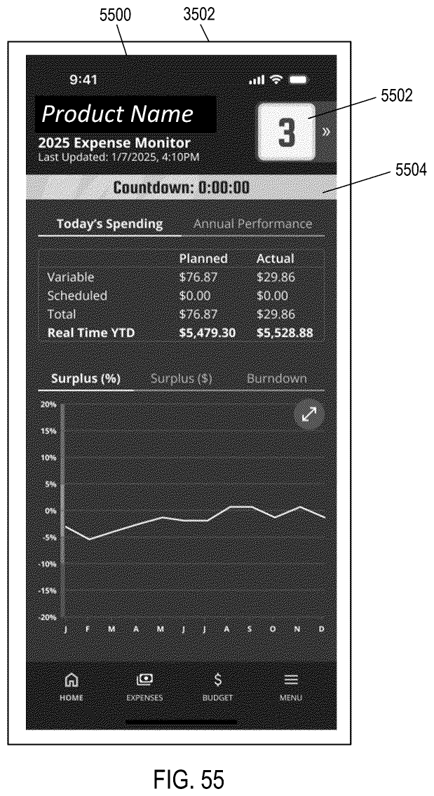

FIG. 55 illustrates another example introductory screen 5500 displayed on the display screen 3502 according to an embodiment of the disclosure. The introductory screen 5500 displays a different adaptable icon 5502 and a different banner 5504 compared to the adaptable icon 5408 and the banner 5410 shown in FIG. 54.

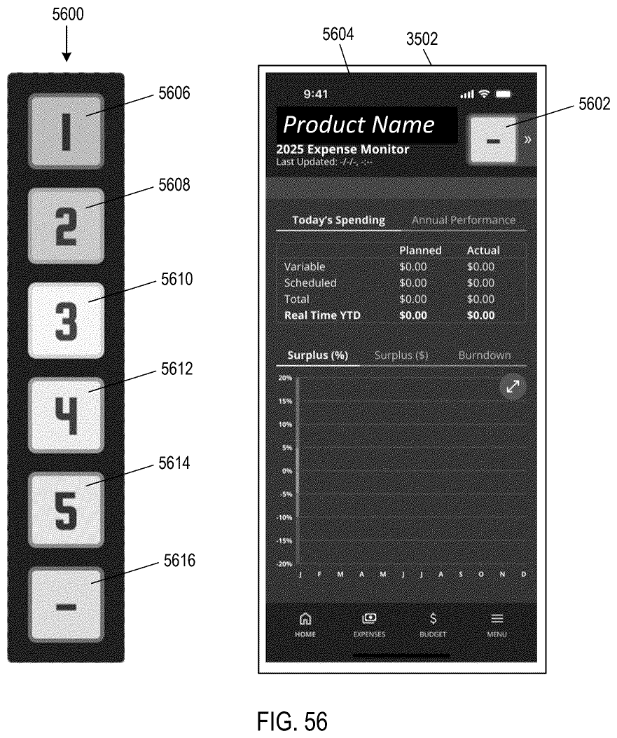

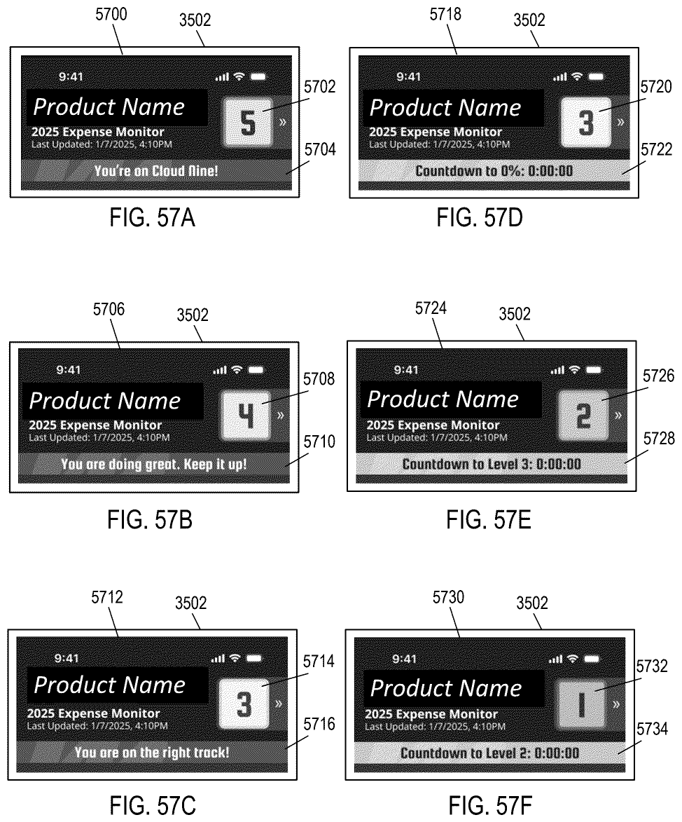

FIG. 56 illustrates example adaptable icons 5600 that may be displayed on one or more screens according to an embodiment of the disclosure. As described earlier, an adaptable icon 5602 may be displayed in a screen, such as the introductory screen 5604. In the illustrated embodiment, there are six adaptable icons 5606, 5608, 5610, 5612, 5614, 5616. An adaptable icon 5600 provides a visual notification to the user regarding the user's state or status at the time a screen is opened or updated. The status may be associated with any of the financial plans, measurements or metrics in the financial management application. For example, an adaptable icon 5600 may be associated with a spending status, a savings status, a category status, a sub-category status, and so on. The adaptable icon 5600 can change in real-time as the associated financial plan, measurement or metric changes throughout the day. Other embodiments can use a different number of colors and/or spending states, and/or shapes for the adaptable icons, and/or different pattern fills for the spending states, or other adaptable visual representations of the states, either by default or by user customization.

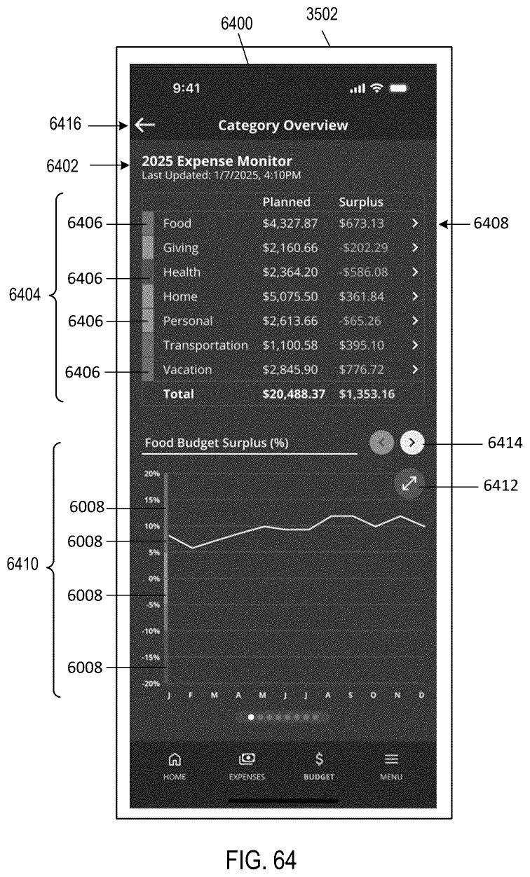

In some implementations, the adaptable icons 5606, 5608, 5610, 5612, 5614, 5616 correspond to a surplus or deficit state of the associated financial plan, measurement or metric. For example, the adaptable icon 5606 may be associated with a deficit that is greater than ten percent (>-10%) of a metric or financial plan (e.g., an expense, a savings or a budget), the adaptable icon 5608 may be associated with a deficit that is between five percent and ten percent (−10% to −5%), the adaptable icon 5610 may be associated with a deficit that is between five percent and zero and a surplus between zero and five percent (−5% to 5%), the adaptable icon 5612 may be associated with a surplus that is between five percent and ten percent (5% to 10%), and the adaptable icon 5614 may be associated with a surplus that is greater than ten percent (>+10%). The adaptable icon 5616 can be associated with a null state that may be displayed when the user has not entered any inputs for an associated financial plan, measurement or metric. For example, the adaptable icon 5616 may be displayed when the user has not entered any inputs for a budget. In some embodiments, a category overview screen can be displayed in response to the user selecting the adaptable icon 5602. Example category overview screens are shown in FIGS. 4B and 64.

FIGS. 57A-57F illustrate example headers that may be displayed in a display screen according to embodiments of the disclosure. Each header is shown as displayed on the display screen 3502. Each header may include the product name or trademark, a current budget title, the last updated date and time, the adaptable icon, and a banner. The header 5700 shown in FIG. 57A displays an adaptable icon 5702 that is associated with a status level of 5. In one embodiment, the status level of 5 may be associated with a surplus that is greater than ten percent (>+10%). The adaptable icon 5702 may be the adaptable icon 5614 shown in FIG. 56. The banner 5704 displays a notification or message that may be associated with the status level shown in the adaptable icon 5702. For example, in FIG. 57A, the banner 5704 displays a congratulatory message (e.g., “You're on cloud nine”) because the status level of 5 is associated with a surplus that is greater than ten percent (>+10%).

FIG. 57B illustrates a header 5706 that includes an adaptable icon 5708 and a banner 5710. The adaptable icon 5706 is associated with a status level of 4. In one embodiment, the status level of 4 may be associated with a surplus that is between five and ten percent (5% to 10%). The adaptable icon 5708 may be the adaptable icon 5612 shown in FIG. 56. The banner 5710 displays a notification or message that is associated with the status level shown in the adaptable icon 5708. For example, in FIG. 57B, the banner 5710 displays an encouraging message (“You are doing great. Keep it up!”) because the status level of 4 is associated with a surplus that is between five and ten percent.

FIG. 57C illustrates a header 5712 that includes an adaptable icon 5714 and a banner 5716. The adaptable icon 5714 is associated with a status level of 3. In one embodiment, the status level of 3 may be associated with a surplus that is between zero and five percent and a deficit between zero and negative five percent (−5% to 5%). The adaptable icon 5714 may be the adaptable icon 5610 shown in FIG. 56. The banner 5716 displays a notification or message that is associated with the status level shown in the adaptable icon 5714. For example, in FIG. 57C, the banner 5716 displays an encouraging message (“You are on the right track”).

As described in conjunction with FIG. 1 and FIG. 8, a countdown timer that is configured to count down to a particular state, such as a budget surplus, may be displayed in a display screen. For example, a countdown icon 126 shown in FIG. 1 and/or a countdown timer 806 shown in FIG. 8 may be displayed. In other embodiments, such as the example screens shown in FIGS. 57D-57F, a countdown timer may be displayed that counts down to the next status level. The next status level can be associated with a status level that represents an improvement or a deterioration in the financial state of the user.

FIG. 57D illustrates a header 5718 that includes an adaptable icon 5720 and a banner 5722. The adaptable icon 5720 is associated with the status level of 3. The banner 5722 displays a notification or message that is associated with the status level shown in the adaptable icon 5720. For example, in FIG. 57D, the banner 5722 displays a counter timer to a breakeven point in the budget. Since the status level of 3 covers a range that includes a deficit and a surplus (e.g., −5% to 5%), the banner 7522 may display a countdown to a deficit of zero (e.g., 0%) when the user is in a deficit. Alternately, the countdown to zero may inform the user with a surplus of a point in time when the user has a surplus of zero (e.g., a breakeven point). The countdown can be based on a current spending rate or savings rate. Additionally or alternatively, the countdown to zero may inform a user in a deficit state of a point in time when the user reaches a deficit of zero.

FIG. 57E illustrates a header 5724 that includes an adaptable icon 5726 and a banner 5728. The adaptable icon 5726 is associated with a status level of 2. In one embodiment, the status level of 2 may be associated with a deficit that is between five percent and ten percent (−5% to −10%). The adaptable icon 5726 may be the adaptable icon 5608 shown in FIG. 56. The banner 5728 displays a notification or message that is associated with the status level shown in the adaptable icon 5726. For example, in FIG. 57E, the banner 5728 displays a countdown timer to status level 3 (e.g., an improvement in the financial state), as the status level 3 is a status level associated with a smaller deficit.

FIG. 57F illustrates a header 5730 that includes an adaptable icon 5732 and a banner 5734. The adaptable icon 5732 is associated with a status level of 1. In one embodiment, the status level of 1 may be associated with a deficit that is greater than ten percent (>-10%). The adaptable icon 5732 may be the adaptable icon 5606 shown in FIG. 56. The banner 5734 displays a notification or message that is associated with the status level shown in the adaptable icon 5732. For example, in FIG. 57F, the banner 5734 displays a countdown timer to the status level 2, as the status level of 2 is a status level associated with a smaller deficit.

In other embodiments, a banner may display a notification or message that indicates at the current level of spending/saving, the user will reach a level associated with a higher level of deficit. Additionally or alternatively, multiple countdown timers may be displayed. In some embodiments, the countdown timer can count down to a status level other than the next status level (e.g., count down from status level 2 to status level 4).

In some embodiments, the adaptable icon and/or the banner may be color coded to indicate a financial state. For example, the banner may have one color (e.g., blue) when the financial state reflects a surplus and a different color when the financial state reflects a deficit. In some instances, the color of the banner may match the color of the adaptable icon.

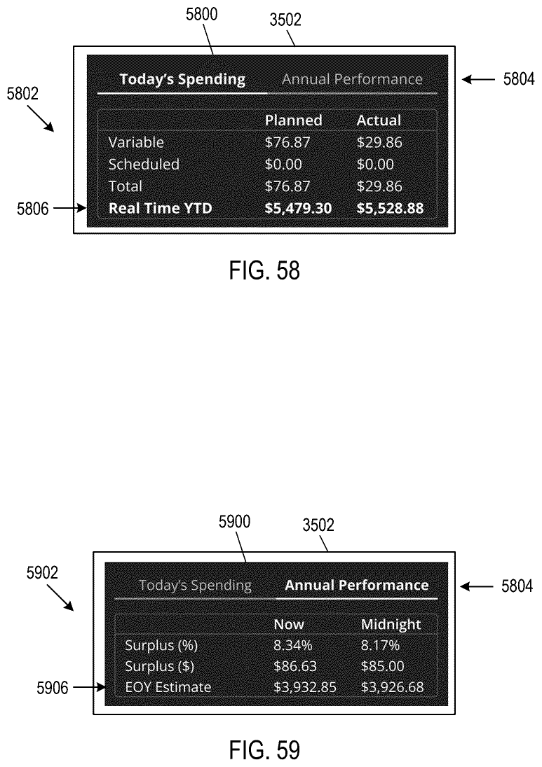

FIG. 58 illustrates a table screen 5800 displayed on the display screen 3502 according to an embodiment of the disclosure. The table 5802 shown in the table screen 5800 is configured to display a table of “today's spending” or a table of “annual performance.” The user may toggle between the two tables using the tabs or screen labels 5804. The “annual performance” tab or screen label is selected in FIG. 58. The table 5802 may include data from across all budget categories and sub-categories. The table 5802 includes planned and actual values for variable expenses and scheduled expenses. The table 5802 includes real time year-to-date (YTD) entries 5806 for the planned and actual expenses. Examples of tables that display “today's spending” and “annual performance” in one screen are shown in FIGS. 1, 2, 3A, 4A, 5B, 6A and 11.

FIG. 59 illustrates a table screen 5900 displayed on the display screen 3502 according to an embodiment of the disclosure. The table 5902 shown in the table screen 5900 is configured to display a table of “today's spending” or a table of “annual performance.” The user may toggle between the two tables using the screen labels 5804. The “annual performance” screen label is selected in FIG. 59. The table 5902 may include data from across all budget categories and sub-categories. The table 5902 includes planned and actual values for variable expenses and scheduled expenses. The table 5902 includes real time end-of-year (EOD) estimate entries 5906 for the planned and actual expenses. Examples of tables that display “today's spending” and “annual performance” in one screen are shown in FIGS. 1, 2, 3A, 4A, 5B, 6A and 11.

A screen, such as a home or introductory screen, an expense screen, a savings screen, and so on, may be configured to display one or more graphs. The number of graphs displayed may be based, for example, on the display device that is displaying the screen. For example, multiple graphs may be displayed on a larger display monitor coupled to a desktop computer while one graph may be displayed on a display screen of a mobile device. Alternately, the user of the mobile device may be able to navigate between multiple graphs by swiping left or right on each graph. FIG. 60 illustrates an example screen 6000 displayed on the display screen 3502 that displays a surplus graph 6002 according to an embodiment of the disclosure. The surplus graph 6002 plots a surplus as a percentage. The x-axis represents time and the y-axis a surplus percentage. In one embodiment, the amount of time that is represented on the x-axis is determined by the length of the budget year at the time the screen 6000 is displayed. The values represented on the y-axis may be flexible and are determined by the user's budget and spending. For example, the y-axis in the surplus graph 6002 may have fixed values from −20% to 20%. The values may expand (but not change the pixel height of the graph) if the data falls below or above the example range of −20% to 20%.

In some embodiments, the user can tap and hold the graph to reveal a tooltip that shows a data point 6004 for a particular day. The data point may cover a different time period in other embodiments. The user may also slide left and right to scroll through more data points. The surplus graph 6002 may include indicators 6008 along the y-axis that indicate the status level associated with the surplus values. For example, the indicators 6008 may be color coded with colors that are associated with the status levels shown in FIG. 56. Additionally or alternatively, the user can select the expand input element 6006 to display the surplus graph in a landscape view (e.g., a full view landscape view). The screen labels 6010 may be used to select different graphs, such as the surplus (%) graph, the surplus ($) graph, and a burndown graph.

FIG. 61 illustrates an example screen 6100 of the surplus graph 6002 in a landscape view according to an embodiment of the disclosure. The screen 6100 may be displayed in response to the user selecting the expand input element 6006 shown in FIG. 60.

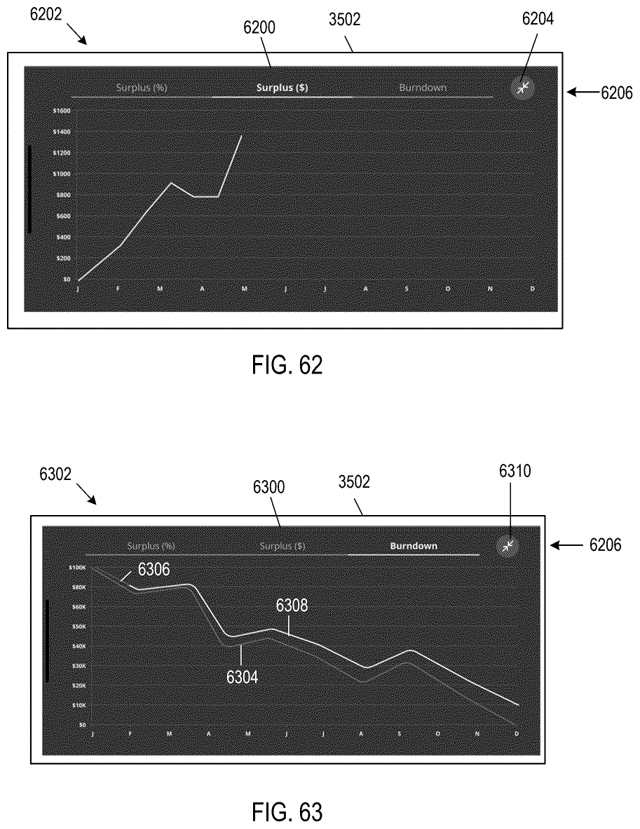

FIG. 62 illustrates an example screen 6200 displayed on the display screen 3502 that displays a surplus graph 6202 according to an embodiment of the disclosure. The surplus graph 6202 plots a surplus in a currency (e.g., U.S. dollars). The x-axis represents time and the y-axis a surplus currency amount. In one embodiment, the amount of time that is represented on the x-axis is determined by the length of the budget year at the time the screen 6200 is displayed. The values represented on the y-axis may be flexible and are determined by the user's budget and spending. The values on the y-axis may expand (but not change the pixel height of the graph) if the data falls below or above the example range of currency amounts.

The illustrated graph 6202 is displayed in a landscape view. The user can select the collapse input element 6204 to display the surplus graph in a portrait view or to display the surplus graph 6202 in a screen, such as an introductory or home screen (e.g., the introductory screen shown in FIG. 60). The screen labels 6206 may be used to select different graphs, such as the surplus (%) graph, the surplus ($) graph, and a burndown graph.

FIG. 63 illustrates an example screen 6300 displayed on the display screen 3502 that displays a burndown graph 6302 according to an embodiment of the disclosure. In the illustrated embodiment, the burndown graph 6302 includes three plots. Plot 6304 represents planned spending, plot 6306 represents actual spending, and plot 6308 represents estimated spending. The user can select the collapse input element 6310 to display the surplus graph in portrait view or to display the surplus graph 6302 in a screen, such as an introductory or home screen (e.g., the introductory screen shown in FIG. 60). The tabs or screen labels 6206 may be used to select different graphs, such as the surplus (%) graph, the surplus ($) graph, and a burndown graph.

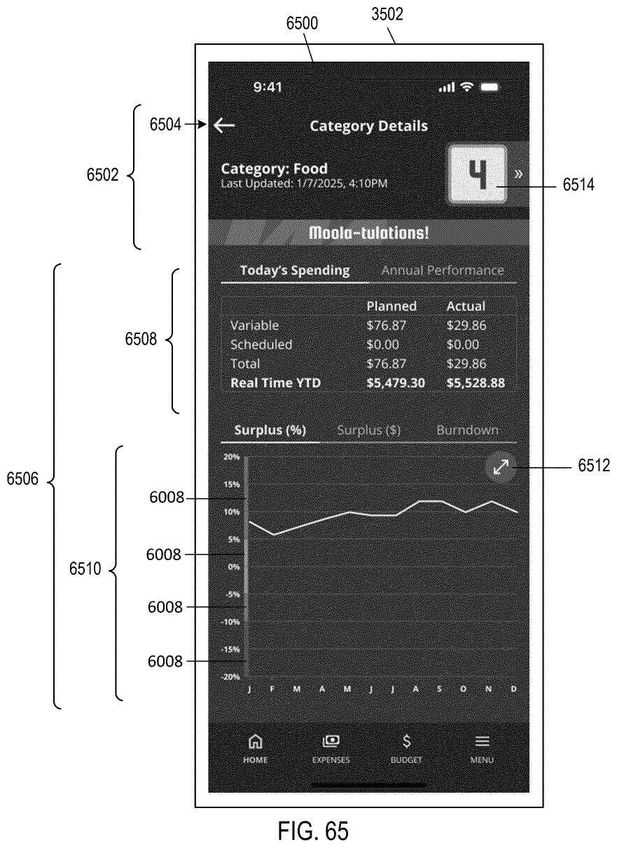

FIG. 64 illustrates an example category overview screen 6400 displayed on the display screen 3502 according to an embodiment of the disclosure. The budget title (e.g., 2025 Expenses Monitor or Demo Data) and last updated date and time may be displayed in section 6402. The user may swipe up or down to refresh the category overview screen 6400 and check for updates. The category overview screen 6400 may display a list 6404 of categories with planned and surplus columns. The list 6404 may include indicators 6406 for each category that indicates the status level of that category. For example, the indicators 6406 may be color coded with colors that are associated with the status levels shown in FIG. 56. A user may select an input element 6408 (e.g., the right-facing arrow) on any category row to cause a category details screen to be displayed. For example, the category details screen shown in FIG. 5B or 65 may be displayed.

The category overview screen 6400 may further display a graph that is associated with a particular category in a graph section 6410. The category overview screen 6400 may include the indicators 6008 along the y-axis to indicate the status level associated with the categories. Additionally or alternatively, the user can select the expand input element 6412 to display the graph in a landscape view. In some instances, the user can select the right and left arrow input elements 6414 to toggle between graphs for the categories shown in the list 6404. The graphs may include, but are not limited to, the graphs shown in FIGS. 16-26 and/or FIGS. 60-63. Selecting the back input element 6416 will cause the introductory screen to be displayed in some embodiments (e.g., the introductory screen 5400 or 5500 shown in FIGS. 54 and 55, respectively). Another example of a category overview screen is shown in FIG. 4B.

FIG. 65 illustrates an example category details screen 6500 displayed on the display screen 3502 according to an embodiment of the disclosure. The category details screen 6500 provides details (e.g., budget and spending data) on a particular category, such as the food category shown in FIG. 65. The category details screen 6500 includes a header section 6502 with a back input element 6504. When selected, the back input element 6504 may return the user to another screen, such as the category overview screen shown in FIG. 64. The header section 6502 may be arranged as the header section 5402 shown in FIG. 54 in some embodiments.

The category details screen 6500 can further include a center section 6506 with a summary section 6508 and a graph section 6510. The center section 6506 may be arranged as the center section 5404 shown in FIG. 54. The graph displayed in the graph section 6510 may include the indicators 6008 shown in FIG. 60. The graphs may include, but are not limited to, the graphs shown in FIGS. 16-26 and/or FIGS. 60-63.

The user may select the expand input element 6512 to cause the graph to be displayed in a landscape view. In some embodiments, selecting the adaptable icon can take the user to another screen, such as a sub-category overview screen. Another example of a category details screen is shown in FIG. 5B.

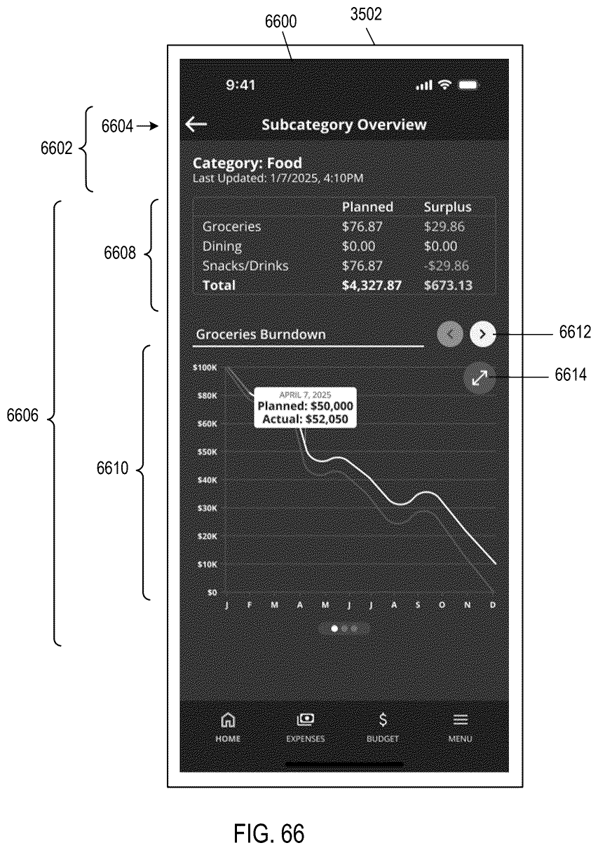

FIG. 66 illustrates an example sub-category overview screen 6600 displayed on the display screen 3502 according to an embodiment of the disclosure. The sub-category overview screen 6600 provides a list of all sub-categories for a particular category (e.g., food). The sub-category overview screen 6600 includes a header section 6602 with a back input element 6604. When selected, the back input element 6604 may return the user to another screen, such as the category details screen shown in FIG. 65. In the illustrated embodiment, the header section 6602 includes a sub-category title and a last updated date and time.

The sub-category overview screen 6600 can further include a center section 6606 with a summary section 6608 and a graph section 6610. The center section 6606 may be arranged as the center section 5404 shown in FIG. 54. The values in the planned and surplus columns may be color coded. For example, a value associated with a sub-category that has a surplus may be displayed in one color (e.g., green) while a value associated with a sub-category that has a deficit may be displayed in another color (e.g., red). In another embodiment, the values may be color coded to match a status level associated with each sub-category.

A user can toggle between graphs associated with the sub-category by selecting the right and left arrow input elements 6612. The graphs may include, but are not limited to, the graphs shown in FIGS. 16-26 and/or FIGS. 60-63. In some embodiments, the graphs may be one type of graph for each sub-category. For example, in the illustrated embodiment, the graphs may all be burndown graphs with one burndown graph for each sub-category. The user may also select the expand input element 6614 to cause the graph to be displayed in a landscape view. Another example of a sub-category overview screen is shown in FIG. 6B.

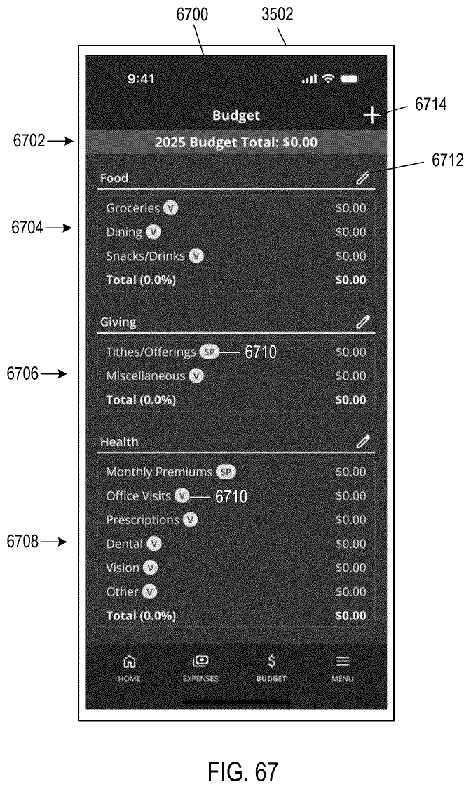

FIG. 67 illustrates an example budget screen 6700 displayed on the display screen 3502 according to an embodiment of the disclosure. A banner 6702 may display a total budget across all categories and sub-categories. The budget screen 6700 may be broken down into tables 6704, 6706, 6708, where each table 6704, 6706, 6708 represents a category. A list of sub-categories may be displayed in each table 6704, 6706, 6708. Each table 6704, 6706, 6708 may also include a total amount and a percentage that represents how much the total amount consumes of the overall total budget.

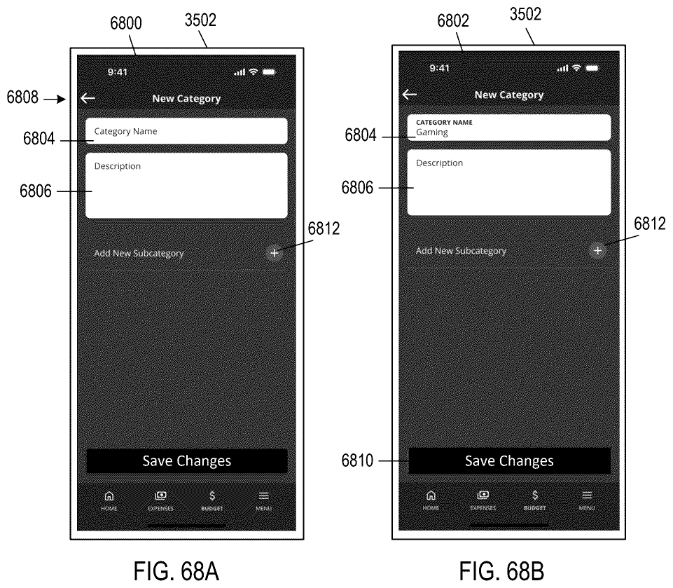

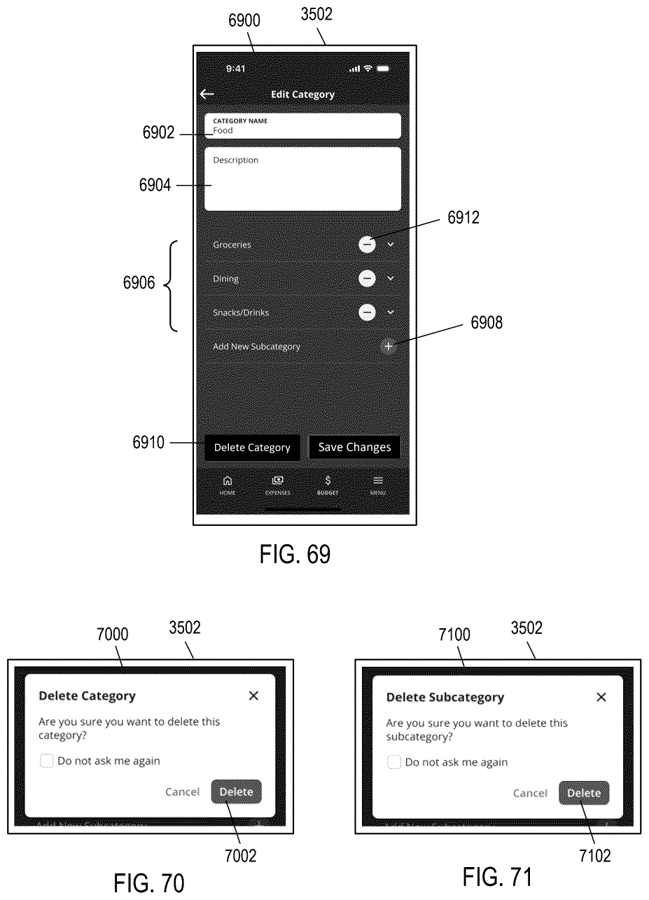

An expense type badge 6710 may be displayed with each sub-category. In the illustrated embodiment, the expense types include variable (v), scheduled periodic (sp), and/or scheduled custom (not shown). The user may select the edit input element 6712 to cause an edit category screen to be displayed (e.g., the edit category screen 2800 shown in FIG. 28B or the edit category screen 6900 shown in FIG. 69). The user may select the new category input element 6714 to cause a new category screen to be displayed. Example new category screens include the new category screen 2702 shown in FIG. 27B and the new category screens shown in FIGS. 68A and 68B and the edit category screen shown in FIG. 69.

FIGS. 68A-68B illustrate example new category screens 6800, 6802 displayed on the display screen 3502 according to an embodiment of the disclosure. The new category screen 6800 includes a text input box 6804 and a text input box 6806. A name for the category may be entered in the text input box 6804. An optional description may be entered in the optional text input box 6806. The user may select the text input boxes 6804, 6806 to cause a virtual keyboard to be displayed, or the user can enter the category name and the description using a physical keyboard. When selected, the back input element 6808 may return the user to another screen, such as the budget screen 6700 shown in FIG. 67.

FIG. 68B illustrates the new category screen 6802 with an example category name entered in the text input box 6804. In some embodiments, when at least one character is entered into the text input box 6804, the input element 6810 (Save Changes) is activated. The user may select the input element 6812 to add a new sub-category to the category named in the text input box 6804. When the input element 6812 is selected, a new sub-category screen is displayed. Example new sub-category screens include the new sub-category screens shown in FIGS. 29B, 30B, 31B, 32B, and 72.

FIG. 69 illustrates an example edit category screen 6900 displayed on the display screen 3502 according to an embodiment of the disclosure. The edit category screen 6900 may be displayed in response to the user selecting the edit input element 6712 shown in FIG. 67. The edit category screen 6900 includes a text input box 6902, a text input box 6904, and a list 6906 of sub-categories that are associated with the category name in the text input box 6902. In the illustrated embodiment, the category name is Food and the list 6906 includes a list of sub-categories associated with the Food category. A user can add a new sub-category by selecting the input element 6908, which causes a new sub-category screen to be displayed. Example new sub-category screens are shown in FIGS. 29B, 30B, 31B, 32B, and 72.

FIG. 70 illustrates an example delete category screen 7000 displayed on the display screen 3502 according to an embodiment of the disclosure. When a user selects the input element 6910 in the edit category screen 6900 shown in FIG. 69, the delete category screen 7000 is displayed. Selecting the input element 7002 will cause the category to be deleted.

FIG. 71 illustrates an example delete sub-category screen 7100 displayed on the display screen 3502 according to an embodiment of the disclosure. When a user selects the “−” input element 6912 in the edit category screen 6900 shown in FIG. 69, the delete sub-category screen 7100 is displayed. Selecting the input element 7102 will cause the sub-category to be deleted.

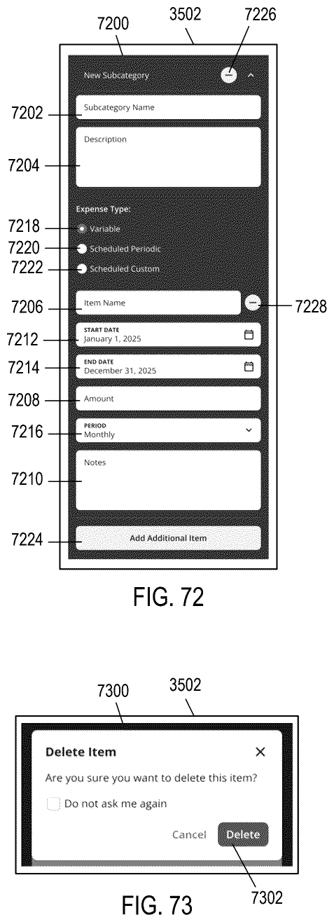

FIG. 72 illustrates an example new sub-category screen 7200 displayed on the display screen 3502 according to an embodiment of the disclosure. The new sub-category screen 7200 may be displayed in response to the user selecting the input element 6908 shown in FIG. 69. In some embodiments, the new sub-category screen 7200 may also be used as an edit sub-category screen.

The new sub-category screen 7200 includes text input boxes 7202, 7204, 7206, 7208, 7210. A name for the sub-category may be entered in the text input box 7202. An optional description for the sub-category may be entered in the optional text input box 7204. An item name 7206 may be entered in the text input box 7206. An amount may be entered in the text input box 7208. Optional notes may be entered in the optional text input box 7210. The user may select the text input boxes 7202, 7204, 7206, 7208, 7210 to cause a virtual keyboard to be displayed, or the user can enter the information using a physical keyboard.

The new sub-category screen 7200 may further include input elements 7212, 7214, 7216. A start date for the new sub-category may be entered using the input element 7212. An end date for the new subcategory may be entered using the input element 7214. The input elements 7212, 7214 are configured as calendar input icons. A period for the new sub-category may be entered using the input element 7216 (e.g., a drop-down menu). Different types of input elements may be used in other embodiments.

The new sub-category screen 7200 may further include input elements 7218, 7220, 7222 that are used to select an expense type for the new sub-category. In FIG. 72, the input elements 7218, 7220, 7222 are implemented as radio buttons, and the expense types are variable, scheduled periodic, and scheduled custom, respectively. In one embodiment, the expense type may default to the variable expense type (shown with the selection of input element 7218). In some embodiments, the user can add more than one budget item to a sub-category by selecting the input element 7224.

An item may be used to represent different aspects of a category, sub-category, expense, savings, and the like. For example, a category or sub-category may be “vacation”, and an item may be associated with each month in which a vacation is planned. For example, one item may be March for a planned spring break vacation and another item may be July for a planned summer vacation. In one embodiment, an item is grouped with the sub-category, category, and the like and is not treated separate from the category, sub-category, etc.

FIG. 73 illustrates an example delete screen 7300 displayed on the display screen 3502 according to an embodiment of the disclosure. When a user selects the “−” input element 7226 or the “−” input element 7228, the delete screen 7300 is displayed. Selecting the input element 7302 will cause the sub-category to be deleted. Selecting the input element 7226 will cause the entire sub-category to be deleted, which would cause the delete sub-category screen 7100 shown in FIG. 71 to be displayed.

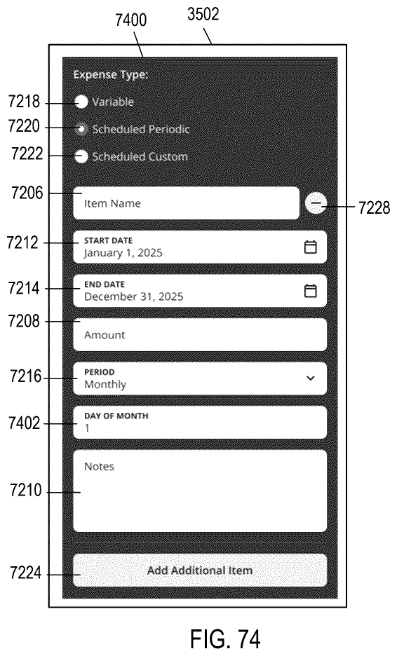

FIG. 74 illustrates a portion of an example new sub-category screen 7400 displayed on the display screen 3502 according to an embodiment of the disclosure. For simplicity, the text input boxes 7202, 7204 and the input element 7226 are not shown in the new sub-category screen 7400. Based on the selection of the input element 7220, the new sub-category screen 7400 is used to add a new scheduled periodic expense. The new sub-category screen 7400 includes the input elements 7206, 7208, 7210, 7212, 7214, 7216, 7218, 7220, 7222 shown in FIG. 72. The new sub-category screen may further include a text input box 7402 where a day of the month may be entered. The day of the month is the day in which the scheduled periodic payment is to be paid.

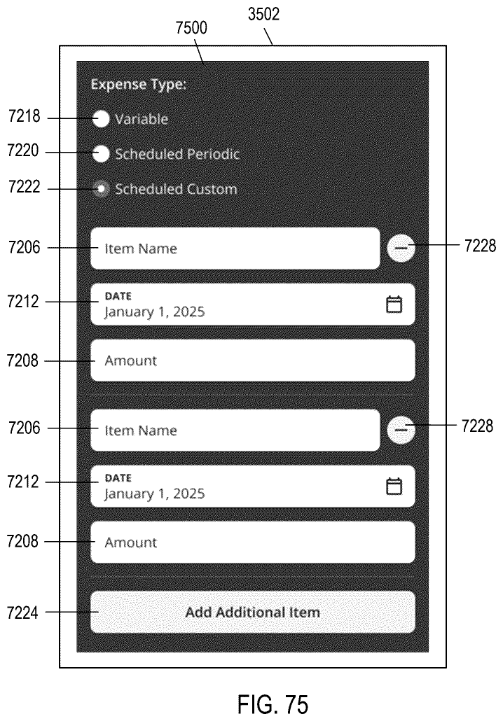

FIG. 75 illustrates a portion of an example new sub-category screen 7500 displayed on the display screen 3502 according to an embodiment of the disclosure. For simplicity, the text input boxes 7202, 7204 and the input element 7226 are not shown in the new sub-category screen 7500. Based on the selection of the input element 7222, the new sub-category screen 7500 is used to add a new scheduled custom expense. The new sub-category screen 7500 includes the input elements 7206, 7208, 7212, 7218, 7220, 7222 shown in FIG. 72. The new sub-category screen 7500 omits the text input box 7210 and the input elements 7214, 7216 shown in FIG. 72. The text input box 7210 and the input elements 7214, 7216 may be omitted because a scheduled custom expense is a scheduled expense that occurs at select times (e.g., one or a few times in a fiscal year).

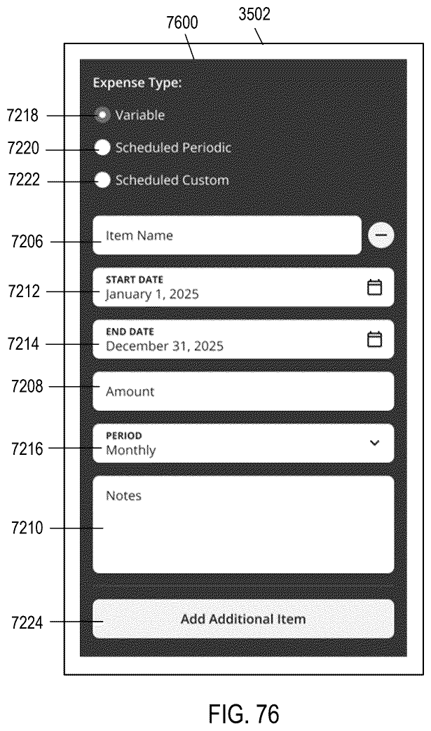

FIG. 76 illustrates a portion of an example new sub-category screen 7600 displayed on the display screen 3502 according to an embodiment of the disclosure. For simplicity, the text input boxes 7202, 7204 and the input element 7226 are not shown in the new sub-category screen 7600. Based on the selection of the input element 7218, the new sub-category screen 7600 is used to add a new variable expense. The new sub-category screen 7600 includes input elements that are similar to the input elements shown in the new sub-category screen 7200 of FIG. 72 (with the noted omission of the text input boxes 7202, 7204 and the input element 7226). Another example of a new sub-category screen is shown in FIG. 29B.

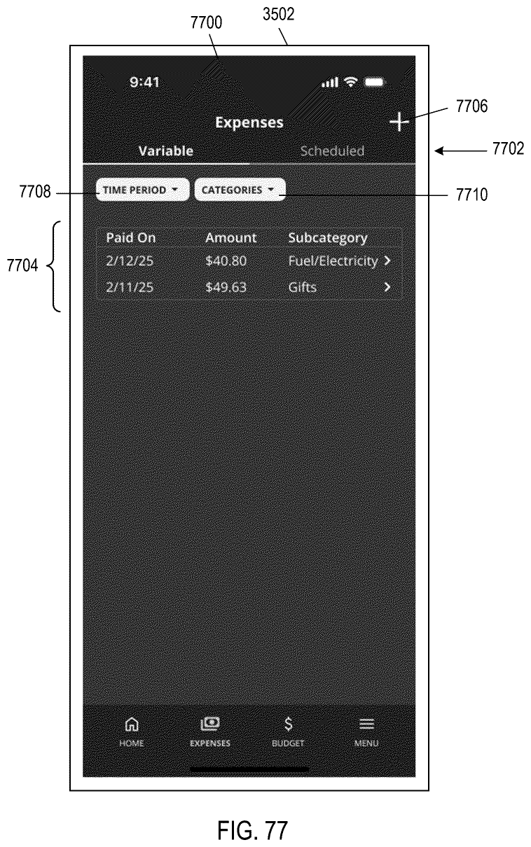

FIG. 77 illustrates an example expense screen 7700 displayed on the display screen 3502 according to an embodiment of the disclosure. The user can toggle between variable expenses and scheduled expenses using the tabs or screen labels 7702. In FIG. 77, the variable expenses screen label is selected and a list 7704 of variable expenses is displayed. In one embodiment, the variable expenses are listed by date order, starting with the most recent date. The user can select the input element 7706 to cause a new expense screen to be created. Examples of new variable expense screens are shown in FIGS. 7B, 8B, and 82. The user may filter the expenses shown in the list 7704 by selecting the input element 7708 or the input element 7710. The input element 7708 may filter by a selected time period and the input element 7710 may filter by a category and/or a sub-category.

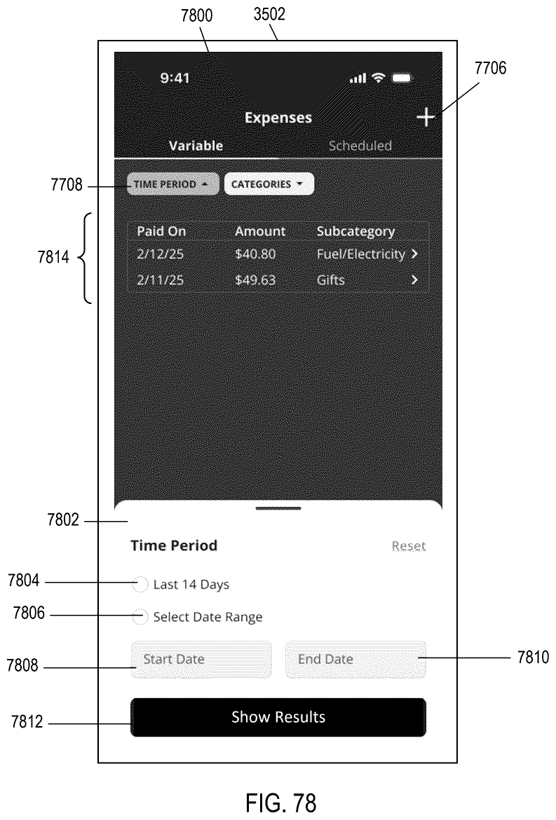

FIG. 78 illustrates an example filter for an expense screen 7800 displayed on the display screen 3502 according to an embodiment of the disclosure. The expense screen 7800 may be displayed in response to the user selecting the input element 7708 shown in FIG. 77. A screen 7802 is displayed that enables the user to enter a time period to filter the expenses. The screen 7802 includes an input element 7804 and an input element 7806. The input element 7804 may be used to select a preset time period, such as fourteen days. The input element 7806 may be used to enter a custom time period. When the input element 7806 is selected, the user may enter a start date and an end date using the text input boxes 7808, 7810, respectively. An input element 7812 may activate once the input element 7804 is selected or when a date range is entered in the text input boxes 7808, 7810. The user can select the input element 7812 to cause the expenses to be filtered and displayed in the list 7814 of expenses.

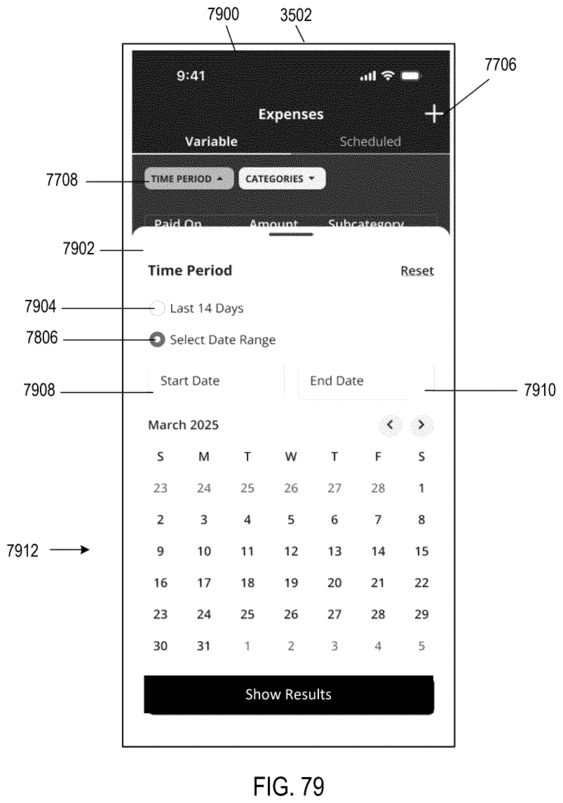

FIG. 79 illustrates an example filter for an expense screen 7900 displayed on the display screen 3502 according to an embodiment of the disclosure. The expense screen 7900 may be displayed in response to the user selecting the input element 7708 shown in FIG. 77. A screen 7902 is displayed that enables the user to enter a time period to filter the expenses. The screen 7902 includes an input element 7904 and an input element 7906. The input element 7904 may be used to select a preset time period, such as fourteen days. The input element 7906 may be used to enter a custom time period. When the input element 7906 is selected, the user may enter a start date and an end date using the text input boxes 7908, 7910, respectively. Alternately, the user may enter a start date and an end date using the calendar input 7912.

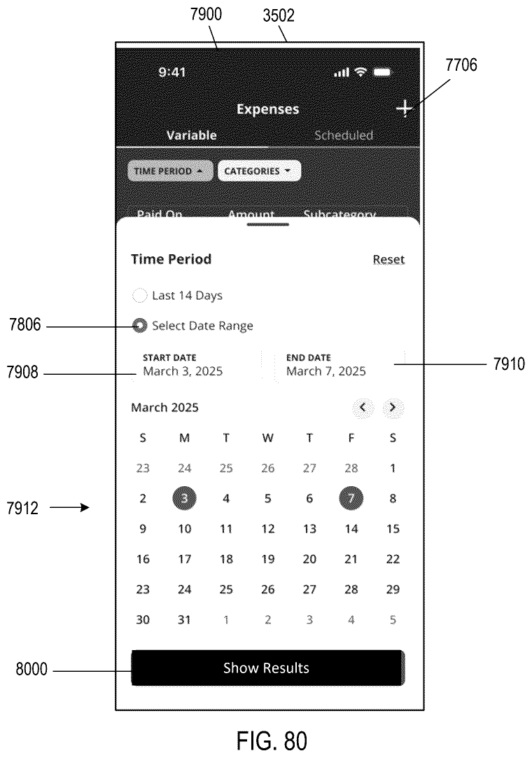

FIG. 80 illustrates an example filter for the expense screen 7900 shown in FIG. 79 according to an embodiment of the disclosure. The input element 7906 is selected and a start date and an end date are entered using the calendar input 7912. As shown in FIG. 80, the start date of Mar. 3, 2025 is selected in the calendar input 7912 and is responsively entered into the text input box 7908, and the end date of Mar. 7, 2025 is selected in the calendar input 7912 and is responsively entered into the text input box 7910. Once the start and end dates are selected, the user may select the input element 8000 to cause the expenses to be filtered based on the entered time period.

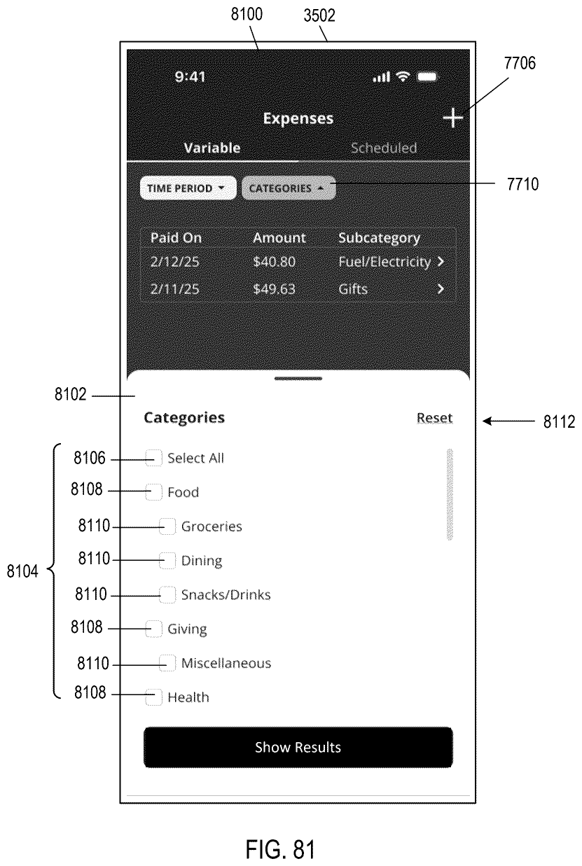

FIG. 81 illustrates an example filter for an expense screen 8100 displayed on the display screen 3502 according to an embodiment of the disclosure. The expense screen 8100 may be displayed in response to the user selecting the input element 7710 shown in FIG. 77. A screen 8102 is displayed that includes a list 8104 of categories and all sub-categories (when sub-categories have been created) for the selected expense type (variable or scheduled). The user can select or unselect all of the categories and sub-categories (when sub-categories have been created) by selecting or unselecting the input element 8106. The user may select or unselect a category by selecting or unselecting an input element 8108. In some embodiments, all of the sub-categories associated with a selected category are selected when the category is selected. The user may select or unselect individual sub-categories by selecting or unselecting an input element 8110. The user may select the input element 8112 to reset the expense screen 8100 and/or the screen 8102.

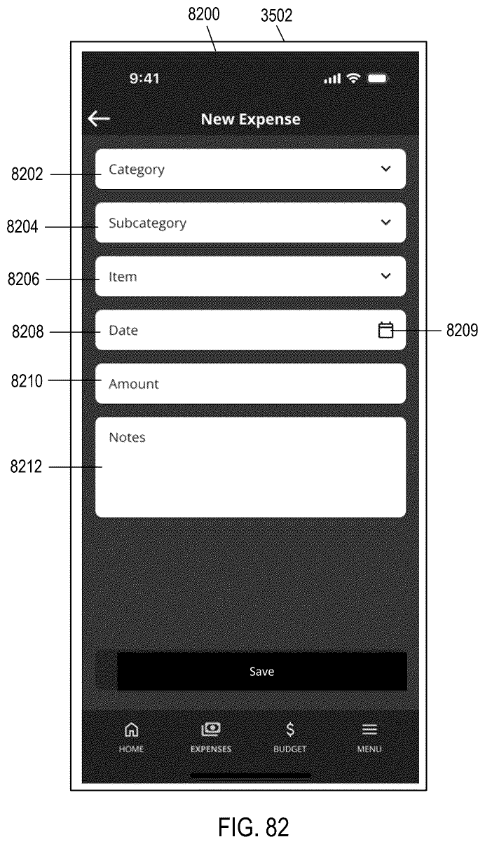

FIG. 82 illustrates a new variable expense screen 8200 displayed on the display screen 3502 according to an embodiment of the disclosure. The new variable expense screen 8200 may be displayed in response to the user selecting the input element 7706 shown in FIGS. 77-81 when the variable screen label 7702 is selected. The new variable expense screen 8200 includes input elements 8202, 8204, 8206. A name of a category may be selected using the input element 8202. A name of a sub-category (if there will be a sub-category) may be selected using the input element 8204. An item may be selected using the input element 8206. The input elements 8202, 8204, 8206 are shown as drop-down menus in FIG. 82, and in some embodiments only categories with variable sub-categories may be shown in the drop-down menu. The sub-categories that are shown depend on the category selected, and only items found within the chosen sub-category may be shown. However, other embodiments may use a different type or different types of input elements. For example, at least one of the input elements 8202, 8204, 8206 may be implemented as a text input box to enable a user to enter a new category name, sub-category name, and/or item name.

The new variable expense screen 8200 can further include an input element 8208. A date may be entered using the input element 8208. The calendar icon 8209 in the input element 8208 can be selected to enter the date. The new variable expense screen 8200 may include text input boxes 8210, 8212. An amount may be entered using the text input box 8210 and an optional note may be entered using the optional text input box 8212. Different types of input elements may be used instead of the input element 8208 and the text input boxes 8210, 8212 in other embodiments.

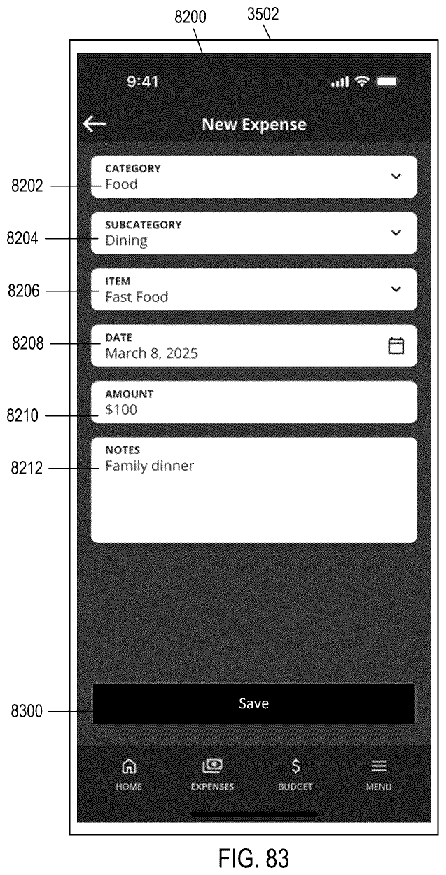

FIG. 83 illustrates the new variable expense screen 8200 shown in FIG. 82 according to an embodiment of the disclosure. The new variable screen 8200 depicts non-limiting nonexclusive example entries for each of the input elements 8202, 8204, 8206, 8208 and the text input boxes 8210, 8212. In one embodiment, the input element 8300 (“Save”) activates once entries are input into the input elements 8202, 8204, 8206, 8208, and 8210. Another example of a new variable expense screen is shown in FIG. 7B.

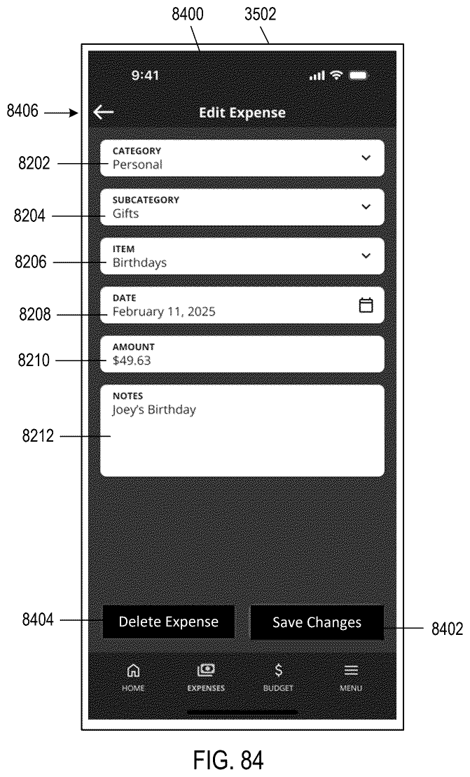

FIG. 84 illustrates an edit variable expense screen 8400 displayed on the display screen 3502 according to an embodiment of the disclosure. The edit variable expense screen 8400 may be displayed in response to the user selecting an existing variable expense. For example, the user may select an existing variable expense using the expense screen 700 shown in FIG. 7A or the expense screen 7700 shown in FIG. 77. The edit variable expense screen 8400 includes the input elements 8202, 8204, 8206, 8208 and the text input boxes 8210, 8212. Non-limiting nonexclusive example entries are depicted in each of the input elements 8202, 8204, 8206, 8208 and the text input boxes 8210, 8212.

A user may select the input element 8402 (“Save Changes”) to save the edits to a variable expense. In one embodiment, the input element 8402 is activated when at least one change is entered. A user may select the input element 8404 (“Delete Expense”) to delete the variable expense. The edits to the variable expense are discarded when the user selects the back input element 8406.

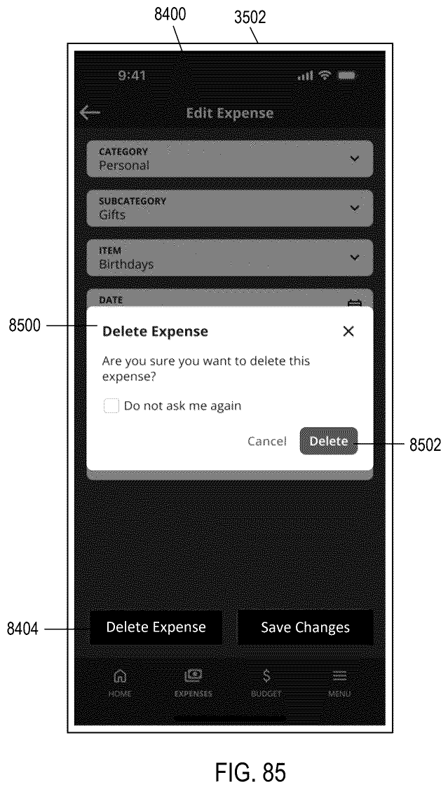

FIG. 85 illustrates the edit variable expense screen 8400 shown in FIG. 84 after the input element 8404 is selected according to an embodiment of the disclosure. An example delete expense screen 8500 is displayed. Selecting the input element 8502 causes the variable expense to be deleted. Another example of an edit variable expense screen is shown in FIG. 10B.

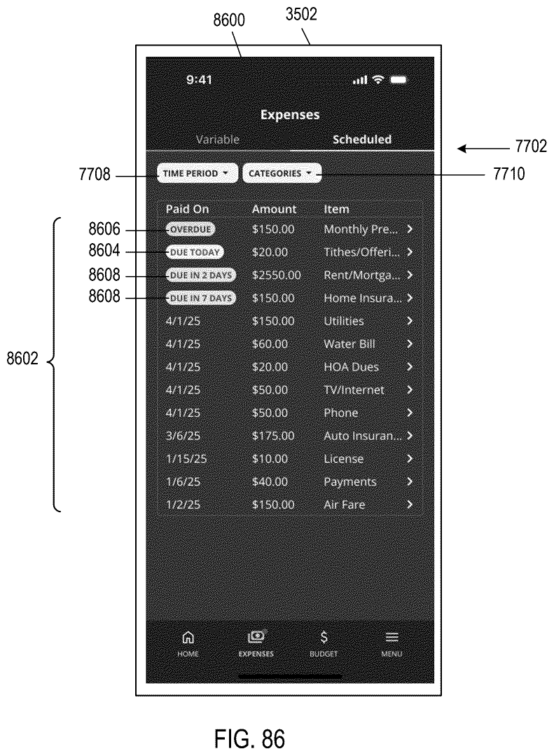

FIG. 86 illustrates an example expense screen 8600 displayed on the display screen 3502 according to an embodiment of the disclosure. As described earlier in conjunction with FIG. 77, the user can toggle between variable expenses and scheduled expenses using the screen labels 7702. In FIG. 86, the scheduled expenses screen label 7702 is selected and a list 8602 of scheduled expenses is displayed. The example expense screen 8600 includes a paid date column, an amount column, and a description or item column. The user may filter the expenses shown in the list 8602 by selecting the input element 7708 or the input element 7710. The different filtering operations shown in FIGS. 78-81 may be used to filter the scheduled expenses.

In the illustrated embodiment, alert badges 8604, 8606 may be displayed when an expense is due that day or is overdue, respectively. Additionally or alternatively, an alert badge 8608 may be displayed when payment on an expense is due within a given time period. For example, the alert badge 8608 can be displayed for expenses due within the next seven days. The alert badge 8608 may specify the number of days until the due date. In one embodiment, the overdue expenses, the due today expenses, and the expenses to be paid (e.g., the expenses without a paid date) can be displayed at the top of the list 8602. In some embodiments, the alert badges 8604, 8606, 8608 may be color coded. For example, the alert badge 8606 may be color coded red, the alert badge 8604 yellow, and the alert badge 8608 blue. Additionally, expenses that have been paid and meet the filter criteria may be listed in the list 8602 in descending paid on date order below any unpaid expenses. Selecting a particular expense may cause the edit scheduled expenses screen to be displayed (e.g., FIG. 12B, 13B, or 87). Another example of a scheduled expense screen is shown in FIG. 12A.

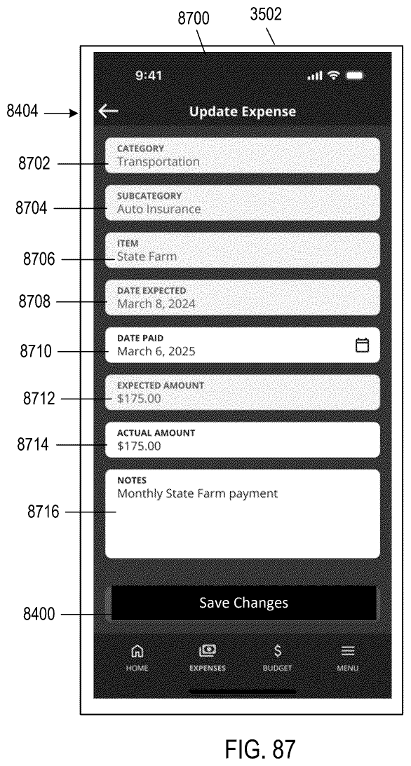

FIG. 87 illustrates an example edit expense screen 8700 displayed on the display screen 3502 according to an embodiment of the disclosure. The user may select an existing scheduled expense to cause the edit expense screen 8700 to be displayed. For example, the user may select an existing scheduled expense using the expense screen 1200 shown in FIG. 12A, the expense screen 1200′ shown in FIG. 13A, or the expense screen 8600 shown in FIG. 86. The expense screen 8700 includes the input elements 8702, 8704, 8706, 8708, 8710, 8712, 8714, 8716. A name for a category may displayed in the input element 8702. A name for a sub-category may be displayed in the input element 8704. A name for an item may be displayed in the input element 8706. An expected pay date may be displayed in the input element 8708. An actual pay date may be displayed in the input element 8710. An expected amount may be displayed in the input element 8712. An actual amount paid may be displayed in the input element 8714. A note may be displayed in the optional input element 8716. Non-limiting nonexclusive example entries are shown in the input elements 8702, 8704, 8706, 8708, 8710, 8712, 8714, 8716.

In one embodiment, the user can only edit or update the entries in the input elements 8710, 8714, 8716. When the user edits an unpaid scheduled expense, the date paid entry may default to the date expected date and the actual amount paid defaults to the expected amount. The input element 8400 may activate when the user edits at least one of the input elements 8710, 8714, 8716. An expense screen may be displayed when the user selects the input element 8400. The edits to the scheduled expense are discarded and the expense screen may be displayed when the user selects the input element 8404.

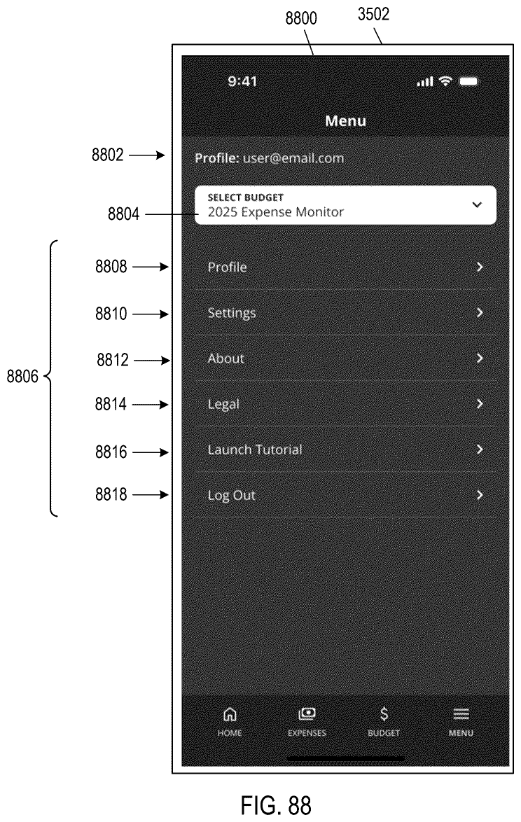

FIG. 88 illustrates an example menu screen 8800 displayed on the display screen 3502 according to an embodiment of the disclosure. The menu screen displays an email address that is associated with the account under profile 8802. The input element 8804 may be used to select or switch between the different screens, such as the budget screen, and/or to select an option to add a new budget. The menu screen 8800 may further include various menu options 8806 that enable the user to edit an email address or a password using the profile option 8808 and/or a language currency, country, and alerts using the settings option 8810. The about option 8812 may be selected to show a version of the financial management application and/or to display other details associated with the financial management application. The user may view the terms and conditions of the financial management application using the legal option 8814. A tutorial may be launched using the launch tutorial option 8816. The user can log out of the financial management system using the log out option 8818. A splash screen may be displayed when the user logs out of the financial management application. One example of a splash screen is the splash screen 3500 shown in FIG. 35.

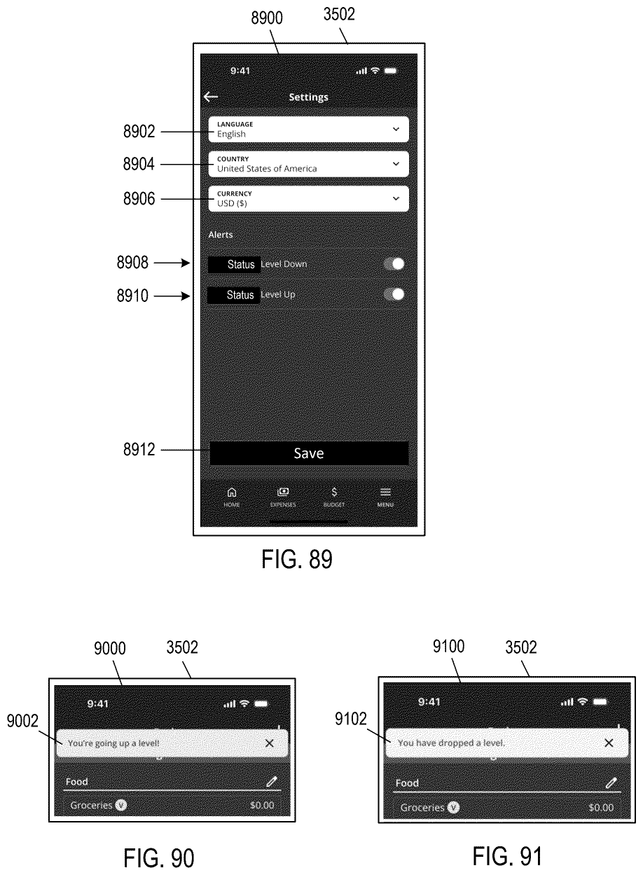

FIG. 89 illustrates an example settings screen 8900 displayed on the display screen 3502 according to an embodiment of the disclosure. The settings screen 8900 may be displayed in response to the user selecting the settings option 8810 shown in FIG. 88. The settings screen 8900 includes input elements 8902, 8904, 8906. A language may be set or changed using the input element 8902. A country may be set or changed using the input element 8904. A currency may be set or changed using the input element 8906.

Alerts that are associated with the status levels may be turned on and off in some embodiments using the settings screen 8900. In the illustrated embodiment, the input element 8908 may be used to turn on and turn off an alert that may be displayed when a user's status level decreases in value, which indicates a worsening of the financial status of the user. For example, the user's status level may decrease from a status level of 3 to a status level of 2.

The input element 8910 may be used to turn on and turn off an alert that may be displayed when a user's status level increases in value, which indicates an improvement in the financial status of the user. For example, the user's status level may increase from a status level of 3 to a status level of 4. Although the input elements 8908, 8910 are shown as toggle switches, different types of input elements may be used in other embodiments. For example, in one embodiment the input elements 8908, 8910 can be implemented as checkboxes or radio buttons. The user may select the input element 8912 (“Save”) to save the options.

FIG. 90 illustrates a portion of a screen 9000 displayed on the display screen 3502 according to an embodiment of the disclosure. The portion of the screen 9002 displays a banner 9002 that presents a congratulatory or encouraging notification or message. The banner 9002 may be displayed when the surplus in the financial management application increases to the point where the status level increases at least one status level (e.g., transition to status level 4 from status level 3).

FIG. 91 illustrates a portion of a screen 9100 displayed on the display screen 3502 according to an embodiment of the disclosure. The portion of the screen 9100 displays a banner 9102 that presents a warning notification or message. The banner 9102 may be displayed when the deficit in the financial management application increases to the point where the status level decreases at least one status level (e.g., transition to status level 2 from status level 3).

The various features, operations, functionality, screens, screen layouts and other disclosures described herein may be implemented in any combination in a financial management application. For example, the screens shown in FIGS. 1-15B, 27A-32, and 35-91 may be combined in any combination and order in a financial management application. Additionally or alternatively, features such as indicators, input elements, graphs, and other discloses may be combined in any combination and order in a financial management application.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of as defined in the claims. Although various embodiments have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements as defined in the following claims.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods. Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A system, comprising:
a processor; and
a memory configured to store processor-executable instructions, that when executed by the processor, cause operations to be performed, the operations comprising:
receiving financial information, the financial information comprising a plurality of expenses that are associated with a budget, the expenses comprising variable expenses and scheduled expenses;
receiving information regarding a payment of an expense in the plurality of expenses;
updating a spending state in real time based on the received information; and
displaying a screen associated with the spending state, the screen comprising:
an adaptable icon configured to visually represent the spending state;
a summary section providing a summary of spending, the summary section comprising spending over a day and spending over a time period that is greater than a day; and
a graph comprising at least one plot associated with spending over the time period.

2. The system of claim 1, wherein the memory stores further processor-executable instructions for updating the adaptable icon, the summary section, and the graph in real time throughout the day.

3. The system of claim 1, wherein the at least one plot comprises a first plot of actual expenses and a second plot of planned expenses.

4. The system of claim 1, wherein the at least one plot is a plot of a budget surplus for the budget.

5. The system of claim 1, wherein the memory stores further processor-executable instructions for displaying a countdown timer that presents an amount of time to reach a breakeven point with respect to the budget.

6. The system of claim 1, wherein the screen includes a first screen label for spending and a second screen label for saving, and the first screen label is selected.

7. The system of claim 6, wherein:
the screen is a first screen;
the adaptable icon is a first adaptable icon;
the summary is a first summary;
the graph is a first graph; and
the memory stores further processor-executable instructions for:
receiving a selection of the second tab;
responsively displaying a second screen associated with a savings state, the second screen comprising:
a second adaptable icon configured to visually represent the savings state;
a second summary of savings, the second summary comprising savings over the day and savings over the time period; and
a second graph comprising at least one plot associated with savings over the time period.

8. The system of claim 7, wherein the first adaptable icon is color coded with a first color that visually represents the spending state and the second adaptable icon is color coded with a second color that visually represents the savings state.

9. The system of claim 7, wherein the memory stores further processor-executable instructions for displaying a banner in the second screen, the banner including a notification that is associated with the savings state.

10. The system of claim 1, wherein the memory stores further processor-executable instructions for displaying a banner in the screen, the banner including a notification that is associated with the spending state.

11. A method, comprising:
receiving financial information, the financial information comprising a plurality of expenses that are associated with a budget, the expenses comprising variable expenses and scheduled expenses;
receiving information regarding a payment of an expense in the plurality of expenses;
updating a spending state in real time based on the received information; and
displaying a screen associated with the spending state, the screen comprising:
an adaptable icon configured to visually represent the spending state, the adaptable icon included in a plurality of adaptable icons;
a summary of spending, the summary comprising spending over a day and spending over a time period that is greater than a day; and
a graph comprising at least one plot associated with spending over the time period.

12. The method of claim 11, further comprising displaying a countdown timer that is configured to count down to a particular status level.

13. The method of claim 12, wherein the at least one plot comprises a first plot of actual expenses and a second plot of planned expenses.

14. The method of claim 12, wherein the graph includes an indicator for each adaptable icon in the plurality of adaptable icons, the plurality of indicators represented by colors that represent a plurality of spending states.

15. The system of claim 14, wherein the plurality of indicators represent different budget surplus states.

16. The method of claim 11, wherein the screen includes a first screen label for spending and a second screen label for saving, and the first screen label is selected.

17. The method of claim 16, wherein:
the screen is a first screen;
the adaptable icon is a first adaptable icon;
the summary is a first summary;
the graph is a first graph; and
the method further comprises:
receiving a selection of the second tab;
responsively displaying a second screen associated with a savings state, the second screen comprising:
a second adaptable icon configured to visually represent the savings state;
a second summary of savings, the second summary comprising savings over the day and savings over the time period; and
a second graph comprising at least one plot associated with savings over the time period.

18. The method of claim 17, wherein the first adaptable icon is color coded with a first color that visually represents the spending state and the second adaptable icon is color coded with a second color that visually represents the savings state.

19. The method of claim 17, wherein the method further comprises displaying a banner in the second screen, the banner including a notification that is associated with the savings state.

20. The method of claim 11, wherein the method further comprises:
receiving a selection of the expense displayed in the screen;
responsively displaying an edit screen configured to receive at least one input to edit a characteristic of the expense;
receiving an edit to the characteristic of the expense, the edit comprising a change in an amount of the expense; and
responsively displaying an updated screen of the screen that displays a revised summary based on the edit.
